(19) United States
(12) Patent Application Publication
(10) Pub. No.: US 2012/0147960 A1
(43) Pub. Date: Jun. 14, 2012

(54) Image Processing Apparatus and Method

(76) Inventor: Kazushi Sato, Kanagawa (JP)

(21) Appl. No.: 13/265,256

(22) PCT Filed: Apr. 22, 2010
(86) PCT No.: PCT/JP2010/057125

§ 371 Date: Nov. 16, 2011

(30) Foreign Application Priority Data
Apr. 24, 2009 (JP) 2009-105935

(51) Int. Cl. H04N 7/36

(52) U.S. Cl. 375/240.16; 375/240.12; 375/E07.027; 375/E07.263

(57) ABSTRACT

The invention relates to an image processing apparatus and method capable of improving an encoding efficiency.

A reference block B which can correspond to a target block A by an inter-motion vector MV is calculated in a reference frame through a motion prediction process. Next, a block A′ corresponding to the target block A is detected in a target frame through in-screen prediction and a block B′ corresponding to a reference block B is detected in a reference frame. A difference between the pixel value of the target block A and the pixel value of the block A′ and a difference between the pixel value of the reference block B and the block B′ are calculated. Secondary difference information which is a difference between the above differences is generated, encoded, and transmitted to a decoding side. The invention is applicable to an image encoding apparatus performing an encoding process in accordance with, for example, the H.264/AVC scheme.

### TECHNICAL FIELD

The present invention relates to an image processing apparatus and method, and more particularly, to an image encoding apparatus and method and an image decoding apparatus and method capable of improving an encoding efficiency using the difference of corresponding pixel values.

### BACKGROUND ART

In recent years, apparatuses have been widespread which digitally process image information and which compress and encode an image using redundancy, which is the characteristic of the image information, in accordance with orthogonal transform such as discrete cosine transform and motion compensation in order to transport and store information with high efficiency. An example of the encoding method includes MPEG (Moving Picture Experts Group).

In particular, MPEG2 (ISO/IEC 13818-2) is defined as a general image encoding method and is a standard scheme that is configured to process both an interlaced scanning image and a sequentially scanned image and process both standard-resolution images and high-resolution images. For example, MPEG2 is widely used for many applications for professional and consumer uses. When the MPEG2 compression scheme is used, an encoding rate (bit rate) of 4 to 8 Mbps can be assigned to an interfaced scanning image with a standard resolution of, for example, 720×480 pixels. Further, when the MPEG2 compression scheme is used, an encoding rate (bit rate) of 18 to 22 Mbps can be assigned to an interfaced scanning image with, for example, a high resolution of 1920×1088 pixels. Thus, it is possible to realize a high compression ratio and an excellent image quality.

MPEG2 is mainly used for high-image quality encoding suitable for broadcasting, but does not correspond to an encoding scheme of an encoding rate (bit rate) lower than that of MPEG1, that is, a higher compression ratio. With the wide spread of portable terminals, it is considered that demand for the encoding scheme has increased. Therefore, the MPEG4 encoding scheme has been standardized to correspond to this trend. The image encoding scheme was approved as an international standard in ISO/IEC 14496-2 in December 1998.

Moreover, in recent years, standardization of a scheme called H.26L (ITU-T Q6/16 VCEG) is in progress in order to initially encode an image for a video conference. It is known that H.26L can realize an encoding efficiency higher than that of a known encoding scheme such as MPEG2 or MPEG4, although a lot of calculation amount is required in encoding and decoding processes. At present, as one of the activities for MPEG4, standardization is in progress as Joint Model of Enhanced-Compression Video Coding to provide the functions that H.26L does not support and realize a higher encoding efficiency on the basis of H.26L. H.264 and MPEG-4 Part 10 (Advanced Video Coding, hereinafter referred to as H.264/AVC) was approved as an international standard in March 2003.

The standardization of FRExt (Fidelity Range Extension), which is an extension of the above standard and includes an encoding tool RGB or 4:2:2 and 4:4:4 necessary for business use, an 8×8 DCT defining MPEG-2, or a quantization matrix, was completed in February 2005. Accordingly, H.264/AVC is used as an encoding scheme which can satisfactorily express a film sound contained in a movie, and thus is used for a wide range of applications such as Blu-Ray Disc (trademark).

In recent years, however, there is increasing demand for compression of an image of about 4000×2000, which is four times the high-vision image, or transmission of a high-vision image and high-compression ratio encoding under a restricted transmission capacity environment such as the Internet. Therefore, VCEG (=Video Coding Expert Group) of ITU-T keeps examining improvements in encoding efficiency.

One of the factors that realize a higher encoding efficiency in the H.264/AVC scheme in comparison to the known MPEG2 scheme is an intra-prediction process.

In the H.264/AVC scheme, intra-prediction modes of a luminance signal include prediction modes of nine types of block units of 4×4 pixels and 8×8 pixels of four types of macro block units of 16×16 pixels. Further, intra-prediction modes of a color difference signal include prediction modes of four types of block units of 8×8 pixels. The intra-prediction modes of the color difference signal can be set to be independent from the intra-prediction modes of the luminance signal.

In the intra-prediction modes of 4×4 pixels and 8×8 pixels of the luminance signal, one intra-prediction mode is defined for each block of the luminance signal of 4×4 pixels and 8×8 pixels. In the intra-prediction mode of 16×16 pixels of the luminance signal and the intra-prediction mode of the color difference signal, one prediction mode is defined for one macro block.

In recent years, for example, Non-Patent Literatures 1 and 2 have suggested a method of improving the efficiency of the intra-prediction of the H.264/AVC scheme.

An intra-template matching method will be described as an intra-prediction method suggested in Non-Patent Literature 1 with reference to FIG. 1. In the example of FIG. 1, a block A with 4×4 pixels and a predetermined search range E of only pixels already subjected to an encoding process in an area having XxY (=horizontal×vertical) are shown on a target frame (not shown) to be encoded.

A target block a to be encoded now is shown in the predetermined block A. The predetermined block A is, for example, a macro block or a sub-macro block. The target block a is a block located on the left upper side among blocks with 2×2 pixels forming the predetermined block A. A template region b with pixels already subjected to the encoding process is adjacent to the target block a. For example, when the encoding process is performed in a raster scan order, as shown in FIG. 1, the template region b is a region located on the left and upper sides of the target block a and is a region where decoded images are accumulated in a frame memory.

According to the intra-template matching method, for example, a template matching process is performed within the predetermined search range E using the template region b where a cost function value such as SAD (Sum of Absolute Difference) or the like is the minimum. As a consequence, a block b′ having the highest correlation with the pixel value of the template region b is searched and a motion vector for the target block a is searched by using the block a′ corresponding to the searched region b′ as a prediction image for the target block a.

In this way, in the motion vector searching process of the intra-template matching method, the decoded image is used in the template matching process. Accordingly, when the predetermined search range E is determined in advance, the process can be performed in the encoding and decoding sides and it is not necessary to transmit information regarding the motion vector to the decoding side.

In FIG. 1, the target sub-block with 2×2 pixels has been described, but the invention is not limited thereto. Instead, a sub-block with an arbitrary size can be used.

An intra-motion prediction method of the intra-prediction method suggested in Non-Patent Literature 2 will be described with reference to FIG. 2. In the example of FIG. 2, a macro block A to be encoded and a predetermined search range E already subjected to the encoding process are shown on a target frame.

The macro block A includes block a1 to a4 and the block a2 is a block to be encoded block. For example, according to the intra-motion prediction method, a block a2′ having the highest correlation with the pixel value of the block a2 is searched from the predetermined search range E and the searched block a2′ is considered as the prediction image for the target block a2. The predetermined search range E also includes the block a1 when the block a2′ is a target.

At this time, in this intra-motion prediction method, information corresponding to a motion vector my from the block block a2′ to the block a2 in a screen is transmitted to the decoding side unlike the intra-template matching method described above with reference to FIG. 1.

Here, according to the MPEG2 scheme, a motion prediction/compensation process is performed at a ½ pixel precision in accordance with linear interpolation process.

On the other hand, according to the H.264/AVC scheme, a prediction/compensation process is performed at a ¼ pixel precision using an FIR (Finite Impulse Response Filter) filter of six taps.

According to the MPEG2 scheme, in a frame motion compensation mode, the motion prediction/compensation process is performed in a unit of 16×16 pixels. In a field motion compensation mode, the motion prediction/compensation process is performed on a first field and a second field in a unit of 16×8 pixels.

On the other hand, according to the H.264/AVC scheme, the motion prediction/compensation process can be performed by setting a block size to be variable. That is, according to the H.264/AVC scheme, one macro block with 16×16 pixels is divided into several 16×16, 16×8, 8×16, or 8×8 partitions and each of the partitions has independent motion vector information. Further, the 8×8 partition can be divided into several 8×8, 8×4, 4×8, or 4×4 sub-partitions and each of the sub-partitions can have independent motion vector information.

In the H.264/AVC scheme, when the motion prediction/compensation process is performed with the ¼ pixel precision and the variable blocks described above, the vast amount of motion vector information is generated. Therefore, when the encoding process is performed in this state, the encoding efficiency may deteriorate. Accordingly, there has been suggested a technique for suppressing the deterioration in the encoding efficiency by a method of generating the prediction motion vector information of a target block to be encoded now by a median operation by the use of the motion vector information of the adjacent block already subjected to the encoding process.

However, even when the medium prediction is used, a ratio of the motion vector information in image compression information is not small. Accordingly, a method disclosed in Non-Patent Literature 3 has been suggested. In the method, a region of an image which is adjacent to the region of an image to be encoded with a predetermined positional relationship and has a high correlation with a decoded image of a template region, which is a part of the decoded image, is searched from the decoded image and prediction is performed based on a predetermined positional relationship with the searched region.

An inter-template matching method suggested in Non-Patent Literature 3 will be described with reference to FIG. 3.

In the example of FIG. 3, a target frame (picture) to be encoded and a reference frame referred to at the time of searching a motion vector are shown. In the target frame, a target block A, which is to be encoded now, and a template region B, which is adjacent to the target block A and has the pixels already subjected to the encoding process, are shown. For example, the template region B is a region which is located on the left and upper sides of the target block A, as shown in FIG. 3 and is a region where the decoded images are accumulated in the frame memory, when the encoding process is performed in a raster scan order.

In the inter-template matching method, a region B′ having the highest correlation with the pixel value of the template region B is searched within a predetermined search range E on the reference frame by a template matching process using, for example, SAD as cost function value. A block A′ corresponding to the searched region B′ is set as a prediction image for the target block A and a motion vector P for the target block A is searched.

In the inter-template matching method, since the decoded image is used in the matching, the same process can be performed on the encoding and decoding sides by setting the search range in advance. That is, since the motion vector invention does not need to be included in the image compression information on the encoding side by performing the above-described prediction/compensation process even on the decoding side, it is possible to suppress the deterioration in the encoding efficiency.

### CITATION LIST

### Non Patent Literature

NPL 1: “Intra Prediction by Template Matching” T. K. Tan et al, ICIP 2006
NPL 2: “Tools for Improving Texture and Motion Compensation”, MPEG Workshop, October 2008
NPL 3: “Inter Frame Coding with Template Matching Averaging”, Suzuki et al. ICIP 2007

### SUMMARY OF INVENTION

### Technical Problem

However, when a high-resolution image is further compressed due to the high-vision image or a high-vision image is transmitted via a network such as the Internet, which is a representative network, as in an IPTV (Internet Protocol Television), as described above, the high-resolution image needs to be compressed at a lower bit rate.

In the compression ratio of the H.264/AVC scheme, however, the compression is not yet sufficient and it is necessary to cut new information in the compression.

The invention is devised in the light of the above-described circumstance and an object of the invention is to improve an encoding efficiency using a difference value of corresponding pixel values.

### Solution to Problem

According to a first aspect of the invention, an image processing apparatus includes: a reception unit receiving target frame difference information, which is a difference between an image of a target frame and a target prediction image generated through in-screen prediction in the target frame, and reference frame difference information, which is a difference between an image of a reference frame corresponding to the target frame and a reference prediction image generated through the in-screen prediction in the reference frame; a secondary difference generation unit generating secondary difference information which is a difference between the target frame difference information and the reference frame difference information received in the receiving; and an encoding unit encoding the secondary difference information generated by the secondary difference generation unit as the image of the target frame.

The image processing apparatus may further include an inter-template motion prediction unit allowing the target block to correspond to the reference block by predicting motion of the target block using a first template, which is adjacent to the target block and is generated from a decoded image, in the reference frame.

The image processing apparatus may further include a target intra-prediction unit generating the target prediction image through the in-screen prediction by the use of pixels of the first template in the target frame; and a reference intra-prediction unit generating the reference prediction image through the in-screen prediction by the use of pixels of a second template, which is adjacent to the reference block and is generated from the decoded image, in the reference frame.

The reference intra-prediction unit may determine a prediction mode by generating the reference prediction image through the in-screen prediction using the pixels of the second template in the reference frame. The target intra-prediction unit may generate the target prediction image through the in-screen prediction in the prediction mode determined by the reference intra-prediction unit by the use of the pixels of the first template in the target frame.

The target intra-prediction unit may determine a prediction mode by generating the target prediction image through the in-screen prediction by the use of the pixels of the first template in the target frame. The reference intra-prediction unit may generate the reference prediction image through the in-screen prediction in the prediction mode determined by the target intra-prediction unit by the use of the pixels of the second template in the reference frame. The encoding unit may encode the image of the target frame and information indicating the prediction mode determined by the target intra-prediction unit.

The target intra-prediction unit may determine a first prediction mode by generating the target prediction image through the in-screen prediction by the use of the pixels of the first template in the target frame. The reference intra-prediction unit may determine a second prediction mode by generating the reference prediction image through the in-screen prediction by the use of the pixels of the second template in the reference frame. The encoding unit may encode the image of the target frame and information indicating the first prediction mode determined by the target intra-prediction unit.

The image processing apparatus may further include a motion prediction unit allowing the target block to correspond to a reference block included in the reference frame by predicting motion of the target block using a target block included in the target frame in the reference frame.

The image processing apparatus may further include a target intra-template prediction unit generating the target prediction image through the in-screen prediction using a first block corresponding to the target block calculated by predicting motion of the target block using a first template, which is adjacent to the target block and is generated from a decoded image, in the target frame; and a reference intra-template prediction unit generating the reference prediction image through the in-screen prediction using a second block corresponding to the reference block calculated by predicting motion of the reference block using a second template, which is adjacent to the reference block and is generated from the decoded image, in the reference frame.

The image processing apparatus may further include a target intra-motion prediction unit generating the target prediction image through the in-screen prediction using a first block corresponding to the target block calculated by predicting motion of the target block using the target block in the target frame; and a reference intra-motion prediction unit generating the reference prediction image through the in-screen prediction using a second block corresponding to the reference block calculated by predicting motion of the reference block using the reference block in the reference frame.

According to the first aspect of the invention, an image processing method comprising: by an image processing apparatus, receiving target frame difference information, which is a difference between an image of a target frame and a target prediction image generated through in-screen prediction in the target frame, and reference frame difference information, which is a difference between an image of a reference frame corresponding to the target frame and a reference prediction image generated through the in-screen prediction in the reference frame; generating secondary difference information which is a difference between the received target frame difference information and the reference frame difference information; and encoding the generated secondary difference information as the image of the target frame.

According to a second aspect of the invention, an image processing apparatus includes: a decoding unit decoding secondary difference information of a decoded target frame; a reception unit receiving a target prediction image generated through in-screen prediction in the target frame and reference frame difference information, which is a difference between an image of a reference frame corresponding to the target frame and a reference prediction image generated through the in-screen prediction in the reference frame; and a secondary difference compensation unit calculating an image of the target frame by adding the secondary difference information decoded by the decoding unit, the target prediction image received by the reception unit, and the reference frame difference information received by the reception unit.

The image processing apparatus may further include an inter-template motion prediction unit allowing the target block to correspond to the reference block by predicting motion of the target block using a first template, which is adjacent to the target block and is generated from a decoded image, in the reference frame.

The image processing apparatus may further include a target intra-prediction unit generating the target prediction image through the in-screen prediction by the use of pixels of the first template in the target frame; and a reference intra-prediction unit generating the reference prediction image through the in-screen prediction by the use of pixels of a second template, which is adjacent to the reference block and is generated from the decoded image, in the reference frame.

The reference intra-prediction unit determines a prediction mode by generating the reference prediction image through the in-screen prediction using the pixels of the second template in the reference frame. The target intra-prediction unit may generate the target prediction image through the in-screen prediction in the prediction mode determined by the reference intra-prediction unit by the use of the pixels of the first template in the target frame.

The decoding unit may decode both the secondary difference information and information indicating a prediction mode in the target intra-prediction unit. The target intra-prediction unit may generate the target prediction image through the in-screen prediction in the prediction mode indicated by the information decoded by the decoding unit by the use of the pixels of the first template in the target frame. The reference intra-prediction unit may generate the reference prediction image through the in-screen prediction in the prediction mode indicated by the information decoded by the decoding unit by the use of the pixels of the second template in the reference frame.

The decoding unit may decode both the secondary difference information and information indicating a first prediction mode in the target intra-prediction unit. The target intra-prediction unit may generate the target prediction image through the in-screen prediction in the first prediction mode indicated by the information decoded by the decoding unit by the use of the pixels of the first template in the target frame. The reference intra-prediction unit may determine a second prediction mode by generating the reference prediction image through the in-screen prediction by the use of the pixels of the second template in the reference frame.

The image processing apparatus may further include a motion prediction unit allowing the target block to correspond to a reference block included in the reference frame by predicting motion of the target block using a target block included in the target frame in the reference frame.

The image processing apparatus may further include a target intra-template prediction unit generating the target prediction image through the in-screen prediction using a first block corresponding to the target block calculated by predicting motion of the target block using a first template, which is adjacent to the target block and is generated from a decoded image, in the target frame; and a reference intra-template prediction unit generating the reference prediction image through the in-screen prediction using a second block corresponding to the reference block calculated by predicting motion of the reference block using a second template, which is adjacent to the reference block and is generated from the decoded image, in the reference frame.

The image processing apparatus may further include a target intra-motion prediction unit generating the target prediction image through the in-screen prediction in the target frame using a first block corresponding to the target block calculated using motion vector information of the target block decoded together with the secondary difference of the target frame by the decoding unit; and a reference intra-motion prediction unit generating the reference prediction image through the in-screen prediction in the reference frame using a second block corresponding to the reference block calculated using motion vector information of the reference block decoded together with the secondary difference of the target frame by the decoding unit.

According to the second aspect of the invention, an image processing method includes: by an image processing apparatus, decoding secondary difference information of a decoded target frame; receiving a target prediction image generated through in-screen prediction in the target frame and reference frame difference information, which is a difference between an image of a reference frame corresponding to the target frame and a reference prediction image generated through the in-screen prediction in the reference frame; and calculating an image of the target frame by adding the decoded secondary difference information, the received target prediction image, and the received reference frame difference information.

According to the first aspect of the invention, there are received target frame difference information, which is a difference between an image of a target frame and a target prediction image generated through in-screen prediction in the target frame, and reference frame difference information, which is a difference between an image of a reference frame corresponding to the target frame and a reference prediction image generated through the in-screen prediction in the reference frame. Further, secondary difference information which is a difference between the received target frame difference information and the received reference frame difference information is received. The secondary difference information generated as the image of the target frame is encoded.

According to the second aspect of the invention, secondary difference information of a decoded target frame is decoded. There are received a target prediction image generated through in-screen prediction in the target frame and reference frame difference information, which is a difference between an image of a reference frame corresponding to the target frame and a reference prediction image generated through the in-screen prediction in the reference frame. Further, there is calculated an image of the target frame by adding the decoded secondary difference information, the received target prediction image, and the received reference frame difference information.

The above-described image processing apparatuses may be independent apparatuses or may be an apparatus having inner blocks of one image encoding apparatus and one image decoding apparatus.

### ADVANTAGEOUS EFFECTS OF INVENTION

According to the first aspect of the invention, it is possible to encode the image. Further, according to the first aspect of the invention, it is possible to improve the encoding efficiency.

According to the second aspect of the invention, it is possible to decode the image. Further, according to the second aspect of the invention, it is possible to improve the encoding efficiency.

### BRIEF DESCRIPTION OF DRAWINGS

FIG. 1 is a diagram illustrating an intra-template matching method.

FIG. 2 is a diagram illustrating an intra-motion prediction.

FIG. 3 is a diagram illustrating an inter-template matching method.

FIG. 4 is a block diagram illustrating the configuration of an image encoding apparatus according to an embodiment of the invention.

FIG. 5 is a diagram illustrating a motion prediction/compensation process of a variable block size.

FIG. 6 is a diagram illustrating a motion prediction/compensation process of a ¼ pixel precision.

FIG. 7 is a diagram illustrating a motion prediction/compensation method of a multi-reference frame.

FIG. 8 is a diagram illustrating an example of a method of generating motion vector information.

FIG. 9 is a block diagram illustrating an example of the detailed configuration of an in-screen prediction unit and a secondary difference generation unit.

FIG. 10 is a diagram illustrating examples of the operations of the in-screen prediction unit and the secondary difference generation unit.

FIG. 11 is a diagram illustrating other examples of the operations of the in-screen prediction unit and the secondary difference generation unit.

FIG. 12 is a flowchart illustrating an encoding process of the image encoding apparatus in FIG. 4.

FIG. 13 is a flowchart illustrating a prediction process of step S21 in FIG. 12.

FIG. 14 is a diagram illustrating a processing sequence in a case of an intra-prediction mode of 16×16 pixels.

FIG. 15 is a diagram illustrating the types of intra-prediction mode of 4×4 pixels of a luminance signal.

FIG. 16 is a diagram illustrating the types of intra-prediction mode of 4×4 pixels of the luminance signal.

FIG. 17 is a diagram illustrating directions of the intra-prediction of 4×4 pixels.

FIG. 18 is a diagram illustrating the intra-prediction of 4×4 pixels.

FIG. 19 is a diagram illustrating encoding of the intra-prediction mode of 4×4 pixels of the luminance signal.

FIG. 20 is a diagram illustrating the types of intra-prediction mode of 8×8 pixels of the luminance signal.

FIG. 21 is a diagram illustrating the types of intra-prediction mode of 8×8 pixels of the luminance signal.

FIG. 22 is a diagram illustrating the types of intra-prediction mode of 16×16 pixels of the luminance signal.

FIG. 23 is a diagram illustrating the types of intra-prediction mode of 16×16 pixels of the luminance signal.

FIG. 24 is a diagram illustrating intra-prediction of 16×16 pixels.

FIG. 25 is a diagram illustrating the types of intra-prediction modes of a color difference signal.

FIG. 26 is a flowchart illustrating an intra-prediction process of step S31 in FIG. 13.

FIG. 27 is a flowchart illustrating an inter-motion prediction process of step S32 in FIG. 13.

FIG. 28 is a flowchart illustrating a secondary difference generation process of step S63 of FIG. 27.

FIG. 29 is a block diagram illustrating the configuration of an image decoding apparatus according to an embodiment of the invention.

FIG. 30 is a block diagram illustrating examples of the detailed configurations of an in-screen prediction unit and a secondary difference compensation unit.

FIG. 31 is a flowchart illustrating a decoding process of the image decoding apparatus in FIG. 29.

FIG. 32 is a flowchart illustrating a prediction process of step S138 in FIG. 31.

FIG. 33 is a flowchart illustrating an inter-motion prediction secondary difference compensation process of step S175 in FIG. 32.

FIG. 34 is a block diagram illustrating the configuration of an image encoding apparatus according to another embodiment of the invention.

FIG. 35 is a block diagram illustrating an example of the detailed configuration of an adjacency prediction unit.

FIG. 36 is a diagram illustrating examples of the operations of an inter-template motion prediction/compensation unit and the adjacency prediction unit.

FIG. 37 is a flowchart illustrating another example of a prediction process of step S21 in FIG. 12.

FIG. 38 is a flowchart illustrating another example of an inter-motion prediction process of step S212 in FIG. 37.

FIG. 39 is a flowchart illustrating an example of an inter-template motion prediction process of step S215 in FIG. 37.

FIG. 40 is a flowchart illustrating another example of the inter-template motion prediction process of step S215 in FIG. 37.

FIG. 41 is a flowchart illustrating still another example of the inter-template motion prediction process of step S215 in FIG. 37.

FIG. 42 is a block diagram illustrating the configuration of an image decoding apparatus according to another embodiment of the invention.

FIG. 43 is a block diagram illustrating an example of the detailed configuration of an adjacency prediction unit.

FIG. 44 is a flowchart illustrating another example of the prediction process of step S138 in FIG. 31.

FIG. 45 is a flowchart illustrating an inter-template motion prediction/compensation process of step S319 in FIG. 44.

FIG. 46 is a block diagram illustrating an example of the configuration of computer hardware.

### DESCRIPTION OF EMBODIMENTS

Hereinafter, an embodiment of the invention will be described with reference to the drawings.

### Example of Configuration of Image Encoding Apparatus

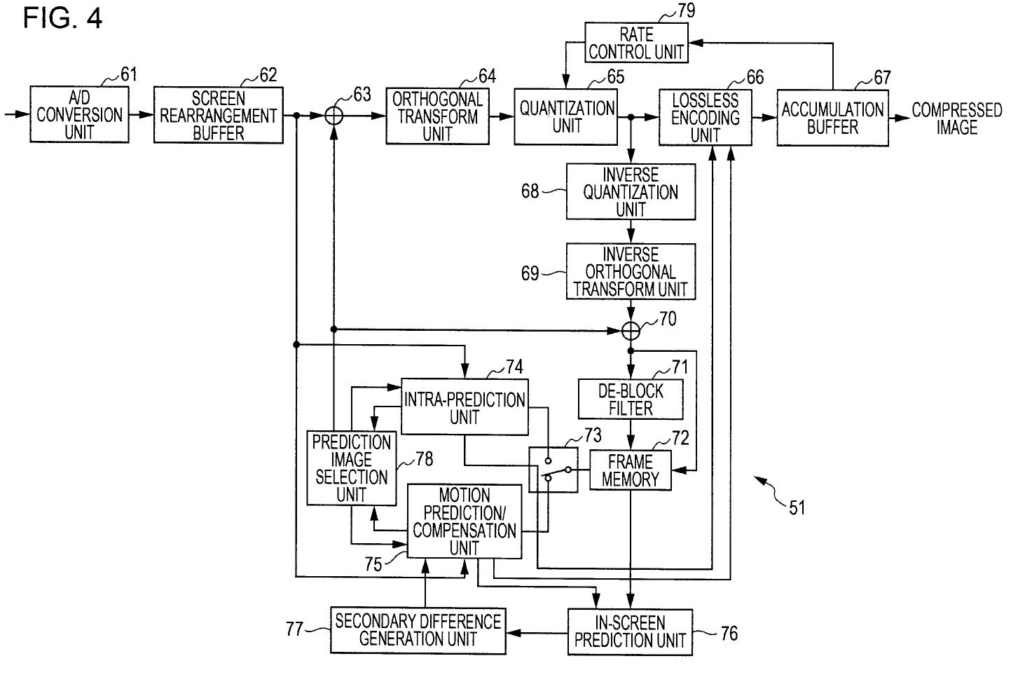

FIG. 4 is a diagram illustrating the configuration of an image encoding apparatus serving as an image processing apparatus according to an embodiment of the invention.

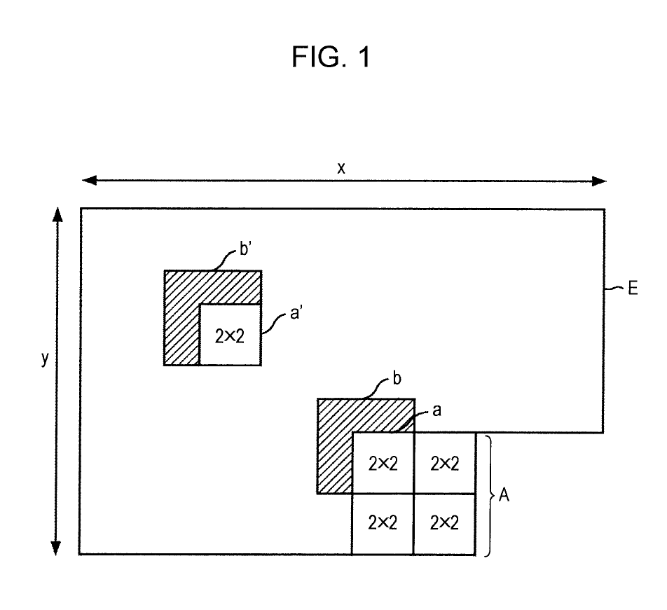

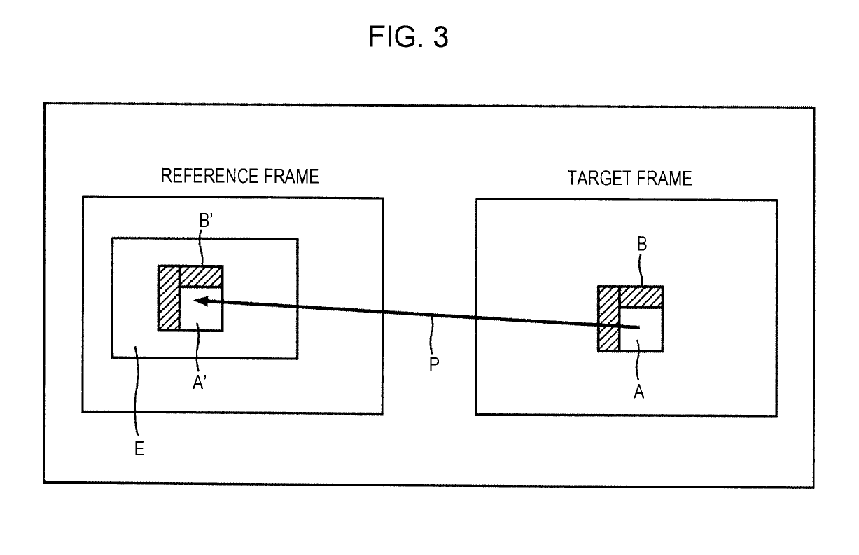

An image encoding apparatus 51 compresses and encodes an image in accordance with, for example, the H.264 scheme and the MPEG-4 Part 10 (Advanced Video Coding) (hereinafter, referred to as H.264/AVC), if not otherwise mentioned. That is, in effect, the template matching method described above with reference to FIG. 1 or 3 is also used in the image encoding apparatus 51, if necessary. Accordingly, an image is compressed and encoded in accordance with H.264/AVC other than the template matching method.

In the example of FIG. 4, the image encoding apparatus 51 includes an A/D conversion unit 61, a screen rearrangement buffer 62, a calculation unit 63, an orthogonal transform unit 64, a quantization unit 65, a lossless encoding unit 66, an accumulation buffer 67, an inverse quantization unit 68, an inverse orthogonal transform unit 69, a calculation unit 70, a de-block filter 71, a frame memory 72, a switch 73, an intra-prediction unit 74, a motion prediction/compensation unit 75, an in-screen prediction unit 76, a secondary difference generation unit 77, a prediction image selection unit 78, and a rate control unit 79.

The A/D conversion unit 61 performs A/D conversion on an input image, outputs the converted image to the screen rearrangement buffer 62, and stores the image. The screen rearrangement buffer 62 rearranges the images of frames in a stored display order in accordance with GOP (Group of Pictures) in the order of the frames for encoding.

The calculation unit 63 subtracts a prediction image, which is selected by the prediction image selection unit 78 and sent from the intra-prediction unit 74, from an image read from the screen rearrangement buffer 62, and then outputs difference information to the orthogonal transform unit 64. The orthogonal transform unit 64 performs orthogonal transform, such as discrete cosine transform or Karhunen-Loeve transform, on the difference information from the calculation unit 63, and then outputs a transform coefficient. The quantization unit 65 quantizes the transform coefficient output by the orthogonal transform unit 64.

The quantized transform coefficient output by the quantization unit 65 is input to the lossless encoding unit 66, and then is subjected to lossless encoding, such as variable length coding or arithmetic coding so as to be compressed.

The lossless encoding unit 66 acquires information indicating intra-prediction from the intra-prediction unit 74 and acquires information or the like indicating an inter-prediction mode from the motion prediction/compensation unit 75. The information indicating the intra-prediction is also referred below to as intra-prediction mode information. Further, the information indicating the inter-prediction is also referred below to as inter-prediction mode information.

The lossless encoding unit 66 encodes the quantized transform coefficient and encodes the information indicating the intra-prediction and the information or the like indicating the inter-prediction mode to set the encoded data as a part of header information in the compressed image. The lossless encoding unit 66 supplies the encoded data to the accumulation buffer 67 to accumulate the encoded data.

For example, lossless encoding unit 66 performs the lossless encoding process such as variable length coding or arithmetic coding. An example of the variable length coding includes CAVLC (Context-Adaptive Variable Length Coding) determined in the H.264/AVC scheme. An example of the arithmetic coding includes CABAC (Context-Adaptive Binary Arithmetic Coding).

The accumulation buffer 67 outputs the data supplied from the lossless encoding unit 66 as a compressed image encoded in accordance with the H.264/AVC scheme to a recording apparatus, a transmission line, or the like (not shown) on the rear stage.

The quantized transform coefficient output from the quantization unit 65 is also input to the inverse quantization unit 68, is subjected to inverse quantization, and then is further subjected to inverse orthogonal transform in the inverse orthogonal transform unit 69. The output subjected to the inverse orthogonal transform is added to the prediction image supplied from the prediction image selection unit 78 by the calculation unit 70, so that a locally decoded image is formed. The de-block filter 71 eliminates a block distortion of the decoded image, supplies the decoded image to the frame memory 72, and then accumulates the decoded image. The image which is not subjected to a de-block filtering process by the de-block filter 71 is also supplied and accumulated in the frame memory 72.

The switch 73 outputs a reference image accumulated in the frame memory 72 to the motion prediction/compensation unit 75 or the intra-prediction unit 74.

In the image encoding apparatus 51, for example, an I picture, a B picture, and a P picture from the screen rearrangement buffer 62 are supplied as an image for intra-prediction (also referred to as intra-processing) to the intra-prediction unit 74. The B picture and the P picture read from the screen rearrangement buffer 62 are supplied as an image for inter-prediction (also referred to as inter-processing) to the motion prediction/compensation unit 75.

The intra-prediction unit 74 performs the intra-prediction process in all candidate intra-prediction modes based on the reference image read from the screen rearrangement buffer 62 and subjected to the intra-prediction and the reference image supplied from the frame memory 72 in order to generate a prediction image.

At this time, the intra-prediction unit 74 calculates the cost function values for all the candidate intra-prediction modes and selects the intra-prediction mode having minimum value among the calculated cost function values as an optimum intra-prediction mode.

The intra-prediction unit 74 supplies the prediction image generated in the optimum intra-prediction mode and the cost function value to the prediction image selection unit 78. When the prediction image generated in the optimum intra-prediction mode by the prediction image selection unit 78 is selected, the intra-prediction unit 74 supplies information indicating the optimum intra-prediction mode to the lossless encoding unit 66. The lossless encoding unit 66 encodes this information and sets the encoded information as a part of the header information in the compressed image.

The motion prediction/compensation unit 75 performs the motion prediction/compensation process of all candidate inter-prediction modes. That is, the image to be subjected to the inter-processing which is read from the screen rearrangement buffer 62 and the reference image are supplied from the frame memory 72 to the motion prediction/compensation unit 75 via the switch 73.

The motion prediction/compensation unit 75 detects a motion vector based on the image to be subjected to the inter-processing and the reference image and calculates a reference block, which can correspond to the target block of the image to be subjected to the inter-processing, based on information regarding the detected motion vector in the reference image. The motion prediction/compensation unit 75 outputs information regarding the target block and information regarding the reference block corresponding to the information regarding the target block to the in-screen prediction unit 76. This process is performed on all the candidate inter-prediction modes.

The motion prediction/compensation unit 75 can perform the motion prediction/compensation process in accordance with the inter-template matching method described above with reference to FIG. 3, instead of the motion prediction/compensation process of the inter-prediction mode.

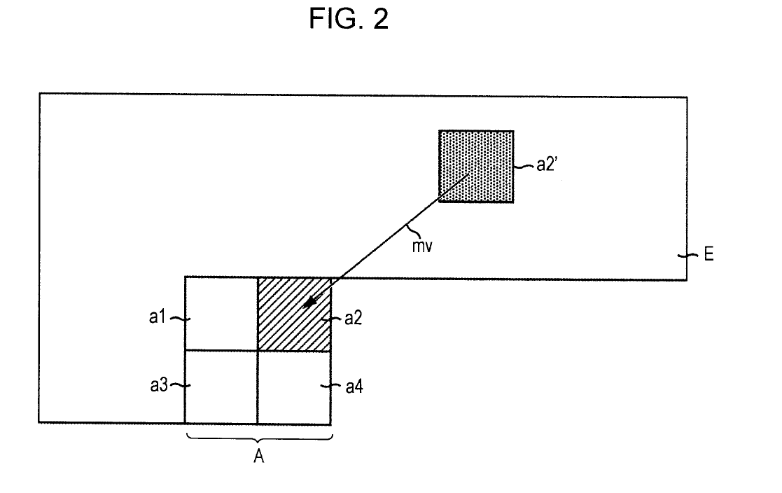

The in-screen prediction unit 76 reads the target frame and the reference image of the reference frame from the frame memory 72. The in-screen prediction unit 76 performs an in-screen prediction in the target frame to detect a block corresponding to the target block and performs the in-screen prediction in the reference frame to detect a block corresponding to the reference block. In the in-screen prediction unit 76, the intra-template matching method described above with reference to FIG. 1 or the intra-motion prediction method described above with reference to FIG. 2 is used as the in-screen prediction.

The in-screen prediction unit 76 calculates difference information (difference information of the target frame) between the pixel value of the target block and the pixel value of the corresponding block and calculates difference information (difference information of the reference frame) between the pixel value of the reference block and the pixel value of the corresponding block. The calculated difference information of the target frame and the calculated difference information of the reference frame are output to the secondary difference generation unit 77.

The secondary difference generation unit 77 generates secondary difference information which is a difference between the difference information of the target frame and the difference information of the reference frame and outputs the generated secondary difference information to the motion prediction/compensation unit 75.

The motion prediction/compensation unit 75 calculates the cost function values for all the candidate inter-prediction modes using the secondary difference information of the target block from the secondary difference generation unit 77. The motion prediction/compensation unit 75 selects the inter-prediction mode with the minimum value among the calculated cost function values as an optimum inter-prediction mode.

The motion prediction/compensation unit 75 supplies a difference between the image to be subjected to the inter-processing and the secondary difference information generated in the optimum inter-prediction mode and the cost function value of the optimum inter-prediction mode to the prediction image selection unit 78. The motion prediction/compensation unit 75 outputs information indicating the optimum inter-prediction mode to the lossless encoding unit 66, when the prediction image selection unit 78 selects a difference between the secondary difference information and the image to be subjected to the inter-processing as the prediction image generated in the optimum inter-prediction mode.

The lossless encoding unit 66 also outputs motion vector information, flag information, reference frame information, and the like to the lossless encoding unit 66, if necessary. The lossless encoding unit 66 performs the lossless encoding process, such as the variable length coding or the arithmetic coding, on the information from the motion prediction/compensation unit 75 to insert the processed information into a header section of the compressed image.

The prediction image selection unit 78 determines the optimum prediction mode from the optimum intra-prediction mode and the optimum inter-prediction mode based on the cost function values output from the intra-prediction unit 74 or the motion prediction/compensation unit 75. The prediction image selection unit 78 selects a difference between the prediction image of the determined optimum prediction mode or the image for inter-processing and the secondary difference information and supplies the difference to the calculation units 63 and 70. At this time, the prediction image selection unit 78 supplies selection information of the prediction image to the intra-prediction unit 74 or the motion prediction/compensation unit 75.

The rate control unit 79 controls the rate of the quantization operation of the quantization unit 65 based on the compression image accumulated in the accumulation buffer 67 so that overflow or underflow does not occur.

### [Description of H.264/AVC Scheme]

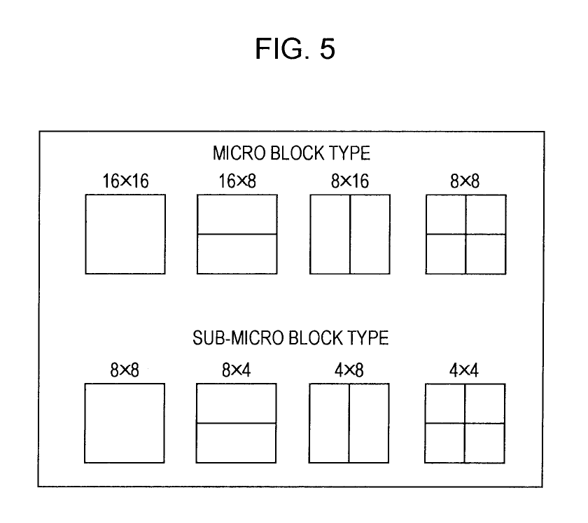

FIG. 5 is a diagram illustrating an example of the block size of the motion prediction and compensation in the H.264/AVC scheme. In the H.264/AVC scheme, the block size is set to be variable for the motion prediction and compensation.

In the upper part of FIG. 5, macro blocks with 16×16 pixels divided into partitions of 16×16 pixels, 16×8 pixels, 8×16 pixels, and 8×8 pixels are shown from the left side. In the lower part of FIG. 5, partitions with 8×8 pixels divided into sub-partitions with 8×8 pixels, 8×4 pixels, 4×8 pixels, and 4×4 pixels are shown from the left side.

That is, in the H.264/AVC scheme, one macro block can be divided into several partitions with 16×16 pixels, 16×8 pixels, 8×16 pixels, or 8×8 pixels and each of the partitions can have independent motion vector information. Further, the partitions with 8×8 pixels can be divided into several sub-partitions with 8×8 pixels, 8×4 pixels, 4×8 pixels, or 4×4 pixels and each of the sub-partitions can have independent motion vector information.

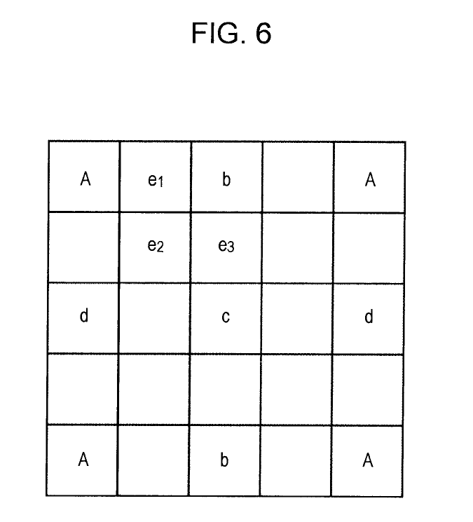

FIG. 6 is a diagram illustrating a prediction/compensation process of a ¼ pixel precision in the H.264/AVC scheme. In the H.264/AVC scheme, a prediction/compensation process is performed at the ¼ pixel precision using an FIR (Finite Impulse Response Filter) filter of six taps.

In the example of FIG. 6, a position A is a position of a integer precision pixel, positions b, c, and d are a position of a ½ pixel precision, positions e1, e2, and e3 are a position of a ¼ pixel position. First, Clip( ) is defined by Expression (1) below.

$$\begin{matrix}[ Expression 1 ] & \\ Clip 1 ( a ) = \{ \begin{matrix}0 ; & if ( a < 0 ) \\ a ; & otherwise \\ max\_pix ; & if ( a > max\_pix )\end{matrix} & ( 1 )\end{matrix}$$

When an input image has an 8-bit precision, the value of max_pix is 255.

The pixel values at the positions b and d are generated by Expression (2) below using the FIR filter of six taps.

[Expression 2]

F=A₋₂−5·A₋₁+20·A₀+20·A₁−5·A₂+A₃

b,d=Clip1((F+16)>>5) (2)

The pixel value at the position c is generated by Expression (3) below applying the FIR filter of six taps in horizontal and vertical directions.

[Expression 3]

F=b₋₂−5·b₋₁+20·b₀+20·b₁−5·b₂+b₃

or

F=d₋₂−5·d₋₁+20·d₀+20·d₁−5·d₂+d₃

C=Clip1((F+512)>>10) (3)

A Clip process is performed finally once after both product-sum operations are performed in the horizontal and vertical directions.

The positions e1 to e3 are generated by Expression (4) below by linear interpolation.

[Expression 4]

e1=(A+b+1)>>1

e2=(b+d+1)>>1

e3=(b+c+1)>>1 (4)

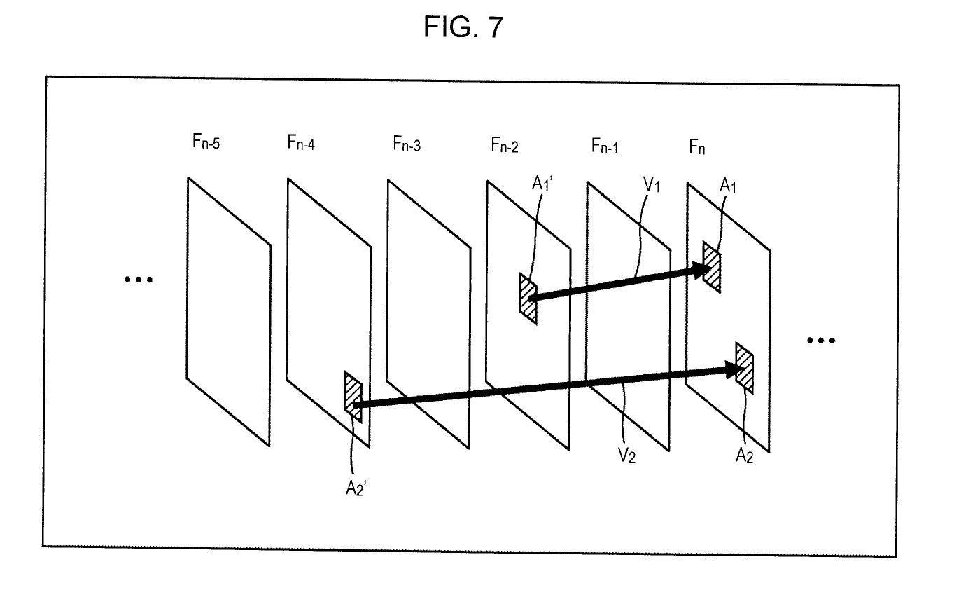

FIG. 7 is a diagram illustrating a prediction/compensation process of the multi-reference frame in the H.264/AVC scheme. In the H.264/AVC scheme, a motion prediction/compensation method of the multi-reference frame is determined.

In the example of FIG. 7, a target frame Fn to be encoded now and frames Fn−5, . . . , Fn−1 already subjected to encoding are shown. The frame Fn−1 is a frame preceding by one from the target frame Fn on a time axis, the frame Fn−2 is a frame preceding by two from the target frame Fn on the time axis, and the frame Fn−3 is a frame preceding by three from the target frame Fn on the time axis. Further, the frame Fn−4 is a frame preceding by four from the target frame Fn and the frame Fn−5 is a frame preceding by five from the target frame Fn. In general, a smaller reference picture number (ref_id) is affixed as the frame is closer to the target frame Fn on the time axis. That is, the frame Fn−1 is the smallest reference picture number and the reference picture number becomes smaller in the order of Fn−2, . . . , Fn−5.

A block A1 and a block A2 are shown in the target frame Fn. The block A1 is considered to have a correlation with a block A1′ of the frame Fn−2 preceding by two and a motion vector V1 is searched. Further, the block A2 is considered to have a correlation with a block A1′ of the frame Fn−4 preceding by four and a motion vector V2 is searched.

In the H.264/AVC scheme, as described above, a plurality of reference frames can be stored in the memory and another reference frame can be referred in one frame (picture). That is, for example, the block A1 refers to the frame Fn−2 and the block A2 refers to the frame Fn−4. In this way, in one picture, each block can have independent reference frame information (reference picture number (ref_id)).

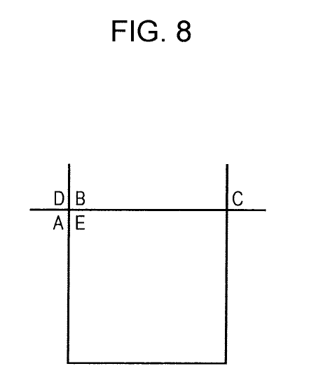

In the H.264/AVC scheme, when the vast amount of motion vector information is generated by performing the motion prediction/compensation process described with reference to FIGS. 5 to 7 and the motion vector information is encoded without any countermeasure, the encoding efficiency may deteriorate. Accordingly, in the H.264/AVC scheme, the size of the encoding information of the motion vector is reduced by a method shown in FIG. 8.

FIG. 8 is a diagram illustrating a method of generating the motion vector information in accordance with the H.264/AVC scheme.

In the example of FIG. 8, a target block E (for example, 16×16 pixels) to be encoded now and blocks A to D which are already subjected to the encoding and are adjacent to the target block E are shown.

That is, the block D is adjacent to the left upper side of the target block E, the block B is adjacent to the upper side of the target block E, the block C is adjacent to the right upper side of the target block E, and the block A is adjacent to the left side of the target block E. Further, blocks which are not divided like the blocks A to D indicate the blocks among the several blocks with 16×16 pixels to 4×4 pixels described above with reference to FIG. 5.

For example, the motion vector information regarding X (=A, B, C, D, E) is expressed mv_{X}. First, the prediction motion vector information pmv_{E} regarding the target block E is generated by Expression (5) by median prediction by the use of the motion vector information regarding the blocks A, B, and C.

pmv_{E}=med(mv_{A},mv_{B},mv_{c}) (5)

In some cases, the motion vector information regarding the block C is unavailable due to the reason that this motion vector information is at the end of an image frame or is not yet encoded. In this case, the motion vector information regarding the block C is substituted by the motion vector information regarding the block D.

Data mvd_{E} which is added as the motion vector information regarding the target block E to the header section of the compressed image is generated by Expression (6) using pmv_{E}.

mvd_{E}=mv_{E}−pmv_{E} (6)

In effect, components in the horizontal and vertical directions of the motion vector information are independently processed.

In this way, it is possible to reduce the motion vector information by generating the prediction motion vector information and adding a difference between the prediction motion vector information generated through the correlation with the adjacent block and the motion vector information to the header section of the compression image.

### Examples of Configurations of In-Screen Prediction Unit and Secondary Difference Generation Unit

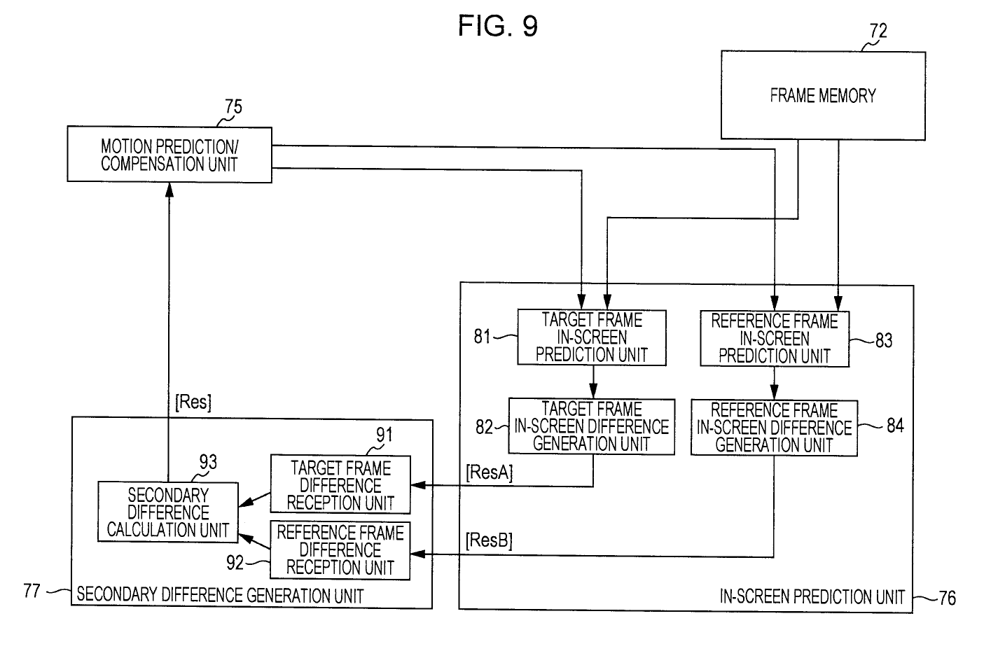

FIG. 9 is a block diagram illustrating an example of the detailed configuration of the in-screen prediction unit and the secondary difference generation unit.

In the example of FIG. 9, the in-screen prediction unit 76 includes a target frame in-screen prediction unit 81, a target frame in-screen difference generation unit 82, a target frame in-screen prediction unit 83, and a reference frame in-screen difference generation unit 84.

The secondary difference generation unit 77 includes a target frame difference reception unit 91, a reference frame difference reception unit 92, and a secondary difference calculation unit 93.

In the motion prediction/compensation unit 75, a motion vector is detected based on the image subjected to the inter-processing and the reference image, and the reference block B corresponding to the target block A of the image subjected to the inter-processing is calculated by the detected motion vector information in the reference image. The motion prediction/compensation unit 75 outputs information regarding the target block A to the target frame in-screen prediction unit 81 and outputs information regarding the reference block B to the reference frame in-screen prediction unit 82.

The target frame in-screen prediction unit 81 reads the reference image of the target frame from the frame memory 72 with reference to the information regarding the target block A. The target frame in-screen prediction unit 81 performs the in-screen prediction on the target frame to detect the block A′ corresponding to the target block A and outputs information regarding the target block A and the block A′ to the target frame in-screen difference generation unit 82.

The target frame in-screen difference generation unit 82 generates difference information between the pixel value of the target block A and the pixel value of the block A′ in the target frame and outputs the difference information as difference information [ResA] of the target frame to the target frame difference reception unit 91.

The reference frame in-screen prediction unit 83 reads the reference image of the reference frame from the frame memory 72 with reference to the information regarding the reference block B. The reference frame in-screen prediction unit 83 performs the in-screen prediction on the reference frame to detect the block B′ corresponding to the reference block B and outputs the information regarding the reference block B and the block B′ to the reference frame in-screen difference generation unit 84.

The reference frame in-screen difference generation unit 84 generates difference information between the pixel value of the reference block B and the pixel value of the block B′ in the reference frame and outputs the difference information as difference information [ResB] of the reference frame to the reference frame difference reception unit 92.

The target frame difference reception unit 91 receives the difference information [ResA] of the target frame from the target frame in-screen difference generation unit 82 and supplies the difference information [ResA] to the secondary difference calculation unit 93. The reference frame difference reception unit 92 receives the difference information [ResB] of the reference frame from reference frame in-screen difference generation unit 84 and supplies the difference information [ResB] to the secondary difference calculation unit 93.

The secondary difference calculation unit 93 calculates secondary difference information [Res] between the difference information [ResA] of the target frame and the difference information [ResB] of the reference frame. The secondary difference calculation unit 93 outputs the calculated second difference information [Res] to the motion prediction/compensation unit 75.

### Examples of Operations of In-Screen Prediction Unit and Secondary Difference Generation Unit

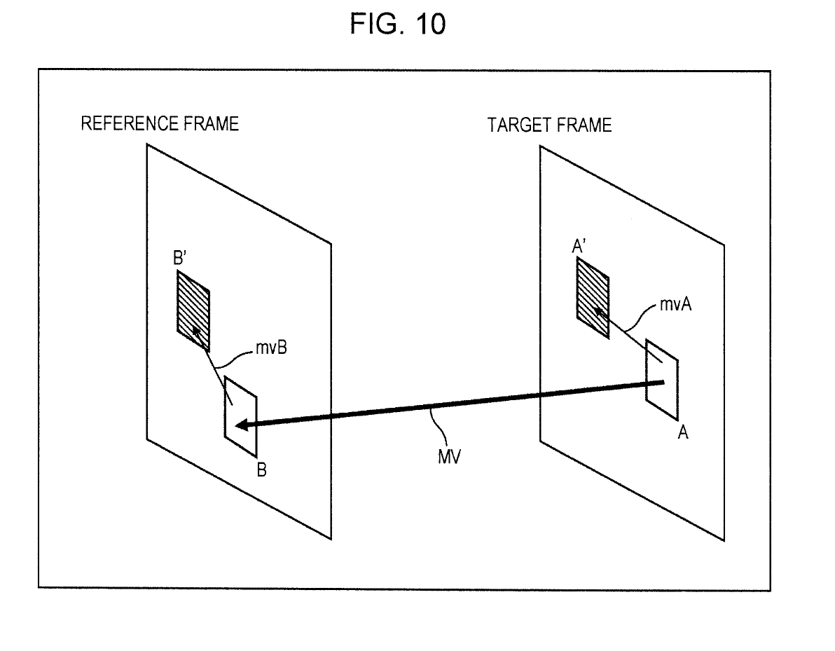

Next, the operations of the in-screen prediction unit and the secondary difference generation unit will be described with reference to FIG. 10. In the example of FIG. 10, the target block A is shown in the target frame.

First, the motion prediction/compensation unit 75 performs a normal motion prediction process in accordance with the H.264/AVC scheme to calculate the reference block B corresponding to the target block A by the inter-motion vector MV in the reference frame. According to the related art, a difference between the pixel value of the reference block B and the pixel value of the target block A as the prediction image of the target block A is encoded.

Next, the target frame in-screen prediction unit 81 performs the in-screen prediction on the target frame to detect the block A′ corresponding to the target block A. Simultaneously, the reference frame in-screen prediction unit 83 performs the in-screen prediction on the reference frame to detect the block B′ corresponding to the reference block B.

In the example of FIG. 10, the target frame in-screen prediction unit 81 detects the block A′ corresponding to the target block A by the intra-motion vector mvA by using the intra-motion prediction method as the in-screen prediction. Likewise, the reference frame in-screen prediction unit 83 detects the block B′ corresponding to the reference block B by the intra-motion vector mvB by using the intra-motion prediction method as the in-screen prediction.

As in the example of FIG. 10, when the intra-motion prediction method is used as the in-screen prediction, it is necessary to transmit the intra-motion vector mvA in the target frame and the intra-motion vector mvB in the reference frame to the decoding side. Accordingly, the intra-motion vector mvA and intra-motion vector mvB are supplied to the lossless encoding unit 66.

At this time, for example, the intra-motion vector mvA may be transmitted without any change and only difference information between the intra-motion vector mvB and the intra-motion vector mvA may be transmitted for the intra-motion vector mvB. Of course, the intra-motion vector mvB may be transmitted without any change and only difference information between the intra-motion vector mvA and the intra-motion vector mvB may be transmitted for the intra-motion vector mvA.

The pixel values of the target block A, the block A′, the reference block B, and the block B′ are denoted by [A], [A′], [B], and [B′], respectively. The target frame in-screen difference generation unit 82 generates the difference information [ResA] of the target frame using Expression (7) below and the reference frame in-screen difference generation unit 84 generates the difference information [ResB] of the reference frame using Expression (8) below.

[ResA]=[A]−[A′] (7)

[ResB]=[B]−[B′] (8)

The secondary difference calculation unit 93 generates the secondary difference information [Res] using Expression (9) below.

[Res]=[ResA]−[ResB] (9)

The second difference information [Res] generated in this way is encoded, and then transmitted to the decoding side. That is, the secondary difference information [Res] is output to the motion prediction/compensation unit 75. The motion prediction/compensation unit 75 outputs a difference [A′]+[ResB] between the pixel value [A] of the target block A and the secondary difference information [Res] to the prediction image selection unit 78. When the prediction image selection unit 78 selects the difference [A′]+[ResB] between the image to be subjected to the inter-processing as the prediction generated in the optimum inter-prediction mode and the secondary difference information, the difference [A′]+[ResB] is output to the calculation units 63 and 70.

In the calculation unit 63, the difference [A′]+[ResB] is subtracted from the original image [A] and the secondary difference information [Res] which is the subtraction result is output to the orthogonal transform unit 64. The secondary difference information [Res] is subjected to orthogonal transform by the orthogonal transform unit 64 is quantized by the quantization unit 65, and is subjected to the encoding by the lossless encoding unit 66.

On the other hand, in the calculation unit 70, the second difference information [Res] subjected to the orthogonal transform and the quantization is subjected to inverse quantization and inverse orthogonal transform and is input, and the difference [A′]+[ResB] between the image to be subjected to the inter-processing and the secondary difference information is also input from the prediction image selection unit 78. Accordingly, the calculation unit 70 can obtain [A] by adding the secondary difference information [Res] and the difference [A′]+[ResB] and outputs the result to the de-block filter 71 and the frame memory 72.

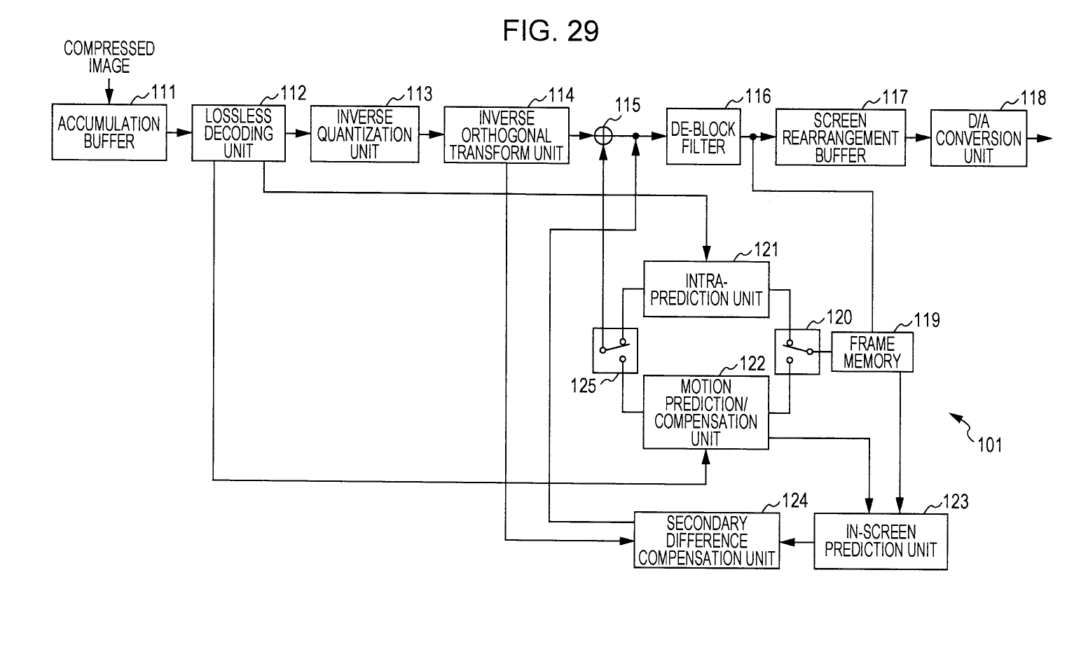

That is, in this case, the calculation unit 70 performs the same process as the process performed in the difference compensation unit 124 of an image decoding apparatus 101 described with reference to FIG. 29.

As described above, the prediction image (reference block B) of the target block A is calculated. In the invention, the difference between the target block A and the in-screen prediction image and the difference between the reference block B and the in-screen prediction image are also calculated. Further, the difference (second difference) between the differences is encoded. Thus, it is possible to improve the encoding efficiency.

In the example of FIG. 10, the target block A and the reference block B which can correspond to each other by the inter-motion vector MV are exemplified. In this example, there are exemplified the target block A and the block A′ which can correspond to each other by an intra-motion vector mv1 and the reference block B and the block B′ which can correspond to each other by an intra-motion vector mv2.

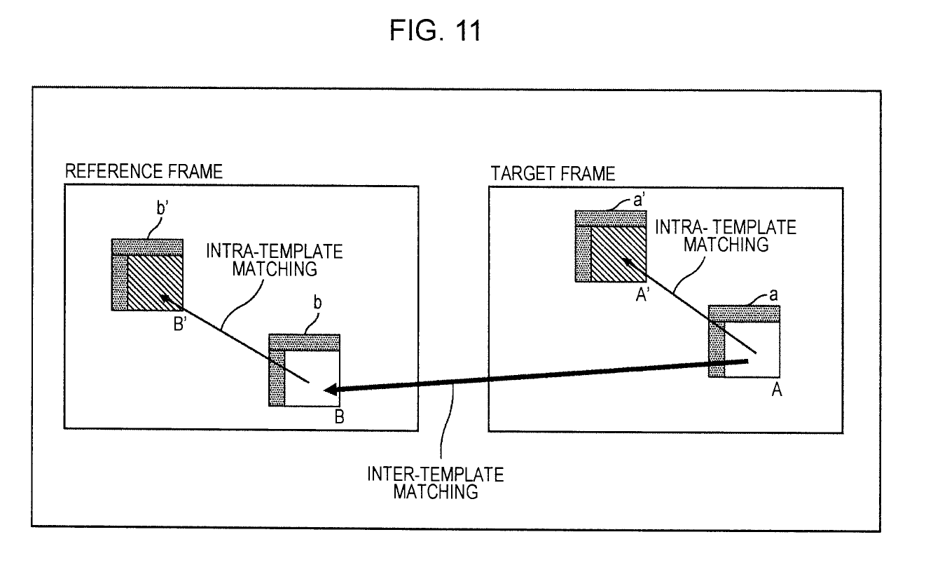

The method of allowing the target block A to correspond to the reference block B and the method of allowing the target block A and the reference block B to correspond to the block A′ and the block B′, respectively are not limited to the example of FIG. 10. For example, a method shown in FIG. 11 may be used for the correspondence.

FIG. 11 is a diagram illustrating other operation examples of the motion prediction/compensation and the in-screen prediction. In the example of FIG. 11, the target block A and the reference block B can correspond to each other by an inter-template matching. Further, the target block A and the reference block B can correspond to the block A′ and the block B′, respectively, by an intra-template matching.

In the example of FIG. 11, the motion prediction/compensation unit 75 performs the motion prediction/compensation process on the target block A by the inter-template matching. That is, the motion prediction/compensation unit 75 searches, from the reference frame, a region b with the highest correlation with the pixel value of a template region a which is adjacent to the target block A and has the pixels already subjected to the encoding. Then, the motion prediction/compensation unit 75 detects the block B corresponding to the region b searched from the reference frame as the block corresponding to the target block A. In this way, the reference block B can correspond to the target block A.

The target frame in-screen prediction unit 81 performs the in-screen prediction process on the target block A by the intra-template matching. That is, the target frame in-screen prediction unit 81 searches, from a target frame, a region a′ with the highest correlation with the pixel value of the template region a of the target block A. Then, the target frame in-screen prediction unit 81 detects the block A′ corresponding to the region a′ searched from the target frame as the block corresponding to the target block A. In this way, the block A′ can correspond to the target block A.

Likewise, the reference frame in-screen prediction unit 83 performs the in-screen prediction process on the reference block B by the intra-template matching. That is, the reference frame in-screen prediction unit 83 searches, from the target frame, a region b′ with the highest correlation with the pixel value of the template region b of the reference block B. Then, the reference frame in-screen prediction unit 83 searches the block B′ corresponding to the region b′ searched from the target frame as the block corresponding to the target block B. In this way, the block B′ can correspond to the target block B.

Unlike the example of FIG. 10, since it is not necessary to transmit the inter-motion vector or the intra-motion vector to the decoding side in the example of FIG. 11, the bit amount is reduced compared to the example of FIG. 10.

In the example of FIG. 11, the pixel values of the regions a and b used in the inter-prediction are also used in the intra-prediction. Accordingly, it is possible to prevent the number of times of memory access from increasing considerably.

The application range of the invention is not limited to a combination of the examples of FIGS. 10 and 11. For example, the target block A and the reference block B can correspond to each other by the inter-motion vector MV shown in FIG. 10. At this time, the target block A and the reference block B can correspond to the block A′ and the block B′, respectively, by the intra-template matching shown in FIG. 11.

For example, the target block A and the reference block B can correspond to each other by the inter-template matching shown in FIG. 11. At this time, the target block A and the reference block B can correspond to the block A′ and the block B′, respectively, by the intra-motion vectors mv1 and mv2 shown in FIG. 10.

When the bit rate is high, the compression efficiency is higher compared to a case where the prediction efficiency is made high even in a case where the bit amount is increased by the motion vector information. Therefore, it is possible to realize the encoding efficiency higher than that of the combination shown in FIG. 10.

On the other hand, when the bit rate is low, the higher encoding efficiency can be realized by reducing the bit amount by the motion vector information. Therefore, it is possible to realize the encoding efficiency higher than that of the combination shown in FIG. 11.

### [Description of Encoding Process of Image Encoding Apparatus]

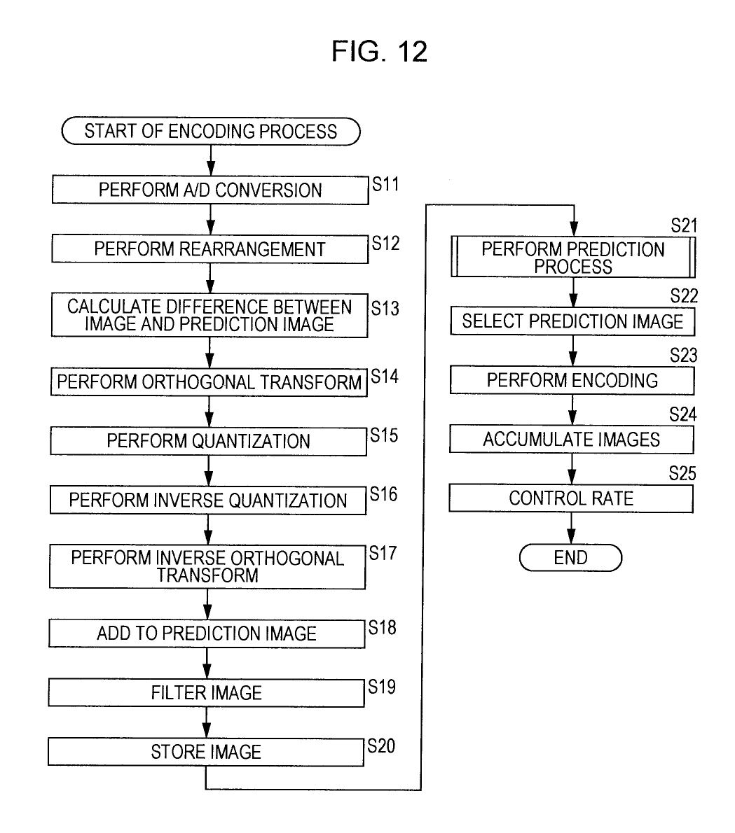

Next, the encoding process of the image encoding apparatus 51 in FIG. 4 will be described with reference to the flowchart of FIG. 12.

In step S11, the A/D conversion unit 61 performs the A/D conversion on the input image. In step S12, the screen rearrangement buffer 62 stores the images supplied from the A/D conversion unit 61 and rearranges the images in the encoding order from the display order of the pictures.

In step S13, the calculation unit 63 calculates the difference between the image rearranged in step S12 and the prediction image. The prediction image is supplied to the calculation unit 63 from the motion prediction/compensation unit 75 via the prediction image selection unit 78 in the case of the inter-prediction, while being supplied from the intra-prediction unit 74 in the case of the intra-prediction.

The difference data has an amount smaller than that of the original image data. Accordingly, it is possible to compress the amount of data compared to the case where the image is encoded without any change.

In step S14, the orthogonal transform unit 64 performs the orthogonal transform on the difference information supplied from the calculation unit 63. Specifically, the transform coefficient is output by performing the orthogonal transform such as discrete cosine transform or Karhunen-Loeve transform. In step S15, the quantization unit 65 quantizes the transform coefficient. When the transform coefficient is quantized, the rate is controlled by a process of step S25 described below.

The difference information quantized in this way is locally decoded as follows. That is, in step S16, the inverse quantization unit 68 performs the inverse quantization on the transform coefficient quantized by the quantization unit 65 in accordance with the characteristics corresponding to the characteristics of the quantization unit 65. In step S17, the inverse orthogonal transform unit 69 performs the inverse orthogonal transform on the transform coefficient subjected to the inverse quantization by the inverse quantization unit 68 in accordance with the characteristics corresponding to the characteristics of the orthogonal transform unit 64.

In step S18, the calculation unit 70 adds the prediction image input via the prediction image selection unit 78 to the locally decoded difference information to generate the locally decoded image (image corresponding to the image input to the calculation unit 63). In step S19, the de-block filter 71 filters the image output from the calculation unit 70. In this way, block distortion is eliminated. In step S20, the frame memory 72 stores the filtered image. Further, an image which is not filtered by the de-block filter 71 is supplied from the calculation unit 70 and is stored in the frame memory 72.

In step S21, the intra-prediction unit 74 and the motion prediction/compensation unit 75 each perform the prediction process on the image. That is, in step S21, the intra prediction unit 74 performs the intra-prediction process of the intra-prediction mode. The motion prediction/compensation unit 75 performs the motion prediction/compensation process in the inter-prediction mode. At this time, the target block and the reference block which can correspond to each other by the inter-prediction are subjected to the in-screen prediction, and the difference information of the target frame and the difference information of the reference frame, which are the difference with the in-screen prediction image, are generated. Then, the secondary difference information, which is the difference between the difference information of the target frame and the difference information of the reference frame, is generated.

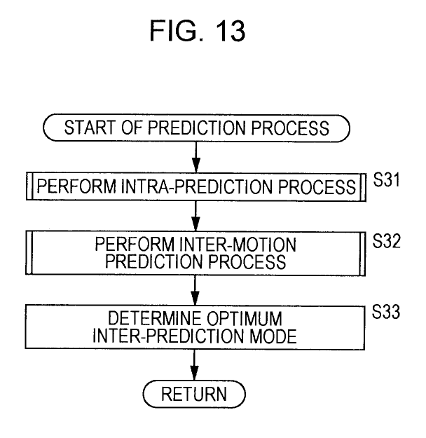

As the detailed prediction process of step S21 is described below with reference to FIG. 13, the prediction process is performed in each of all the candidate intra-prediction modes to calculate each of the cost function values of all the candidate prediction modes. The optimum intra-prediction mode is selected based on the calculated cost function values, and the prediction image generated by the intra-prediction of the optimum intra-prediction mode and the cost function value thereof are supplied to the prediction image selection unit 78.

The prediction process in all the candidate inter-prediction modes is performed, so that the secondary difference information is generated from the difference information between the target block and the reference block. Each of the cost function values in all the candidate prediction modes is calculated using the generated secondary difference information. Further, the optimum inter-prediction mode is selected based on the calculated cost function value, and the difference between the secondary difference information and the image to be subjected to the inter-processing as the prediction image generated in the optimum inter-prediction mode and the cost function value of the optimum inter-prediction mode are supplied to the prediction image selection unit 78.

In step S22, the prediction image selection unit 78 determines, as the optimum prediction mode, one of the optimum intra prediction mode and the optimum inter-prediction mode based on the cost function values output from the intra-prediction unit 74 and the motion prediction/compensation unit 75. Then, the prediction image selection unit 78 selects the prediction image of the determined optimum prediction mode and supplies the prediction image to the calculation units 63 and 70. The prediction image (the difference between the image to be subjected to the inter-processing and the secondary difference information) is used in the calculation of steps S13 and S18, as described above.

The selection information of the prediction image is supplied to the intra-prediction unit 74 or the motion prediction/compensation unit 75. When the prediction image in the optimum intra-prediction mode is selected, the intra-prediction unit 74 information (that is, intra-prediction mode information) indicating the optimum intra-prediction mode to the lossless encoding unit 66.

When the prediction image of the optimum inter-prediction mode is selected, the motion prediction/compensation unit 75 outputs information indicating the optimum inter-prediction mode to the lossless encoding unit 66 and outputs information corresponding to the optimum inter-prediction mode, if necessary. Examples of the information corresponding to the optimum inter-prediction mode include motion vector information, flag information, and reference frame information.

In step S23, the lossless encoding unit 66 encodes the transform coefficient quantized and output from the quantization unit 65. That is, the difference image (the secondary difference image in the inter-processing) is subjected to the lossless encoding, such as variable length coding or arithmetic coding, and is compressed. At this time, for example, the intra-prediction mode information input to the lossless encoding unit 66 in step S22 described above and from the intra-prediction unit 74 or the information corresponding to the optimum inter-prediction mode from the motion prediction/compensation unit 75 is also encoded and added to the header information.

In step S24, the accumulation buffer 67 accumulates the difference image as the compressed image. The compressed image accumulated in the accumulation buffer 67 is appropriately read and transmitted to the decoding side via a transmission line.

In step S25, based on the compressed image accumulated in the accumulation buffer 67, the rate control unit 79 controls the rate of the quantization operation of the quantization unit 65 so that the overflow or the underflow does not occur.

### [Description of Prediction Process]

Next, the prediction process of step S21 in FIG. 12 will be described with reference to the flowchart of FIG. 13.

When the image, which is to be processed, supplied from the screen rearrangement buffer 62 is an image of the block which is subjected to the intra-processing, the decoded image to be referred is read from the frame memory 72 and is supplied to the intra-prediction unit 74 via the switch 73. In step S31, based on the image, the intra-prediction unit 74 performs the intra-prediction on the pixels of the block to be processed in all the candidate intra-prediction modes. The pixels which are not subjected to de-block filtering by the de-block filter 71 are used as the decoded pixels to be referred.

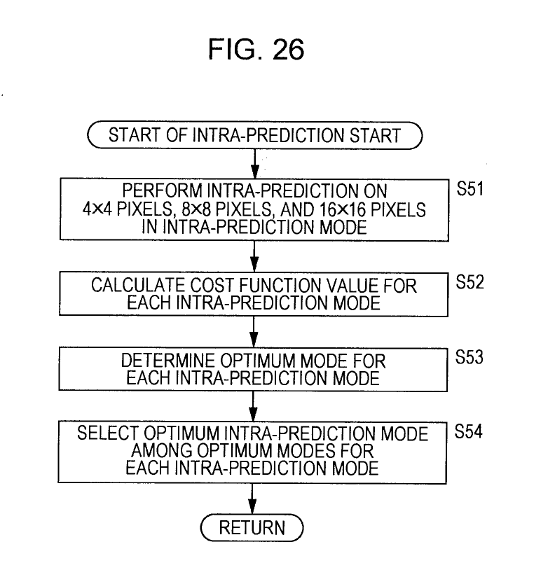

As the detailed intra-prediction process of step S31 is described below with reference to FIG. 26, the intra-prediction is performed in all the candidate intra-prediction modes to calculate the cost function values in all the candidate intra-prediction modes. The optimum intra-prediction mode is selected based on the calculated cost function values, and the prediction image generated by the intra-prediction of the optimum intra-prediction mode and the cost function value thereof are supplied to the prediction image selection unit 78.

When the image, which is to be processed, supplied from the screen rearrangement buffer 62 is an image which is subjected to the inter-processing, the image to be referred is read from the frame memory 72 and is supplied to the motion prediction/compensation unit 75 via the switch 73. In step S32, the motion prediction/compensation unit 75 performs the inter-motion prediction process based on this image. That is, the motion prediction/compensation unit 75 performs the motion prediction process of all the candidate inter-prediction modes with reference to the image supplied from the frame memory 72.

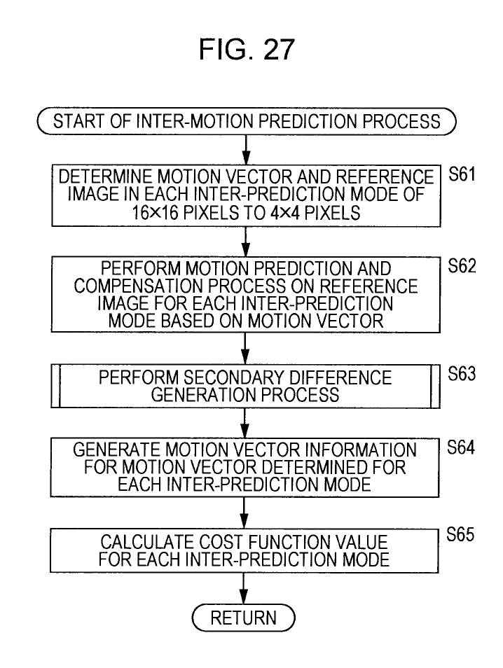

As the detailed inter-prediction process of step S32 is described below with reference to FIG. 27, the motion prediction process is performed in all the candidate inter-prediction modes to generate the secondary difference information for all the candidate inter-prediction modes. The cost function value is calculated using the generated secondary difference information.

In step S33, the motion prediction/compensation unit 75 determines, as the optimum inter-prediction mode, the prediction mode with the minimum value among the cost function values calculated for the inter-prediction modes in step S32. Then, the motion prediction/compensation unit 75 supplies the prediction image selection unit 78 with the difference between the image to be subjected to the inter-processing and the secondary difference information generated in the optimum inter-prediction mode and the cost function value of the optimum inter-prediction mode.

[Description of Intra-Prediction Process in Accordance with H.264/AVC Scheme]

Next, each mode of the intra-prediction determined in accordance with the H.264/AVC scheme will be described.

First, the intra-prediction mode for a luminance image will be described. In the intra-prediction mode of the luminance signal, three methods of an intra 4×4 prediction mode, an intra 8×8 prediction mode, and an intra 16×16 prediction mode are provided. The intra-prediction mode is a mode for determining a block unit and is set for each macro block. Further, an intra-prediction mode of a color difference signal can be set in each macro block so as to be independent from that of the luminance signal.

In the case of the intra 4×4 prediction mode, one prediction mode can be set in each target block with 4×4 pixels from nine types of prediction modes. Further, in the case of the intra 8×8 prediction mode, one prediction mode can be set in each target block with 8×8 pixels from nine types of prediction modes. Furthermore, in the case of the intra 16×16 prediction mode, one prediction mode can be set in each target macro block with 16×16 pixels from four types of prediction modes.

Hereinafter, the intra 4×4 prediction mode, the intra 8×8 prediction mode, and the intra 16×16 prediction mode are also appropriately referred to as an intra-prediction mode with 4×4 pixels, an intra-prediction mode with 8×8 pixels, and an intra-prediction mode with 16×16 pixels, respectively.

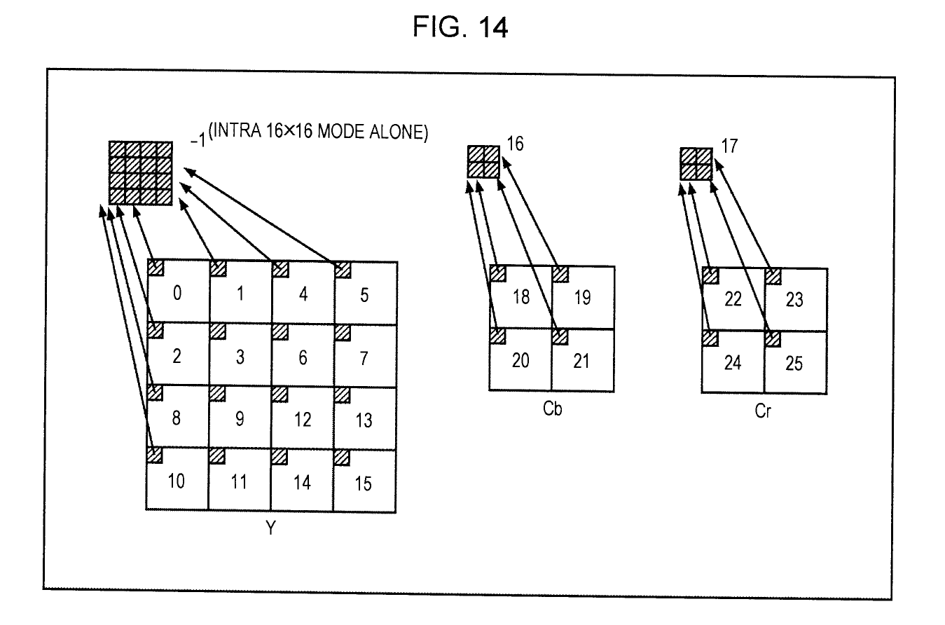

In the example of FIG. 14, numbers −1 to 25 affixed to the respective blocks represent a bit stream sequence (processing sequence in the decoding side) of the respective blocks. As for the luminance signal, a macro block is divided into blocks with 4×4 pixels and is subjected to DCT of 4×4 pixels. Only the case of the intra 16×16 prediction mode, direct-current components of the respective blocks are collected to generate a 4×4 matrix, as shown in a block of −1. Further, this matrix is subjected to orthogonal transform.

On the other hand, as for the color difference signal, a macro block is divided into blocks with 4×4 pixels and is subjected to DCT of 4×4 pixels. As shown in the blocks of 16 and 17, direct-current components of the respective blocks are collected to generate a 2×2 matrix. Further, this matrix is subjected to orthogonal transform.

As for the intra 8×8 prediction mode, the above-described process can be applied only when a target macro block is subjected to 8×8 orthogonal transform with a high-profile or a higher profile.

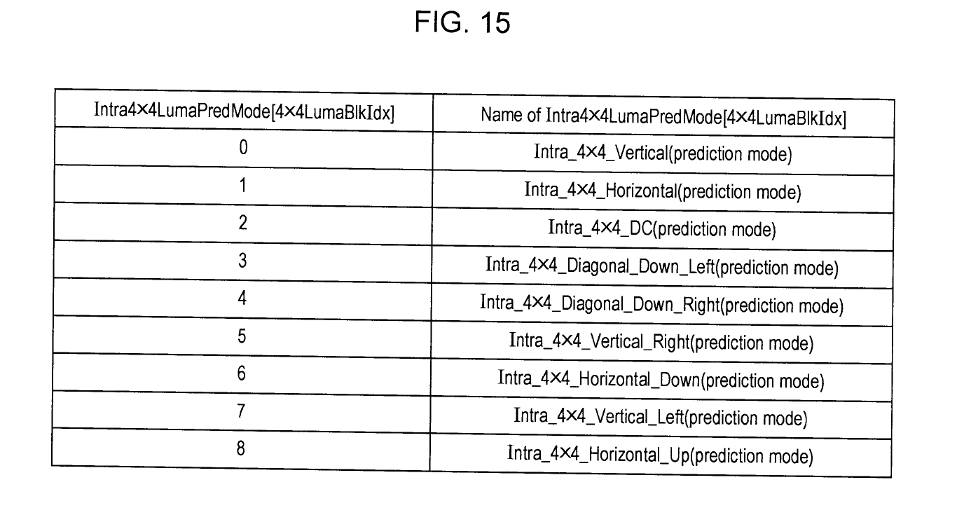

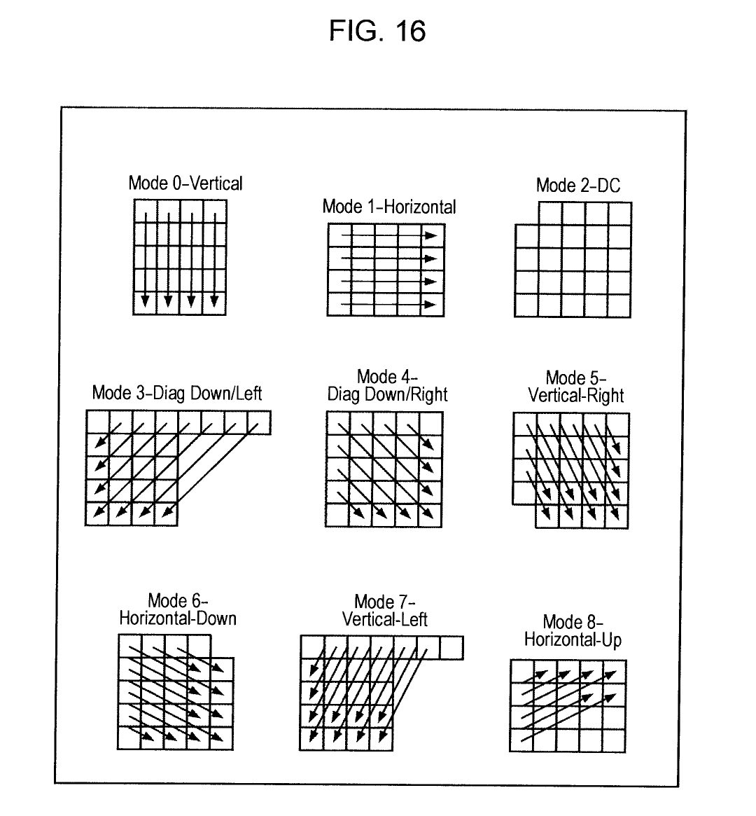

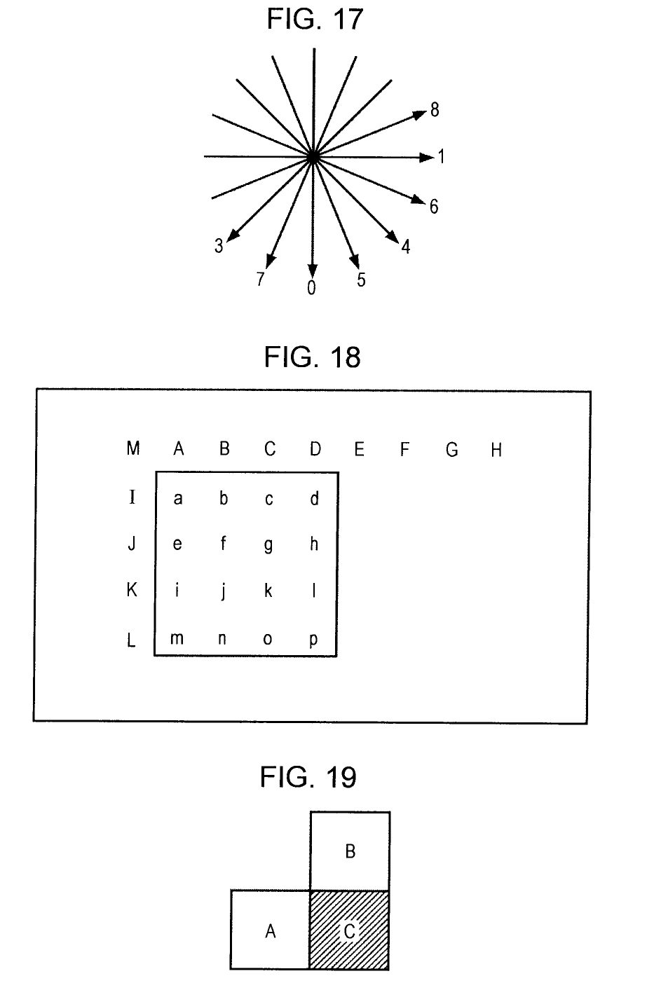

FIGS. 15 and 16 are diagrams illustrating the nine types of intra-prediction mode (Intra_{—}4×4_pred_mode) of 4×4 pixels of the luminance signal. The eight types of modes other than Mode 2 representing a mean (DC) prediction correspond to directions indicated by numbers 0, 1, and 3 to 8 in FIG. 17.

The nine types of Intra_{—}4×4_pred_mode will be described with reference to FIG. 18. In the example of FIG. 18, pixels a to p represent pixels of a target block to be subjected to the intra-processing and pixel values A to M represent pixel values of the pixels belonging to adjacent blocks. That is, the pixels a to p are the image of the processing target read from the screen rearrangement buffer 62 and the pixel values A to M are the pixel values of the decoded image which is read from the frame memory 72 and is referred.

In the case of the respective intra-prediction modes shown in FIGS. 15 and 16, the prediction pixel values of the pixels a to p are generated as follows using the pixel values A to M of the pixels belonging to the adjacent blocks. Further, an expression a pixel value is “available” means that the pixel value is available due to no reason that the pixel value is at the end of an image frame or is not yet encoded. On the other hand, an expression a pixel value is “unavailable” means that the pixel value is unavailable due to the reason that the pixel value is at the end of an image frame or is not yet encoded.

Mode 0 is a vertical prediction mode (Vertical Prediction Mode) and is applied only when the pixel values A to D are “available”. In this case, the prediction pixel values of the pixels a to p are generated by Expression (10) below.

prediction pixel values of pixels a, e, i, m=A

prediction pixel values of pixels b, f, j, n=B

prediction pixel values of pixels c, g, k, o=C

prediction pixel values of pixels d, h, l, p=D (10)

Mode 1 is a horizontal prediction mode (Horizontal Prediction Mode) and is applied only when the pixel values I to L are “available”. In this case, the prediction pixel values of the pixels a to p are generated by Expression (11) below.

prediction pixel values of pixels a, b, c, d=I

prediction pixel values of pixels e, f, g, h=J

prediction pixel values of pixels i, j, k, l=K

prediction pixel values of pixels m, n, o, p=L (11)

Mode 2 is a DC prediction mode (DC Prediction Mode). When all of the pixel values A, B, C, D, I, J, K, and L are “available”, the prediction pixel values are generated by Expression (12).

(A+B+C+D+I+J+K+L+4)>>3 (12)

When all of the pixel values A, B, C, and D are “unavailable”, the prediction pixel values are generated by Expression (13).

(I+J+K+L+2)>>2 (13)

When all of the pixel values I, J, K, and L are “unavailable”, the prediction pixel values are generated by Expression (14).

(A+B+C+D+2)>>2 (14)

Further, when all of the pixel values A, B, C, D, I, J, K, and L are “unavailable”, 128 is used as the prediction pixel value.

Mode 3 is a Diagonal_Down_Left Prediction mode and is applied only when the pixel values A, B, C, D, I, J, K, L, and M are “available.” In this case, the prediction pixel values of the pixels a to p are generated by Expression (15) below.

prediction pixel value of pixel a=(A+2B+C+2)>>2

prediction pixel values of pixels b, e=(B+2C+D+2)>>2

prediction pixel values of pixels c, f, i=(C+2D+E+2)>>2

prediction pixel values of pixels, d, g, j, m=(D+2E+F+2)>>2

prediction pixel values of pixels h, k, n=(E+2F+G+2)>>2

prediction pixel values of pixels l, o=(F+2G+H+2)>>2

prediction pixel value of pixel p=(G+3H+2)>>2 (15)

Mode 4 is a Diagonal_Down_Right Prediction mode and is applied only when the pixel values A, B, C, D, I, J, K, L, and M are “available.” In this case, the prediction pixel values of the pixels a to p are generated by Expression (16) below.

prediction pixel value of pixel m=(J+2K+L+2)>>2

prediction pixel values of pixels i, n=(I+2J+K+2)>>2

prediction pixel values of pixels e, j, o=(M+2I+J+2)>>2

prediction pixel values of pixels a, f, k, p=(A+2M+I+2)>>2

prediction pixel values of pixels b, g, l=(M+2A+B+2)>>2

prediction pixel values of pixels c, h=(A+2B+C+2)>>2

prediction pixel value of pixel d=(B+2C+D+2)>>2 (16)

Mode 5 is a Diagonal_Vertical_Right Prediction mode and is applied only when the pixel values A, B, C, D, I, J, K, L, and M are “available.” In this case, the prediction pixel values of the pixels a to p are generated by Expression (17) below.

prediction pixel values of pixels a, j=(M+A+1)>>1

prediction pixel values of pixels b, k=(A+B+1)>>1

prediction pixel values of pixels c, l=(B+C+1)>>1

prediction pixel value of pixel d=(C+D+1)>>1

prediction pixel value of pixel e, n=(I+2M+A+2)>>2

prediction pixel values of pixels f, o=(M+2A+B+2)>>2

prediction pixel values of pixels g, p=(A+2B+C+2)>>2

prediction pixel value of pixel h=(B+2C+D+2)>>2

prediction pixel value of pixel i=(M+2I+J+2)>>2

prediction pixel value of pixel m=(I+2J+K+2)>>2 (17)

Mode 6 is a Horizontal Down Prediction mode and is applied only when the pixel values A, B, C, D, I, J, K, L, and M are “available.” In this case, the prediction pixel values of the pixels a to p are generated by Expression (18) below.

prediction pixel values of pixels a, g=(M+I+1)>>1

prediction pixel values of pixels b, h=(I+2M+A+2)>>2

prediction pixel value of pixel c=(M+2A+B+2)>>2

prediction pixel value of pixel d=(A+2B+C+2)>>2

prediction pixel values of pixels e, k=(I+J+1)>>1

prediction pixel values of pixels f, l=(M+2I+J+2)>>2

prediction pixel values of pixels i, o=(J+K+1)>>1

prediction pixel values of pixels j, p=(I+2J+K+2)>>2

prediction pixel value of pixel m=(K+L+1)>>1

prediction pixel value of pixel n=(J+2K+L+2)>>2 (18)

Mode 7 is a Vertical_Left Prediction mode and is applied only when the pixel values A, B, C, D, I, J, K, L, and M are “available.” In this case, the prediction pixel values of the pixels a to p are generated by Expression (19) below.

prediction pixel value of pixel a=(A+B+1)>>1

prediction pixel values of pixels b, i=(B+C+1)>>1

prediction pixel values of pixels c, j=(C+D+1)>>1

prediction pixel values of pixels d, k=(D+E+1)>>1

prediction pixel value of pixel l=(E+F+1)>>1

prediction pixel value of pixel e=(A+2B+C+2)>>2

prediction pixel values of pixels f, m=(B+2C+D+2)>>2

prediction pixel values of pixels g, n=(C+2D+E+2)>>2

prediction pixel values of pixels h, o=(D+2E+F+2)>>2

prediction pixel value of pixel p=(E+2F+G+2)>>2 (19)

Mode 8 is a Horizontal_Up Prediction mode and is applied only when the pixel values A, B, C, D, I, J, K, L, and M are “available.” In this case, the prediction pixel values of the pixels a to p are generated by Expression (20) below.

prediction pixel value of pixel a=(I+J+1)>>1

prediction pixel value of pixel b=(I+2J+K+2)>>2

prediction pixel values of pixels c, e=(J+K+1)>>1

prediction pixel values of pixels d, f=(J+2K+L+2)>>2

prediction pixel values of pixels g, i=(K+L+1)>>1

prediction pixel values of pixels h, j=(K+3L+2)>>2

prediction pixel values of pixels k, l, m, n, o, p=L (20)

Next, a method of encoding the intra-prediction mode (Intra_{—}4×4_pred_mode) of 4×4 pixels of the luminance signal will be described with reference to FIG. 19. In the example of FIG. 19, a target block C which has 4×4 pixels and is to be encoded is shown. Further, blocks A and B which are adjacent to the target block C and have 4×4 pixels are shown.

In this case, it is considered that the Intra_{—}4×4_pred_mode in the target block C has a high correlation with the Intra_{—}4×4_pred_modes in the blocks A and B. It is possible to realize the higher encoding efficiency by performing the encoding process by the use of this correlation as follows.

That is, in the example of FIG. 19, when the Intra_{—}4×4_pred_modes in the blocks A and B are Intra_{—}4×4_pred_modeA and Intra_{—}4×4_pred_modeB, MostProbableMode is defined as Expression (21) below.

MostProbableMode=Min(Intra_{—}4×4_pred_modeA,Intra_{—}4×4_pred_modeB) (21)

That is, the block to which a smaller mode number can be assigned between the blocks A and B is considered to be MostProbableMode.

In a bit stream, two values of prev_intra4×4_pred_mode_flag[luma4×4BlkIdx] and rem_intra4×4_pred_mode[luma4×4BlkIdx] are defined as parameters for the target block C. Therefore, the value of the Intra_{—}4×4_pred_mode, intra4×4PredMode[luma4×4BlkIdx] for the target block C can be obtained by a decoding process by performing a process based on a pseudocode expressed by Expression (22).

if (prev_intra4×4_pred_mode_flag[luma4×4BlkIdx]) Intra4×4PredMode[luma4×4BlkIdx]=MostProbableMode else

if (rem_intra4×4_pred_mode[luma4×4BlkIdx]<MostProbableMode) Intra4×4PredMode[luma4×4BlkIdx]=rem_intra4×4_pred_mode[luma4×4BlkIdx]else Intra4×4PredMode[luma4×4BlkIdx]=rem_intra4×4_pred_mode[luma4×4BlkIdx]+1 (22)

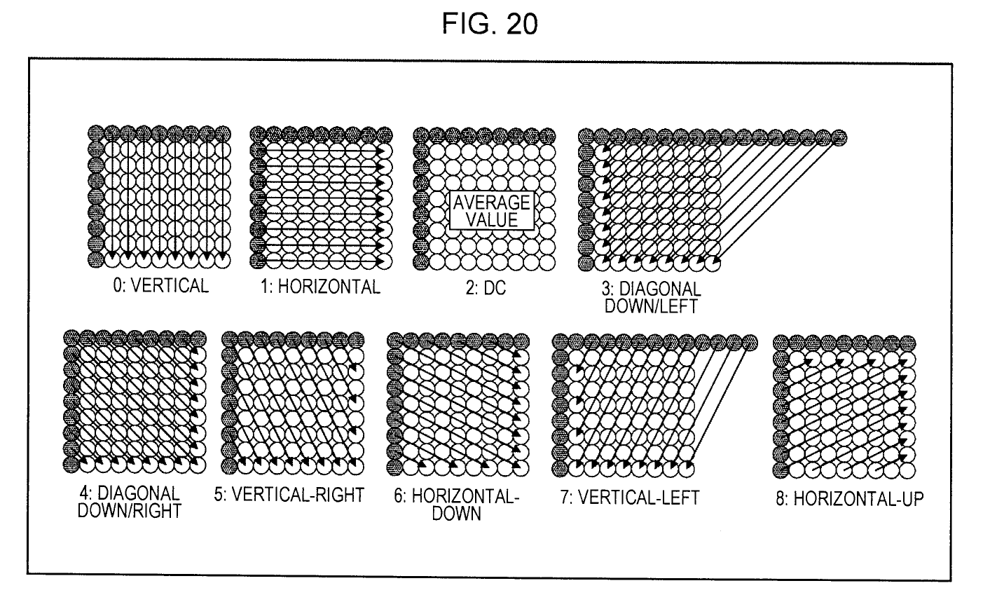

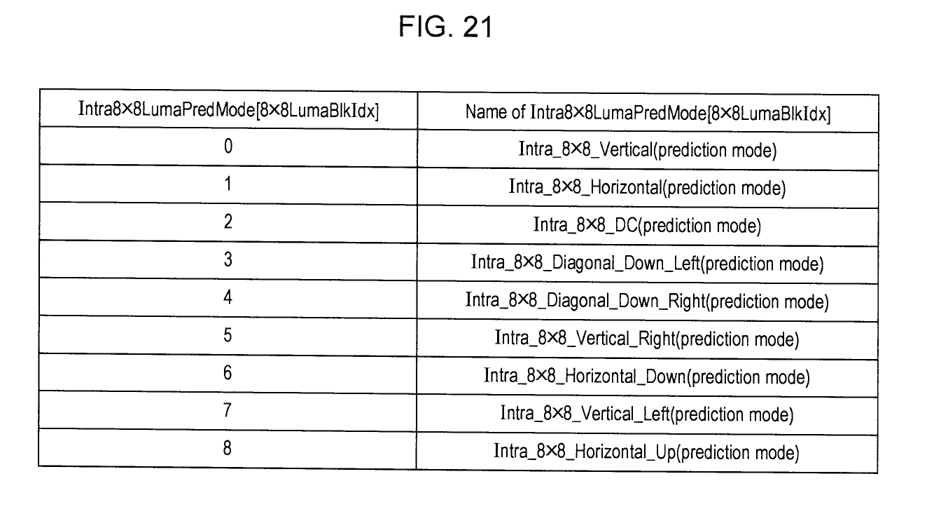

Next, the intra-prediction mode of 8×8 pixels will be described. FIGS. 20 and 21 are diagrams illustrating the nine types of intra-prediction modes (Intra_{—}8×8_pred_mode) of 8×8 pixels of the luminance signal.

The pixel value of a target 8×8 block is set as P[x, y] (where 0≦x≦7 and 0≦y≦7) and the pixel value of an adjacent block is expressed p[−1, −1], . . . , p[−1, 15], p[−1, 0], . . . , [p−1, 7].

In the intra-prediction mode of 8×8 pixels, a low-pass filtering process is performed on the adjacent pixels before generation of a prediction value. Here, the pixel values before the low-pass filtering process are expressed by p[−1, −1], . . . , p[−1, 15], p[−1, 0], . . . , p[−1, 7] and the pixel values after the low-pass filtering process are expressed by p′[−1, −1], . . . , p′[−1, 15], p′[−1, 0], . . . , p′[−1, 7].

First, p′ [0, −1] is calculated by Expression (23) below when p[−1, −1] is “available”, whereas being calculated by Expression (24) below when p[−1, −1] is “not available.”

p′[0,−1]=(p[−1,−1]+2*p[0,−1]+p[1,−1]+2)>>2 (23)

p′[0,−1]=(3*p[0,−1]+p[1,−1]+2)>>2 (24)

p′[x,−1] (where x=0, . . . , 7) is calculated by Expression (25) below.

p′[x,−1]=(p[x−1,−1]+2*p[x,−1]+p[x+1,−1]+2)>>2 (25)

p′[x, −1] (where x=8, . . . , 15) is calculated by Expression (26) below when p[x, −1] (where x=8, . . . , 15) is “available.”

p′[x,−1]=(p[x−1,−1]+2*p[x,−1]+p[x+1,−1]+2)>>2

p′[15,−1]=(p[14,−1]+3*p[15,−1]+2)>>2 (26)

p′[x−1,−1] is calculated as follows when p[−1, −1] is “available.” That is, p′[−1, −1] is calculated by Expression (27) when both p[0, −1] and p[−1, 0] are “available”, whereas is calculated by Expression (28) when p[−1, 0] is “unavailable.” Further, p′[−1, −1] is calculated by Expression (29) when p[0, −1] is “unavailable.”

p′[−1,−1]=(p[0,−1]+2*p[−1,−1]+p[−1,0]+2)>>2 (27)

p′[−1,−1]=(3*p[−1,−1]+p[0,−1]+2)>>2 (28)

p′[−1,−1]=(3*p[−1,−1]+p[−1,0]+2)>>2 (29)

p′[−1, y] (where y=0, . . . , 7) is calculated as follows when p[−1, y] (where y=0, . . . , 7) is “available.” That is, p′[−1, 0] is first calculated by Expression (30) below when p[−1, −1] is “available”, whereas being calculated by Expression (31) below when p[−1, −1] is “unavailable.”

p′[−1,0]=(p[−1,−1]+2*p[−1,0]+p[−1,1]+2)>>2 (30)

p′[−1,0]−(3*p[−1,0]+p[−1,1]+2)>>2 (31)

p′[−1, y] (where y=1, . . . , 6) is calculated by Expression (32) below and p′[−1, 7] is calculated by Expression (33).

p′[−1,y]=(p[−1,y−1]+2*p[−1,y]+p[−1,y+1]+2)>>2 (32)

p′[−1,7]=(p[−1,6]+3*p[−1,7]+2)>>2 (33)

The prediction value in each intra-prediction mode shown in FIGS. 20 and 21 is generated as follows using p′ calculated in this way.

Mode 0 is a Vertical Prediction mode and is applied only when p[x, −1] (where x=0, . . . , 7) is “available.”. The prediction value pred8×8_{L}[x, y] is generated by Expression (34) below.

pred8×8_{L}[x,y]=p′[x,−1]x,y=0, . . . , 7 (34)

Mode 1 is a Horizontal Prediction mode and is applied only when p[−1, y] (where y=0, . . . , 7) is “available.”. The prediction value pred8×8_{L}[x, y] is generated by Expression (35) below.

pred8×8_{L}[x,y]=p′[−1,y]x,y=0, . . . , 7 (35)

Mode 2 is a DC Prediction mode and the prediction value pred8×8_{L}[x, y] is generated as follows. That is, the prediction value pred8×8_{L}[x, y] is generated by Expression (36) below, when both p[x, −1] (where x=0, . . . , 7) and p[−1, y] (where y=0, . . . , 7) are “available.”

$$\begin{matrix}[ Expression 5 ] & \\ Pred 8 \times {8}_{L} [ x , y ] = ( {\sum }_{{x}^{′} = 0}^{7} {P}^{′} [ {x}^{′} , - 1 ] + {\sum }_{{y}^{′} = 0}^{7} {P}^{′} [ - 1 , y ] + 8 ) >> 4 & ( 36 )\end{matrix}$$

The prediction value pred8×8_{L}[x, y] is generated by Expression (37) below, when both p[x, −1] (where x=0, . . . , 7) is “available” but p[−1, y] (where y=0, . . . , 7) is “unavailable.”

$$\begin{matrix}[ Expression 6 ] & \\ Pred 8 \times {8}_{L} [ x , y ] = ( {\sum }_{{x}^{′} = 0}^{7} {P}^{′} [ {x}^{′} , - 1 ] + 4 ) >> 3 & ( 37 )\end{matrix}$$

The prediction value pred8×8_{L}[x, y] is generated by Expression (38) below, when both p[x, −1] (where x=0, . . . , 7) is “unavailable” but p[−1, y] (where y=0, . . . , 7) is “available.”

$$\begin{matrix}[ Expression 7 ] & \\ Pred 8 \times {8}_{L} [ x , y ] = ( {\sum }_{{y}^{′} = 0}^{7} {P}^{′} [ - 1 , y ] + 4 ) >> 3 & ( 38 )\end{matrix}$$

The prediction value pred8×8_{L}[x, y] is generated by Expression (39) below, when both p[x, −1] (where x=0, . . . , 7) and p[−1, y] (where y=0, . . . , 7) are “unavailable.”

pred8×8_{L}[x,y]=128 (39)

In this case, Expression (39) is used in a case of 8-bit input.

Mode 3 is a Diagonal-Down_Left_prediction mode and the prediction value pred8×8_{L}[x, y] is generated as follows. That is, the Diagonal-Down_Left_prediction mode is applied only when p[x, −1], x=0, . . . , 15 is “available.” When x=7 and y=7, the prediction value is generated by Expression (40) below, whereas the other prediction values are generated by Expression (41).

pred8×8_{L}[x,y]=(p′[14,−1]+3*p[15,−1]+2)>>2 (40)

red8×8_{L}[x,y]=(p′[x+y,−1]+2*p[x+y+1,−1]+p′[x+y+2,−1]+2)>>2 (41)

Mode 4 is a Diagonal_Down_Right prediction mode and the prediction value pred8×8_{L}[x, y] is generated as follows. That is, the Diagonal_Down_Right_prediction mode is applied only when p[x, −1], x=0, . . . , 7 and p[−1, y], y=0, . . . , 7 are “available.” When x>y, the prediction pixel value is generated by Expression (42) below. When x<y, the prediction pixel value is generated by Expression (43) below. When x=y, the prediction pixel value is generated by Expression (44) below.

pred8×8_{L}[x,y]=(p′[x−y−2,−1]+2*p′[x−y−1,−1]+p′[x−y,−1]+2)>>2 (42)

pred8×8_{L}[x,y]=(p′[−1,y−x−2]+2*p′[−1,y−x−1]+p′[−1,y−x]+2)>>2 (43)

pred8×8_{L}[x,y]=(p′[0,−1]+2*p′[−1,−1]+p′[−1,0]+2)>>2 (44)

Mode 5 is a Vertical_Right_prediction mode and the prediction value pred8×8_{L}[x, y] is generated as follows. That is, the Vertical_Right_prediction mode is applied only when p[x, −1], x=0, . . . , 7 and p[−1, y], y=0, . . . , 7 are “available.” Now, zVR is defined by Expression (45) below.

zVR=2*x−y (45)

At this time, when zVR is 0, 2, 4, 6, 8, 10, 12, and 14, the pixel prediction value is generated by Expression (46). When zVR is 1, 3, 5, 7, 9, 11, and 13, the pixel prediction value is generated by Expression (47).

pred8×8_{L}[x,y]=(p′[x−(y>>1)−1,−1]+p′[x−(y>>1),−1]+1)>>1 (46)

pred8×8_{L}[x,y]=(p′[x−(y>>1)−2,−1]+2*p′[x−(y>>1)−1,−1]+p′[x−(y>>1),−1]+2)>>2 (47)

When zVR is −1, the pixel prediction value is generated by Expression (48). When zVR is not −1, that is, is −2, −3, −4, −5, −6, and −7, the pixel prediction value is generated by Expression (49) below.

pred8×8_{L}[x,y]=(p′[−1,0]+2*p′[−1,−1]+p′[0,−1]+2)>>2 (48)

pred8×8_{L}[x,y]=(p′[−1,y−2*x−1]+2*p′[−1,y−2*x−2]+p′[−1,y−2*x−3]+2)>>2 (49)

Mode 6 is a Horizontal Down prediction mode and the prediction value pred8×8_{L}[x, y] is generated as follows. That is, the Horizontal Down prediction mode is applied only when p[x, −1], x=0, . . . , 7 and p[−1, y], y=−1, . . . , 7 are “available.” Now, zVR is defined by Expression (50) below.

zHD=2*y−x (50)

At this time, when zHD is 0, 2, 4, 6, 8, 10, 12, and 14, the prediction pixel value is generated by Expression (51). When zHD is 1, 3, 5, 7, 9, 11, and 13, the prediction pixel value is generated by Expression (52).

pred8×8_{L}[x,y]=(p′[−1,y−(x>>1)−1]+p′[−1,y−(x>>1)]+1)>>1 (51)

pred8×8_{L}[x,y]=(p′[−1,y−(x>>1)−2]+2*p′[−1,y−(x>>1)−1],−1+p′[−1,y−(x>>1)]+2)>>2 (52)

When zHD is −1, the pixel prediction value is generated by Expression (53). When zHD is not −1, that is, is −2, −3, −4, −5, −6, and −7, the pixel prediction value is generated by Expression (54) below.

pred8×8_{L}[x,y]=(p′[−1,0]+2*p′[−1,−1]+p′[0,−1]+2)>>2 (53)

pred8×8_{L}[x,y]=(p′[x−2*y−1,−1]+2*p′[x−2*y−2,−1]+p′[x−2*y−3,−1]+2)>>2 (54)

Mode 7 is a Vertical_Left_prediction mode and the prediction value pred8×8_{L}[x, y] is generated as follows. That is, the Vertical_Left_prediction mode is applied only when p[x, −1], x=0, . . . , 15 is “available”. When y=0, 2, 4, and 6, the prediction pixel value is generated by Expression (55) below. Otherwise, that is, when y=1, 3, 5, and 7, the prediction pixel value is generated by Expression (56) below.

pred8×8_{L}[x,y]=(p′[x+(y>>1),−1]+p′[x+(y>>1)+1,−1]+1)>>1 (55)

pred8×8_{L}[x,y]=(p′[x+(y>>1),−1]+2*p′[x+(y>>1)+1,−1]+p′[x+(y>>1)+2,−1]+2)>>2 (56)

Mode 8 is a Horizontal_Up_prediction mode and the prediction value pred8×8_{L}[x, y] is generated as follows. That is, the Horizontal_Up_prediction mode is applied only when p[−1, y], y=0, . . . , 7 is “available.” Hereinafter, zHU is defined by Expression (57) below.

zHU=x+2*y (57)

When zHU is 0, 2, 4, 6, 8, 10, 12, and 14, the pixel prediction value is generated by Expression (58). When zHU is 1, 3, 5, 7, 9, and 11, the pixel prediction value is generated by Expression (59).

pred8×8_{L}[x,y]=(p′[−1,y+(x>>1)]+p′[−1,y+(x>>1)+1]+1)>>1 (58)

pred8×8_{L}[x,y]=(p′[−1,y+(x>>1)] (59)

When the value of zHU is 13, the pixel prediction value is generated by Expression (60). When the value of zHU is not 13, that is, is larger than 13, the prediction pixel value is generated by Expression (61) below.

pred8×8_{L}[x,y]=(p′[−1,6]+3*p′[−1,7]+2)>>2 (60)

pred8×8_{L}[x,y]=p′[−1,7] (61)

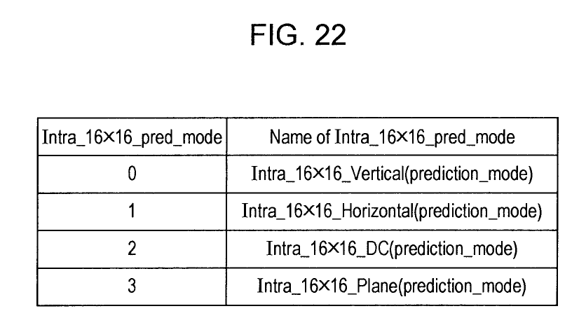

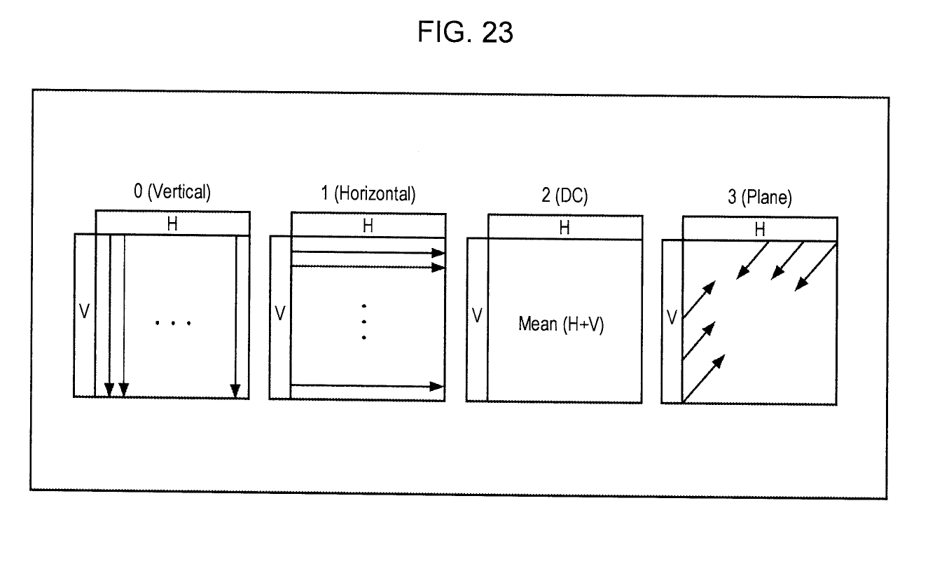

Next, the intra-prediction mode of 16×16 pixels will be described. FIGS. 22 and 23 are diagrams illustrating four types of intra-prediction modes (Intra_{—}16×16_pred_mode) of 16×16 pixels of the luminance signal.

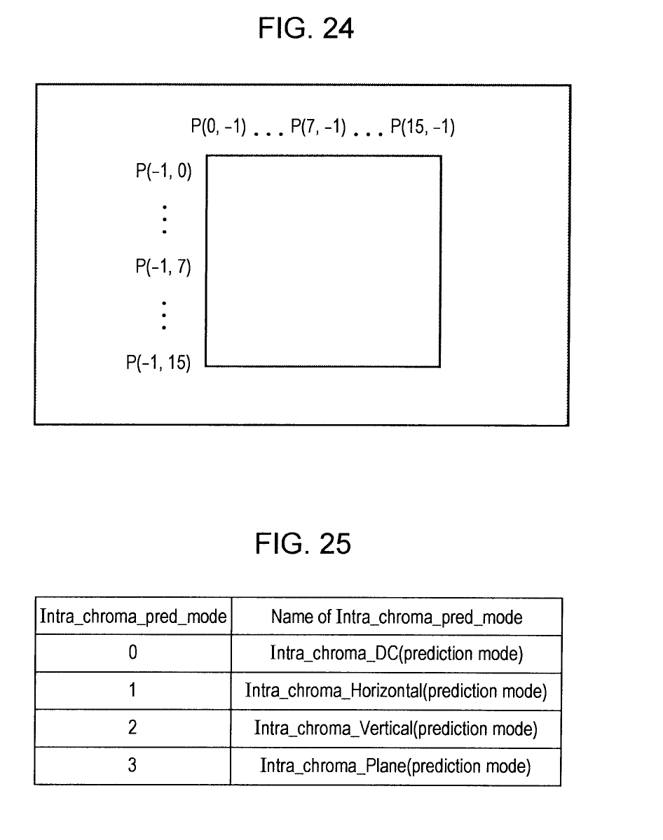

The four types of intra-prediction modes will be described with reference to FIG. 24. In the example of FIG. 24, a target macro block A to be subjected to the intra-processing is shown. P(x, y); x, y=−1, 0, . . . , 15 denotes the pixel value of a pixel adjacent to the target macro block A.

Mode 0 is a Vertical Prediction mode and is applied only when P(x, −1); x, y=−1, 0, . . . , 15 is “available.” In this case, the prediction pixel value Pred (x, y) of each pixel of the target macro block A is generated by Expression (62) below.

Pred(x,y)=P(x,−1); x, y=0, . . . , 15 (62)

Mode 1 is a Horizontal Prediction mode and is applied only when P(−1, y); x, y=−1, 0, . . . , 15 is “available.” In this case, the prediction pixel value Pred (x, y) of each pixel of the target macro block A is generated by Expression (63) below.

Pred(x,y)=P(−1,y); x, y=0, . . . , 15 (63)

Mode 2 is a DC Prediction mode and is applied only when both P(x, −1) and P(−1, y); x, y=−1, 0, . . . , 15 are “available.” In this case, the prediction pixel value Pred (x, y) of each pixel of the target macro block A is generated by Expression (64) below.

$$\begin{matrix}[ Expression 8 ] & \\ Pred ( x , y ) = [ {\sum }_{{x}^{′} = 0}^{15} P ( {x}^{′} , - 1 ) + {\sum }_{{y}^{′} = 0}^{15} P ( - 1 , {y}^{′} ) + 16 ] >> 5 \\ with x , y = 0 , … , 15 & ( 64 )\end{matrix}$$

Further, when P(x, −1); x, y=−1, 0, . . . , 15 is “unavailable”, the prediction pixel value Pred (x, y) of each pixel of the target macro block A is generated by Expression (65) below.

$$\begin{matrix}[ Expression 9 ] & \\ Pred ( x , y ) = [ {\sum }_{{y}^{′} = 0}^{15} P ( - 1 , {y}^{′} ) + 8 ] >> 4 with x , y = 0 , … , 15 & ( 65 )\end{matrix}$$

When P(−1, y); x, y=−1, 0, . . . , 15 is “unavailable”, the prediction pixel value Pred (x, y) of each pixel of the target macro block A is generated by Expression (66) below.

$$\begin{matrix}[ Expression 10 ] & \\ Pred ( x , y ) = [ {\sum }_{{y}^{′} = 0}^{15} P ( {x}^{′} , - 1 ) + 8 ] >> 4 with x , y = 0 , … , 15 & ( 66 )\end{matrix}$$

When both P(x, −1) and P(−1, y); x, y=−1, 0, . . . , 15 are “unavailable”, 128 is used as the prediction pixel value.

Mode 3 is a Plane Prediction mode and is applied only when both P(x, −1) and P(−1, y); x, y=−1, 0, . . . , 15 are “available.” In this case, the prediction pixel value Pred (x, y) of each pixel of the target macro block A is generated by Expression (67) below.

$$\begin{matrix}[ Expression 11 ] & \\ Pred ( x , y ) = Clip 1 ( ( a + b \cdot ( x - 7 ) + c \cdot ( y - 7 ) + 16 ) >> 5 ) \\ a = 16 \cdot ( P ( - 1 , 15 ) + P ( 15 , - 1 ) ) \\ b = ( 5 \cdot H + 32 ) >> 6 \\ c = ( 5 \cdot V + 32 ) >> 6 \\ H = {\sum }_{x = 1}^{8} x \cdot ( P ( 7 + x , - 1 ) - P ( 7 - x , - 1 ) ) \\ V = {\sum }_{y = 1}^{8} y \cdot ( P ( - 1 , 7 + y ) - P ( - 1 , 7 - y ) ) & ( 67 )\end{matrix}$$

Next, the intra-prediction mode of the color difference signal will be described. FIG. 25 is a diagram illustrating four types of intra-prediction modes (Intra_chroma_pred_mode) of the color difference signal. The intra-prediction mode of the color difference signal can be set to be independent from the intra-prediction mode of the luminance signal. The intra-prediction mode of the color difference signal is the same as the above-described intra-prediction mode of 16×16 pixels of the luminance signal in the order.

However, the intra-prediction mode of 16×16 pixels of the luminance signal is used for a block with 16×16 pixels, whereas the intra-prediction mode of the color difference signal is used for a block with 8×8 pixels. As shown in FIGS. 22 and 25 described above, the mode number of the intra-prediction mode of the luminance signal does not correspond to the mode number of the intra-prediction mode of the color difference signal.

Here, the definitions of the pixel value of the target macro block A and the adjacent pixel value of the intra-prediction mode of 16×16 pixels of the luminance signal described above with reference to FIG. 24 are applied correspondingly. For example, the pixel value of a pixel adjacent to the target macro block A (8×8 pixels in the case of the color difference signal) to be subjected to the intra-processing is set to P(x, y); x, y=−1, 0, . . . , 7.

Mode 0 is a DC Prediction mode. When both P(x, −1) and P(−1, y); x, y=−1, 0, . . . , 7 are “available”, the prediction pixel value Pred (x, y) of each pixel of the target macro block A is generated by Expression (68) below.

$$\begin{matrix}[ Expression 12 ] & \\ Pred ( x , y ) = ( ( {\sum }_{n = 0}^{7} ( P ( - 1 , n ) + P ( n , - 1 ) ) ) + 8 ) >> 4 \\ with x , y = 0 , … , 7 & ( 68 )\end{matrix}$$

When P(−1, y); x, y=−1, 0, . . . , 7 is “unavailable”, the prediction pixel value Pred (x, y) of each pixel of the target macro block A is generated by Expression (69) below.

$$\begin{matrix}[ Expression 13 ] & \\ Pred ( x , y ) = [ ( {\sum }_{n = 0}^{7} P ( n , - 1 ) ) + 4 ] >> 3 \\ with x , y = 0 , … , 7 & ( 69 )\end{matrix}$$

When P(x, −1); x, y=−1, 0, . . . , 7 is “unavailable”, the prediction pixel value Pred (x, y) of each pixel of the target macro block A is generated by Expression (70) below.

$$Pred ( x , y ) = [ ( {\sum }_{n = 0}^{7} P ( - 1 , n ) ) + 4 ] >> 3 with x , y = 0 , … , 7 \qquad ( 70 )$$

Mode 1 is a Horizontal Prediction mode and is applied only when P(−1, y); x, y=−1, 0, . . . , 7 is “available.” In this case, the prediction pixel value Pred (x, y) of each pixel of the target macro block A is generated by Expression (71) below.

Pred(x,y)=P(−1,y); x, y=0, . . . , 7 (71)

Mode 2 is a Vertical Prediction mode and is applied only when P(x, −1); x, y=−1, 0, . . . , 7 is “available.” In this case, the prediction pixel value Pred (x, y) of each pixel of the target macro block A is generated by Expression (63) below.

Pred(x,y)=P(x,−1); x, y=0, . . . , 7 (72)

Mode 3 is a Plane Prediction mode and is applied only when both P(x, −1) and P(−1, y); x, y=−1, 0, . . . , 7 are “available.” In this case, the prediction pixel value Pred (x, y) of each pixel of the target macro block A is generated by Expression (73) below.

$$\begin{matrix}[ Expression 15 ] & \\ Pred ( x , y ) = Clip 1 ( a + b \cdot ( x - 3 ) + c \cdot ( y - 3 ) + 16 ) >> 5 ; \\ x , y = 0 , … , 7 \\ a = 16 \cdot ( P ( - 1 , 7 ) + P ( 1 , - 1 ) ) \\ b = ( 17 \cdot H + 16 ) >> 5 \\ c = ( 17 \cdot V + 16 ) >> 5 \\ H = {\sum }_{x = 1}^{4} x \cdot [ P ( 3 + x , - 1 ) - P ( 3 - x , - 1 ) ] \\ V = {\sum }_{y = 1}^{4} y \cdot [ P ( - 1 , 3 + y ) - P ( - 1 , 3 - y ) ] & ( 73 )\end{matrix}$$

As described above, as the intra-prediction mode of the luminance signal, there are the prediction modes of the nine types of block units with 4×4 pixels and block units with 8×8 pixels and the four types of macro block units with 16×16 pixels. The mode of the block unit is set for each macro block unit. As the intra-prediction mode of the color difference signal, there are the four types of block units with 8×8 pixels. The intra-prediction mode of the color difference signal can be set to be independent from the intra-prediction mode of the luminance signal.

In the intra-prediction mode (intra 4×4 prediction mode) of 4×4 pixels of the luminance signal and the intra-prediction mode (intra 8×8 prediction mode) of 8×8 pixels of the luminance signal, one intra-prediction mode is set for each block of 4×4 pixels and 8×8 pixels of the luminance signal. In the intra-prediction mode (intra 16×16 prediction mode) of 16×16 pixels of the luminance signal and the intra-prediction mode of the color difference signal, one prediction mode is set for one macro block.

The types of prediction modes correspond to the directions indicated by the numbers 0, 1, and 3 to 8 described with reference to FIG. 17. Prediction Mode 2 is a mean prediction.

### [Description of Intra-Prediction Process]

Next, an intra-prediction process, which is a process performed in the prediction modes, in step S31 of FIG. 13 will be described with reference to the flowchart of FIG. 26. In the example of FIG. 26, a case of the luminance signal is described as an example.

In step S51, the intra-prediction unit 74 performs the intra-prediction in the intra-prediction modes of 4×4 pixels, 8×8 pixels, and 16×16 pixels.

Specifically, the intra-prediction unit 74 performs the intra-prediction on the pixels of the block to be processed and with reference to the decoded image read from the frame memory 72 and supplied via the switch 73. When the intra-prediction process is performed in each intra-prediction mode, the prediction image in each intra-prediction mode is generated. Further, pixels which are not subjected to the de-block filtering by the de-block filter 71 are used as the decoded pixels to be referred.

In step S52, the intra-prediction unit 74 calculates the cost function value of each of the intra-prediction modes of 4×4 pixels, 8×8 pixels, and 16×16 pixels. Here, the cost function value is calculated based on one of a High Complexity mode and a Low Complexity mode. These modes are defined with JM (Joint Model) which is reference software in the H.264/AVC scheme.

That is, as for the High Complexity mode, even a temporary encoding process is performed as the process of step S51 on all of the candidate prediction modes. Further, the cost function value expressed in Expression (74) below is calculated for each prediction mode. The prediction mode with the minimum value is selected as the optimum prediction mode.

Cost(Mode)=D+λ·R (74)

In this expression, D denotes a difference (distortion) between the original image and the decoded image, R denotes an occurrence encoding amount including even the orthogonal transform coefficient, and λ denotes a Lagrange multiplier given as a function of a quantization parameter QP.

On the other hand, as for the Low Complexity mode, the generation of the prediction image and the calculation of a header bit such as motion vector information, prediction mode information, flag information, or the like are performed as the process of step S51 on all of the candidate prediction modes. Further, the cost function value expressed in Expression (75) below is calculated for each prediction mode. The prediction mode with the minimum value is selected as the optimum prediction mode.

Cost(Mode)=D+QPtoQuant(QP)·Header_Bit (75)

In this expression, D denotes a difference (distortion) between the original image and the decoded image, Header_Bit denotes a header bit for the prediction mode, and QPtoQuant is a function given as a function of a quantization parameter QP.

In the Low Complexity mode, the prediction images are just generated for all of the prediction modes. Accordingly, since it is not necessary to perform the encoding process and the decoding process, the calculation amount is reduced.

In step S53, the intra-prediction unit 74 determines the optimum mode for each of the intra-prediction modes of 4×4 pixels, 8×8 pixels, and 16×16 pixels. That is, in the intra 4×4 prediction mode and the intra 8×8 prediction mode, as described above, there are the nine types of prediction modes. In the intra 16×16 prediction mode, there are the four types of prediction modes. Accordingly, the intra-prediction unit 74 determines the optimum intra 4×4 prediction mode, the optimum intra 8×8 prediction mode, and the optimum intra 16×16 prediction mode based on the cost function values calculated in step S42.

In step S54, the intra-prediction unit 74 selects the optimum intra-prediction mode from the optimum modes determined for the intra-prediction modes of 4×4 pixels, 8×8 pixels, and 16×16 pixels based on the cost function values calculated in step S42. That is, the mode with the minimum cost function value is selected as the optimum intra prediction mode from the optimum modes determined for 4×4 pixels, 8×8 pixels, and 16×16 pixels.

Then, the intra-prediction unit 74 supplies the predict image generated in the optimum intra-prediction mode and its cost function value to the prediction image selection unit 78.

### [Description of Inter-Motion Prediction Process]

Next, the inter-motion prediction process of step S32 in FIG. 13 will be described with reference to the flowchart of FIG. 27.

In step S61, the motion prediction/compensation unit 75 determines the motion vector and the reference image of each of the eight types of inter-prediction modes of 16×16 pixels to 4×4 pixels described above with reference to FIG. 5. That is, the motion vector and the reference image are determined for the block to be processed in each inter-prediction mode.

In step S62, the motion prediction/compensation unit 75 performs the motion prediction and compensation processes on the reference image in each of the eight types of inter-prediction modes of 16×16 pixels to 4×4 pixels based on the motion vector determined in step S51. That is, the reference block B which can correspond to the target block A by the inter-motion vector MV in the reference frame is calculated through this process. The motion prediction/compensation unit 75 outputs the information regarding the target block A and the information regarding the reference block B to the in-screen prediction unit 76.

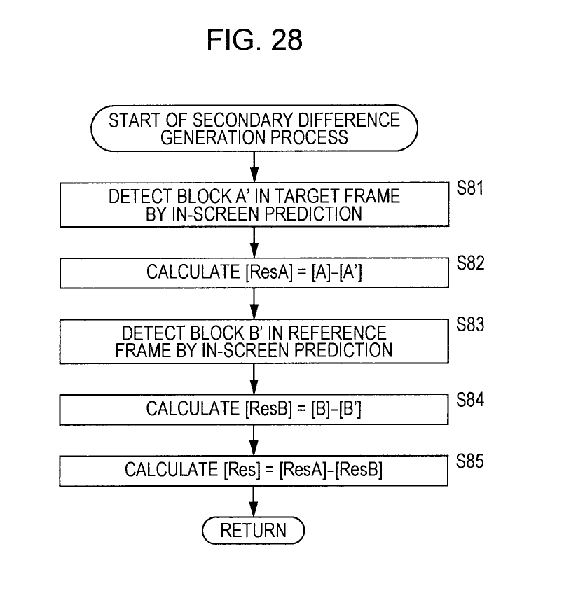

In step S63, the in-screen prediction unit 76 and the secondary difference generation unit 77 performs the secondary difference generation process. The secondary difference generation process will be described below with reference to FIG. 28.

The secondary difference information which is a difference between the difference information of the target frame and the difference information of the reference frame is generated through the process of step S63 and is output to the motion prediction/compensation unit 75. The secondary difference information is used even when the cost function value is calculated in step S65. The difference obtained by subtracting the secondary difference information from the image to be subjected to the inter-processing is selected as the prediction image of the optimum prediction mode by the prediction image selection unit 78, when the cost function value is small.

In step S64, the motion prediction/compensation unit 75 generates the motion vector information, which is added to the compressed image, for the motion vector determined in each of the eight types of inter-prediction modes of 16×16 pixels to 4×4 pixels. At this time, the motion vector information is generated using the method of generating the motion vector described with reference to FIG. 8.

The generated motion vector information is used even when the cost function value is also calculated in subsequent step S65. Finally, when the corresponding prediction image is selected by the prediction image selection unit 78, the motion vector information is output to the lossless encoding unit 66 together with the prediction mode information and the reference frame information.

When the motion prediction/compensation unit 75 performs the motion prediction by inter-the template matching, it is not necessary to transmit the motion vector information to the decoding side. Therefore, the process of step S64 is skipped.

In step S65, the motion prediction/compensation unit 75 calculates the cost function value expressed by Expression (74) or Expression (75) described above in each of the eight inter-prediction modes of 16×16 pixels to 4×4 pixels. The calculated cost function value is used when the optimum inter-prediction mode is used in step S33 described above with reference to FIG. 13.

### [Description of Secondary Difference Generation Process]

Next, the secondary difference generation process of step S63 in FIG. 27 will be described with reference to the flowchart of FIG. 28.

The information regarding the target block A is input from the motion prediction/compensation unit 75 to the target frame in-screen prediction unit 81. The target frame in-screen prediction unit 81 reads the reference image of the target frame from the frame memory 72 with reference to the information regarding the target block A. Then, in step S81, the target frame in-screen prediction unit 81 detects the block A′ corresponding to the target block A by performing the in-screen prediction in the target frame.

The pixel value [A] of the target block A and the pixel value [A′] of the block A′ are input from the target frame in-screen prediction unit 81 to the target frame in-screen difference generation unit 82. In step S82, the target frame in-screen difference generation unit 82 calculates difference information [ResA]=[A]−[A′] of the target frame. That is, the target frame in-screen difference generation unit 82 calculates the difference information [ResA] of the target frame, which is a difference between the pixel value [A] of the target block A and the pixel value [A′] of the block A′.

The information regarding the reference block B is input from the motion prediction/compensation unit 75 to the reference frame in-screen prediction unit 83. The reference frame in-screen prediction unit 83 reads the reference image of the reference frame from the frame memory 72 with reference to the information regarding the reference block B. Then, in step S83, the reference frame in-screen prediction unit 83 detects the block B′ corresponding to the reference block B by performing the in-screen prediction in the reference frame.

The pixel value [B] of the reference block B and the pixel value [B′] of the block B′ are input from the reference frame in-screen prediction unit 83 to the reference frame in-screen difference generation unit 84. In step S84, the reference frame in-screen difference generation unit 84 calculates difference information [ResB]=[B]−[B′] of the reference frame. That is, the reference frame in-screen difference generation unit 84 generates the difference information [ResB] of the reference frame which is a difference between the pixel value [B] of the reference block B and the pixel [B′] of the block B′.

The target frame difference reception unit 91 receives the difference information [ResA] of the target frame from the target frame in-screen difference generation unit 82 and supplies the difference information [ResA] of the target frame to the secondary difference calculation unit 93. The reference frame difference reception unit 92 receives the difference information [ResB] of the reference frame from reference frame in-screen difference generation unit 84 and supplies the difference information [ResB] to the secondary difference calculation unit 93.

In step S85, the secondary difference calculation unit 93 calculates secondary difference information [Res] between the difference information [ResA] of the target frame and the difference information [ResB] of the reference frame. The secondary difference calculation unit 93 outputs the calculated second difference information [Res] to the motion prediction/compensation unit 75.

The encoded compressed image is transmitted via a predetermined transmission line and is decoded by the image decoding apparatus.

### Example of Configuration of Image Decoding Apparatus

FIG. 29 is a diagram illustrating the configuration of the image decoding apparatus serving as an image processing apparatus according to an embodiment of the invention.

The image decoding apparatus 101 includes an accumulation buffer 111, a lossless decoding unit 112, an inverse quantization unit 113, an inverse orthogonal transform unit 114, a calculation unit 115, a de-block filter 116, a screen rearrangement buffer 117, a D/A conversion unit 118, a frame memory 119, a switch 120, an intra-prediction unit 121, a motion prediction/compensation unit 122, an in-screen prediction unit 123, a secondary difference compensation unit 124, and a switch 125.

The accumulation buffer 111 accumulates the transmitted compressed images. The lossless decoding unit 112 decodes the information supplied from the accumulation buffer 111 and encoded by the lossless encoding unit 66 in FIG. 4 in accordance with a method corresponding to the encoding method of the lossless encoding unit 66. The inverse quantization unit 113 performs inverse quantization on the image decoded by the lossless decoding unit 112 in accordance with a method corresponding to the quantization method of the quantization unit 65 in FIG. 4. The inverse orthogonal transform unit 114 performs inverse orthogonal transform on the output of the inverse quantization unit 113 in accordance with a method corresponding to the orthogonal transform method of the orthogonal transform unit 64 in FIG. 4.

The output subjected to the inverse orthogonal transform is added to the prediction image supplied from the switch 125 by the calculation unit 115 and is decoded. The de-block filter 116 eliminates the block distortion of the decoded image, supplies the image to the frame memory 119 to store the image, and outputs the image to the screen rearrangement buffer 117.

The screen rearrangement buffer 117 rearranges the images. That is, the order of the frames rearranged in the encoding order by the rearrangement buffer 62 in FIG. 4 is changed to the original display order. The D/A conversion unit 118 performs D/A conversion on the image supplied from the screen rearrangement buffer 117 and outputs the image to a display (not shown) to display the image.

The switch 120 reads the image to be subjected to the inter-processing and the image to be referred from the frame memory 119 and outputs the images to the motion prediction/compensation unit 122. Further, the switch 120 reads the image used for the intra-prediction from the frame memory 119 and supplies the read image to the intra-prediction unit 121.

The information, which is obtainable by decoding the header information, regarding the intra-prediction mode is supplied from the lossless decoding unit 112 to the intra-prediction unit 121. The intra-prediction unit 121 generates the prediction image based on this information and outputs the generated prediction image to the switch 125.

The information (prediction mode information, motion vector information, and reference frame information) which is obtainable by decoding the header information is supplied from the lossless decoding unit 112 to the motion prediction/compensation unit 122. When the information indicating the inter-prediction mode is supplied, the motion prediction/compensation unit 122 calculates the reference block, which can correspond to the target block of the image to be subjected to the inter-processing, in the reference image based on the inter-motion vector information from the lossless decoding unit 112. The motion prediction/compensation unit 122 outputs the information regarding the target block and the information regarding the reference block corresponding to the information regarding the target block to the in-screen prediction unit 123.

When the motion prediction/compensation unit 75 in FIG. 4 performs the motion prediction/compensation process in accordance with the inter-template matching method described above with reference to FIG. 3, the motion prediction/compensation unit 122 also performs the motion prediction/compensation process in accordance with the inter-template matching method. In this case, since the inter-motion vector information is not encoded in the image encoding apparatus 51, no inter-motion vector information is supplied from the lossless decoding unit 112.

The in-screen prediction unit 123 reads the reference images of the target frame and the reference frame from the frame memory 119. The in-screen prediction unit 123 performs the in-screen prediction on the target frame to detect a block corresponding to the target block and performs the in-screen prediction on the reference frame to detect a block corresponding to the reference block. In the in-screen prediction unit 123, as the in-screen prediction, a method corresponding to the in-screen prediction unit 76 in FIG. 4 is used between the intra-template matching method described with reference to FIG. 1 and the intra-motion prediction method described with reference to FIG. 2.

When the intra-motion prediction method is used as the in-screen prediction, the intra-motion vector is encoded by the image encoding apparatus 51 and is transmitted. The intra-motion vector is supplied from the lossless decoding unit 112 to the in-screen prediction unit 123 via the motion prediction/compensation unit 122.

The in-screen prediction unit 123 also calculates difference information (difference information of the reference frame) between the pixel value of the reference block and the pixel value of the corresponding block. The information regarding the block corresponding to the detected target block and the calculated difference information of the reference frame are output to the secondary difference compensation unit 124.

The secondary difference information subjected to the decoding process, the inverse quantization, and the inverse orthogonal transform is supplied from the inverse orthogonal transform unit 114 to the secondary difference compensation unit 124. The secondary difference compensation unit 124 compensates the image of the target block using the secondary difference information from the inverse orthogonal transform unit 114, the information regarding the block corresponding to the target block from the in-screen prediction unit 123, and the difference information of the reference frame. The secondary difference compensation unit 124 supplies the compensated image of the target block to the de-block filter 116.

The switch 125 selects the prediction image generated by the motion prediction/compensation unit 122 or the intra-prediction unit 121 and supplies the selected prediction image to the calculation unit 115. In effect, since no prediction image is input from the motion prediction/compensation unit 122, the switch 125 selects the prediction image generated by the intra-prediction unit 121 and supplies the selected prediction image to the calculation unit 115 in the example of FIG. 29.

### Examples of Configurations of In-Screen Prediction Unit and Secondary Difference Compensation Unit

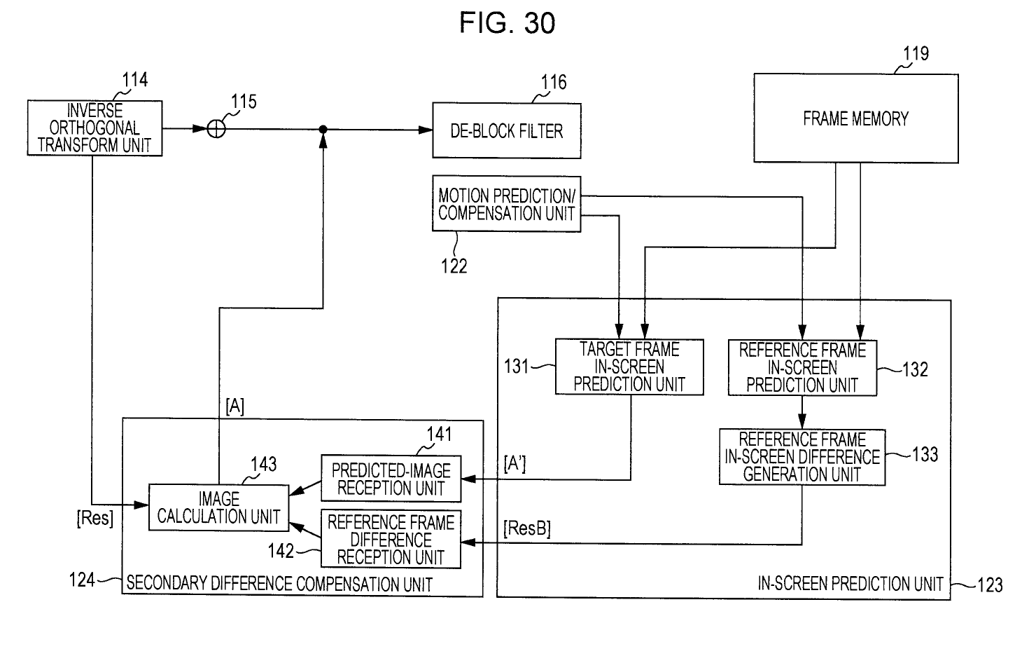

FIG. 30 is a block diagram illustrating examples of the detailed configurations of the in-screen prediction unit and the secondary difference compensation unit.

In the example of FIG. 30, the in-screen prediction unit 123 includes a target frame in-screen prediction unit 131, a reference frame in-screen prediction unit 132, and a reference frame in-screen difference generation unit 133.

The secondary difference compensation unit 124 includes a prediction image reception unit 141, a reference frame difference reception unit 142, and an image calculation unit 143.

The motion prediction/compensation unit 122 calculates the reference block B, which can correspond to the target block A of the image to be subjected to the inter-processing, in the reference image based on the motion vector information from the lossless decoding unit 112. The motion prediction/compensation unit 122 outputs the information regarding the target block A to the target frame in-screen prediction unit 131 and outputs the information regarding the reference block B to the reference frame in-screen prediction unit 132.

The target frame in-screen prediction unit 131 reads the reference image of the target frame from the frame memory 119 with reference to the information regarding the target block A. The target frame in-screen prediction unit 131 detects the block A′ corresponding to the target block A by performing the in-screen prediction on the target frame and outputs the information (the pixel value [A′]) regarding the block A′ corresponding to the target block A to the prediction image reception unit 141.

The reference frame in-screen prediction unit 132 reads the reference image of the reference frame from the frame memory 119 with reference to the information regarding the reference block B. The reference frame in-screen prediction unit 132 detects the block B′ corresponding to the reference block B by performing the in-screen prediction on the reference frame and outputs the information regarding the reference block B and the block B′ to the reference frame in-screen difference generation unit 133.

The reference frame in-screen difference generation unit 133 generates the difference information between the pixel value of the reference block B and the pixel value of the block B′ in the reference frame and the outputs the difference information as the difference information [ResB] of the reference frame to the reference frame difference reception unit 142.

The prediction image reception unit 141 receives the pixel value [A′] of the block A′ corresponding to the target block A from the target frame in-screen prediction unit 131 and supplies the pixel value [A′] to the image calculation unit 143. The reference frame difference reception unit 142 receives the difference information [ResB] of the reference frame from the reference frame in-screen difference generation unit 133 and supplies the difference information [ResB] to the image calculation unit 143.

The secondary difference information [Res] subjected to the decoding process, the inverse quantization, and the inverse orthogonal transform is supplied from the inverse orthogonal transform unit 114 to the image calculation unit 143. The image calculation unit 143 compensates and calculates the image of the target block using the secondary difference information [Res], the information [A′] of the block A′ corresponding to the target block, and the difference information [ResB] of the reference frame. The image calculation unit 143 supplies the calculated image of the target block to the de-block filter 116.

### [Description of Decoding Process of Image Decoding Apparatus]

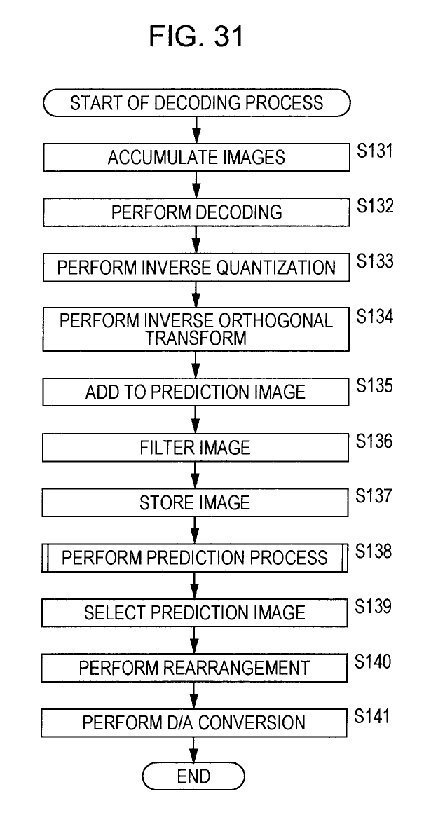

Next, the decoding process performed by the image decoding apparatus 101 will be described with reference to the flowchart of FIG. 31.

In step S131, the accumulation buffer 111 accumulates the transmitted images. Ins step S132, the lossless decoding unit 112 decodes the compressed image supplied form the accumulation buffer 111. That is, the lossless decoding unit 112 decodes the I picture, the P picture, and the B picture encoded by the lossless encoding unit 66 in FIG. 4.

At this time, the lossless decoding unit 112 also decodes the motion vector information, the reference frame information, the prediction mode information (the intra-prediction mode and the inter-prediction mode), and the flag information.

That is, when the prediction mode information is the intra-prediction mode, the prediction mode information is supplied to the intra-prediction unit 121. When the prediction mode information is the inter-prediction mode, the motion vector information corresponding to the prediction mode information is supplied to the motion prediction/compensation unit 122.

In step S133, the inverse quantization unit 113 performs the inverse quantization on the transform coefficient decoded by the lossless decoding unit 112 in accordance with the characteristic corresponding to the characteristic of the quantization unit 65 in FIG. 4. In step S134, the inverse orthogonal transform unit 114 performs the inverse orthogonal transform on the transform coefficient subjected to the inverse quantization unit 113 by the inverse quantization unit 113 in accordance with the characteristic corresponding to the characteristic of the orthogonal transform unit 64 in FIG. 4. In this way, the difference information (the secondary difference information in the case of the inter-processing) corresponding to the input (the output of the calculation unit 63) of the orthogonal transform unit 64 in FIG. 4 is decoded. Further, in the case of the inter-processing, since the secondary difference information is directly output to the secondary difference compensation unit 124, the subsequent process of step S135 is skipped.

In step S135, the calculation unit 115 adds the prediction image selected in the process of step S141 described below and input via the switch 125 to the difference information. In this way, the original image is decoded.

In step S136, the de-block filter 116 filters the image output from the calculation unit 115 or the image, which is decoded in the process of step S138 described below, from the secondary difference compensation unit 124. Thus, the block distortion is eliminated. In step S137, the frame memory 119 stores the filtered image.

In step S138, the intra-prediction unit 121 or the motion prediction/compensation unit 122 performs the prediction process on each image in correspondence with the prediction mode information supplied from the lossless decoding unit 112.

That is, when the intra-prediction mode information is supplied from the lossless decoding unit 112, the intra-prediction unit 121 performs the intra-prediction process in the intra-prediction mode. When the inter-prediction mode information is supplied from the lossless decoding unit 112, the motion prediction/compensation unit 122 performs the motion prediction process in the inter-prediction mode, and the in-screen prediction unit 123 and the secondary difference compensation unit 124 perform the secondary difference compensation process.

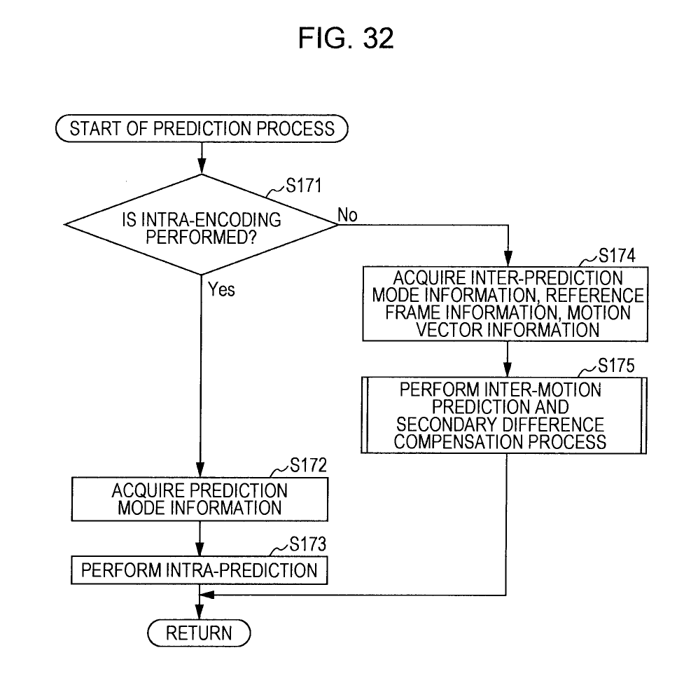

As the detailed prediction process of step S138 is described with reference to FIG. 32, the prediction image generated by the intra-prediction unit 121 is supplied to the switch 125 through this prediction process. The image of the target block generated by the motion prediction/compensation unit 122, the in-screen prediction unit 123, and the secondary difference compensation unit 124 is directly output to the de-block filter 116 without transmission to the switch 125 and the calculation unit 115. Accordingly, the subsequent process of step S139 is skipped.

In step S139, the switch 125 selects the prediction image. That is, the prediction image generated by the intra-prediction unit 121 is supplied to the switch 125. Accordingly, the supplied prediction image is selected and supplied to the calculation unit 115, and then is added to the output of the inverse orthogonal transform unit 114 in step S134, as described above.

In step S140, the screen rearrangement buffer 117 performs the rearrangement. That is, the order of the frames rearranged for the encoding process by the rearrangement buffer 62 of the image encoding apparatus 51 is changed to the original display order.

In step S141, the D/A conversion unit 118 performs D/A conversion on the image from the screen rearrangement buffer 117. This image is output to the display (not shown) and is displayed.

### [Description of Prediction Process]

Next, the prediction process of step S138 will be described with reference to the flowchart of FIG. 32.

In step S171, the intra-prediction unit 121 determines whether the target block is subjected to the intra-encoding. When the intra-prediction mode information is supplied from the lossless encoding unit 112 to the intra-prediction unit 121, the intra-prediction unit 121 determines that the target block is subjected to the intra-encoding in step S171. Then, the process proceeds to step S172.

The intra-prediction unit 121 acquires the intra-prediction mode information in step S172 and performs the intra-prediction in step S173.

That is, when the image to be processed is the image to be subjected to the intra-processing, the necessary image is read from the frame memory 119 and is supplied to the intra-prediction unit 121 via the switch 120. In step S173, the intra-prediction unit 121 performs the intra-prediction to generate the prediction image based on the intra-prediction mode information acquired in step S172. The generated prediction image is output to the switch 125.

On the other hand, when the intra-prediction unit 121 determines that the target block is not subjected to the intra-encoding in step S171, the process proceeds to step S174.

In step S174, the motion prediction/compensation unit 122 acquires the prediction mode information and the like from the lossless decoding unit 112.

When the image to be processed is the image to be the inter-processing, the inter-prediction mode information, the reference frame information, and the motion vector information are supplied from the lossless decoding unit 112 to the motion prediction/compensation unit 122. In this case, in step S174, the motion prediction/compensation unit 122 acquires the inter-prediction mode information, the reference frame information, and the motion vector information.

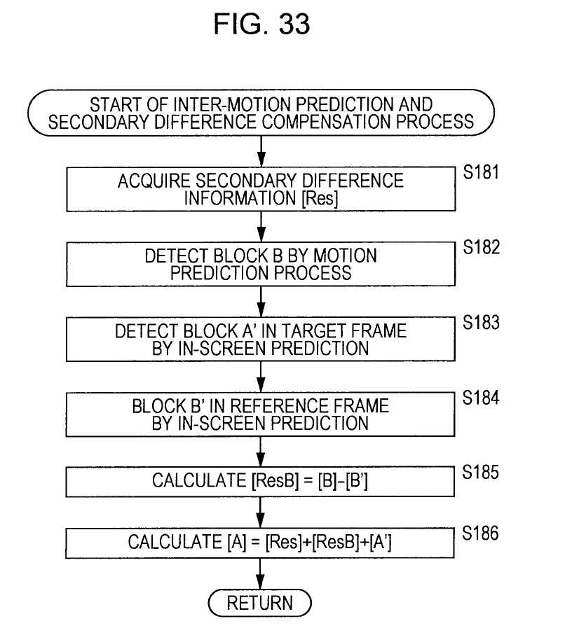

In step S175, the motion prediction/compensation unit 122, the in-screen prediction unit 123, and the secondary difference compensation unit 124 perform inter-motion prediction and secondary difference compensation processes. The inter-motion prediction and secondary difference compensation processes will be described below with reference to FIG. 33.

The image of the target block is compensated and generated through the process of step S175 and is directly output to the de-block filter 116 without transmission to the switch 125 and the calculation unit 115. The output image of the target block is filtered by the de-block filter 116 in step S136 of FIG. 31 and is stored in the frame memory 119 in step S137.

### [Description of Inter-Motion Prediction and Secondary Difference Compensation Processes]

Next, the inter-motion prediction and secondary difference compensation processes will be described with reference to the flowchart of FIG. 33.

The secondary difference information [Res] subjected to the decoding process, the inverse quantization, and the inverse orthogonal transform is supplied from the inverse orthogonal transform unit 114 to the image calculation unit 143. In step S181, the image calculation unit 143 acquires the secondary difference information [Res] from the inverse orthogonal transform unit 114.

In step S182, the motion prediction/compensation unit 122 calculates the reference block B, which can correspond to the target block A of the image to be subjected to the inter-processing, in the reference image based on the inter-motion vector information acquired in step S174 of FIG. 32. The motion prediction/compensation unit 122 outputs the information regarding the target block A and the information regarding the reference block B to the target frame in-screen prediction unit 131 and the reference frame in-screen prediction unit 132, respectively.

In step S183, the target frame in-screen prediction unit 131 performs the in-screen prediction on the target frame to detect the block A′ corresponding to the target block A and outputs the pixel value [A′] of the block A′ corresponding to the target block A to the prediction image reception unit 141.

In step S184, the reference frame in-screen prediction unit 132 performs the in-screen prediction on the reference frame to detect the block B′ corresponding to the reference block B and outputs the reference block B and the pixel value [B′] of the block B′ to the reference frame in-screen difference generation unit 133.

In step S185, the reference frame in-screen difference generation unit 133 calculates the difference information [ResB] between the pixel value [B] of the reference block B and the pixel value [B′] of the block B′ in the reference frame and outputs this difference information as the difference information [ResB] of the reference frame to the reference frame difference reception unit 142.

In step S186, the image calculation unit 143 compensates and calculates the image [A] of the target block using the secondary difference information [Res] acquired in step S181, the pixel value [A′] of the block A′ corresponding to the target block, and the difference information [ResB] of the reference frame. The image calculation unit 143 supplies the calculated image [A] of the target block to the de-block filter 116.

In this way, in the image encoding apparatus 51 and the image decoding apparatus 101, each first difference information is generated through the in-screen prediction in the target frame and the reference frame which can correspond to each other, and the secondary difference information between the frames is generated and encoded. Thus, it is possible to further improve the encoding efficiency.

### Another Example of Configuration of Image Encoding Apparatus

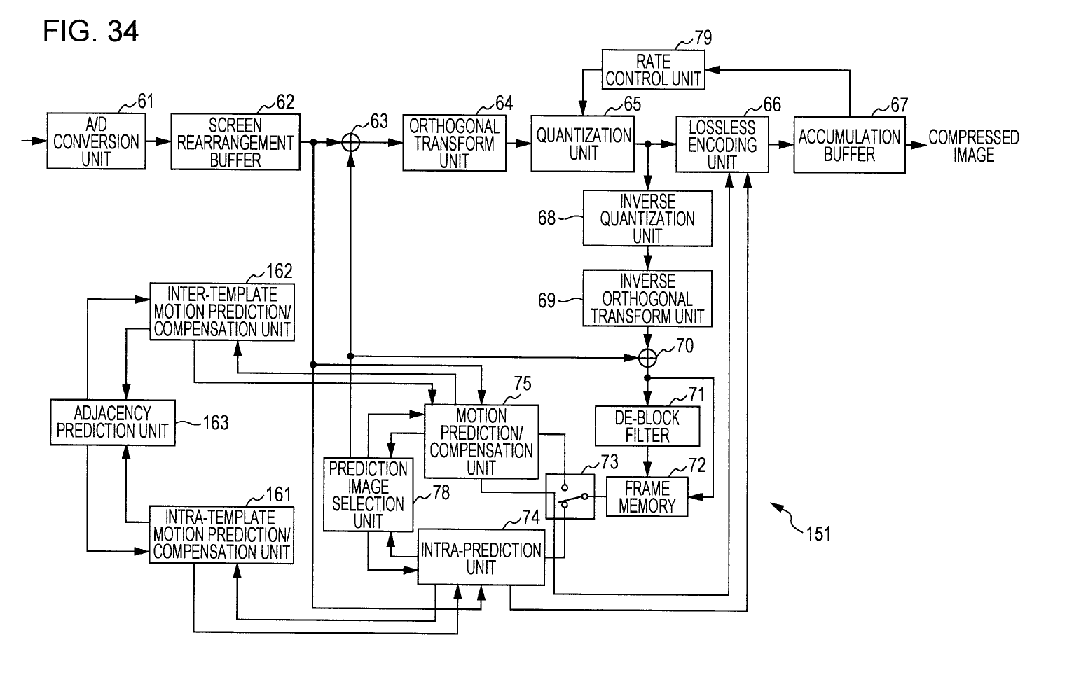

FIG. 34 is a diagram illustrating the configuration of an image encoding apparatus according to another embodiment of the invention.

An image encoding apparatus 151 has the same configuration as that of the image encoding apparatus 51 in FIG. 4 in that the image encoding apparatus 151 includes the A/D conversion unit 61, the screen rearrangement buffer 62, the calculation unit 63, the orthogonal transform unit 64, the quantization unit 65, the lossless encoding unit 66, the accumulation buffer 67, the inverse quantization unit 68, the inverse orthogonal transform unit 69, the calculation unit 70, the de-block filter 71, the frame memory 72, the switch 73, the intra-prediction unit 74, the motion prediction/compensation unit 75, the prediction image selection unit 78, and the rate control unit 79.

The image encoding apparatus 151 is different from the image encoding apparatus 51 in FIG. 4 in that the image encoding apparatus 151 includes no in-screen prediction unit 76 and no secondary difference generation unit 77 and includes an intra-template motion prediction/compensation unit 161, an inter-template motion prediction/compensation unit 162, and an adjacency prediction unit 163.

Hereinafter, the intra-template motion prediction/compensation unit 161 and the inter-template motion prediction/compensation unit 162 are referred to as the intra-TP motion prediction/compensation unit 161 and the inter-TP motion prediction/compensation unit 162.

In the example of FIG. 34, the intra-prediction unit 74 performs the intra-prediction process of all the candidate intra-prediction modes based on the image, which is read from the screen rearrangement buffer 62, to be subjected to the intra-prediction and the reference image supplied from the frame memory 72 in order to generate the prediction images. Further, the intra-prediction unit 74 supplies the image, which is read from the screen rearrangement buffer 62, to be subjected to the intra-prediction and the reference image supplied from the frame memory 72 via the switch 73 to the intra-TP motion prediction/compensation unit 161.

The intra-prediction unit 74 calculates the cost function values of all the candidate intra-prediction modes. The intra-prediction unit 74 determines, as an optimum intra-prediction mode, the prediction mode with the minimum value among the calculated cost function values and the cost function values of the intra-template prediction mode calculated by the intra-TP motion prediction/compensation unit 161.

The intra-prediction unit 74 supplies the prediction image generated in the optimum intra-prediction mode and the cost function value thereof to the prediction image selection unit 78. When the prediction image selection unit 78 selects the prediction image generated in the optimum intra-prediction mode, the intra-prediction unit 74 supplies the lossless encoding unit 66 with the information (the intra-prediction mode information or the intra-template prediction mode information) indicating the optimum intra-prediction mode.

The image, which is read from the screen rearrangement buffer 62, to be subjected to the intra-prediction and the necessary reference image supplied from the frame memory 72 are input to the intra-TP motion prediction/compensation unit 161. The intra-TP motion prediction/compensation unit 161 calculates the reference block, which can correspond to the target block of the image to be subjected to the intra-processing, by performing the motion prediction in accordance with the intra-template matching method described above with reference to FIG. 1 using these images.

The intra-TP motion prediction/compensation unit 161 outputs information (that is, information regarding the adjacent pixels of the target block and the reference block) regarding the necessary reference image and information regarding the reference block corresponding to the necessary reference image to the adjacency prediction unit 163. Hereinafter, the motion prediction performed in accordance with the intra-template matching method is also referred to as motion prediction of the intra-template prediction mode.

The intra-TP motion prediction/compensation unit 161 calculates the cost function value for the intra-template prediction mode using the secondary difference information from the adjacency prediction unit 163. The intra-TP motion prediction/compensation unit 161 supplies the calculated cost function value and a difference between the image to be subjected to the intra-processing as the prediction image and the secondary difference information to the intra-prediction unit 74.

That is, when the intra-template prediction mode is determined as the optimum mode by the intra-prediction unit 74, the cost function value of the intra-template prediction mode and the difference between the image to be subjected to the intra-processing as the prediction image and the secondary difference information are output to the prediction image selection unit 78.

The motion prediction/compensation unit 75 performs the motion prediction/compensation process in all the candidate inter-prediction modes. That is, the motion prediction/compensation unit 75 is supplied with the image, which is read from the screen rearrangement buffer 62, to be subjected to the inter-processing and the reference image from the frame memory 72 via the switch 73. The motion prediction/compensation unit 75 detects the motion vectors of all the candidate inter-prediction modes based on the image to be subjected to the inter-processing and the reference image and performs the compensation process on the reference image based on the motion vectors to generate the prediction image. Further, the motion prediction/compensation unit 75 supplies the inter-TP motion prediction/compensation unit 162 with the image, which is read from the screen rearrangement buffer 62, to be subjected to the inter-processing and the reference image from the frame memory 72 via the switch 73.

The motion prediction/compensation unit 75 calculates the cost function values of all the candidate inter-prediction modes. The motion prediction/compensation unit 75 determines, as an optimum inter-prediction mode, the prediction mode with the minimum value among the cost function values of the inter-prediction modes and the cost function values of the inter-template prediction modes from the inter-TP motion prediction/compensation unit 162.

The motion prediction/compensation unit 75 supplies the prediction image selection unit 78 with the prediction image generated in the optimum inter-prediction mode and the cost function value thereof. When the prediction image selection unit 78 selects the prediction image generated in the optimum inter-prediction mode, the motion prediction/compensation unit 75 supplies the lossless encoding unit 66 with the information (the inter-prediction mode information or the inter-template prediction mode information) indicating the optimum intra-prediction mode. If necessary, the motion vector information, the flag information, the reference frame information, and the like are supplied to the lossless encoding unit 66.

The image, which is read from the screen rearrangement buffer 62, to be subjected to the inter-prediction and the necessary reference image supplied from the frame memory 72 are input to the inter-TP motion prediction/compensation unit 162. The inter-TP motion prediction/compensation unit 162 calculates the reference block, which can correspond to the target block of the image to be subjected to the inter-processing, by performing the motion prediction in accordance with the inter-template matching method described above with reference to FIG. 3 using these images.

The inter-TP motion prediction/compensation unit 162 outputs information (that is, information regarding the adjacent pixels of the target block and the reference block) regarding the necessary reference image and information regarding the reference block corresponding to the necessary reference image to the adjacency prediction unit 163. Hereinafter, the motion prediction performed in accordance with the inter-template matching method is also referred to as motion prediction of the inter-template prediction mode.

The inter-TP motion prediction/compensation unit 162 calculates the cost function value for the inter-template prediction mode using the secondary difference information from the adjacency prediction unit 163. The inter-TP motion prediction/compensation unit 162 supplies the calculated cost function value and a difference between the image to be subjected to the inter-processing as the prediction image and the secondary difference information to the motion prediction/compensation unit 75.

That is, when the inter-template prediction mode is determined as the optimum mode by the motion prediction/compensation unit 75, the cost function value of the inter-template prediction mode and the difference between the image to be subjected to the inter-processing as the prediction image and the secondary difference information are output to the prediction image selection unit 78.

The adjacency prediction unit 163 performs the processes corresponding to the in-screen prediction unit 76 and the secondary difference generation unit 77. That is, the adjacency prediction unit 163 performs the intra-prediction on the target block and the reference block as the in-screen prediction based on the information regarding the necessary reference image. The adjacency prediction unit 163 generates an intra-prediction image (hereinafter, referred to as a target intra-prediction image) of the target block and an intra-prediction image (hereinafter, referred to as a reference intra-prediction image) of the reference block by each intra-prediction. Further, the adjacency prediction unit 163 generates difference information of the target image, which is a difference between the target block and the target intra-prediction image, and generates difference information, which is a difference between the reference block and the reference intra-prediction image.

The adjacency prediction unit 163 calculates secondary difference information which is a difference between the difference information of the target image and the difference information of the reference image. The calculated secondary difference information is output to the corresponding intra-TP motion prediction/compensation unit 161 or the corresponding inter-TP motion prediction/compensation unit 162.

The prediction image selection unit 78 selects the prediction image of the determined optimum prediction mode or a difference between the image to be subjected to the intra-processing or the inter-processing and the secondary difference information and supplies the result to the calculation units 63 and 70.

That is, when the intra-template prediction mode is determined as the optimum mode by the prediction image selection unit 78, the difference between the image to be subjected to the intra-processing as the prediction image and the secondary difference information is output to the calculation units 63 and 70. When the inter-template prediction mode is determined as the optimum mode by the prediction image selection unit 78, the difference between the image to be subjected to the inter-processing as the prediction image and the secondary difference information is output to the calculation units 63 and 70.

### Example of Configuration of Adjacency Prediction Unit

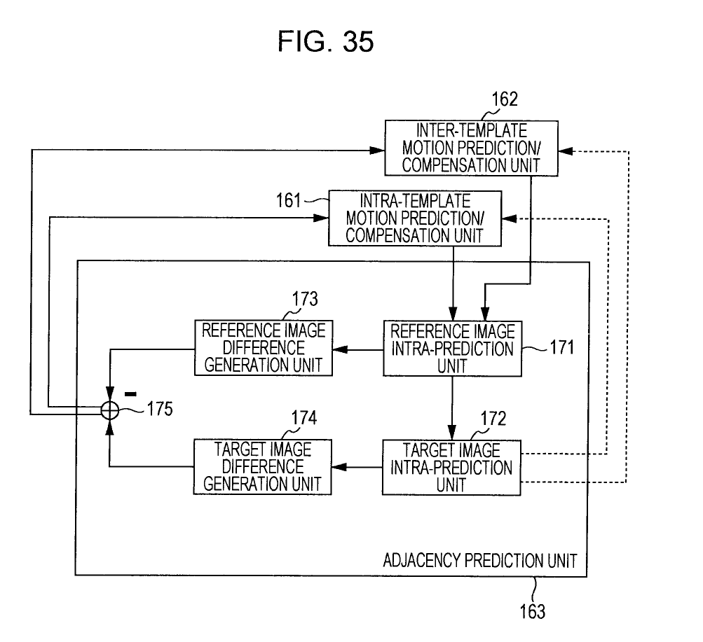

FIG. 35 is a block diagram illustrating an example of the detailed configuration of the adjacency prediction unit 163.

In the example of FIG. 35, the adjacency prediction unit 163 includes a reference image intra-prediction unit 171, a target image intra-prediction unit 172, a reference image difference generation unit 173, a target image difference generation unit 174, and a calculation unit 175.

The information (that is, information regarding the adjacent pixels of the target block and the reference block) regarding the necessary reference image, the information regarding the target block, and the information regarding the reference block corresponding to the target block are input from the intra-TP motion prediction/compensation unit 161 or the inter-TP motion prediction/compensation unit 162 to the reference image intra-prediction unit 171.

The reference image intra-prediction unit 171 performs the intra-prediction on the reference block in the corresponding reference frame or target frame to generate the reference intra-prediction image. At this time, the reference image intra-prediction unit 171 generates the reference intra-prediction images of all the intra-prediction modes defined in the H.264/AVC scheme and determines the intra-prediction mode with the minimum prediction error with the pixel value of the reference block.

The reference image intra-prediction unit 171 outputs the information (for example, information regarding the adjacent pixels of the target block) regarding the necessary reference image, the information regarding the target block, and the information regarding the determined intra-prediction mode to the target image intra-prediction unit 172. Further, the reference image intra-prediction unit 171 outputs the information regarding the reference block and the information regarding the reference intra-prediction image generated in the determined intra-prediction mode to the reference image difference generation unit 173.

The target image intra-prediction unit 172 generates the target intra-prediction image by performing the intra-prediction on the target block. At this time, the target image intra-prediction unit 172 generates the target intra-prediction image in the intra-prediction mode determined by the reference image intra-prediction unit 171. The target image intra-prediction unit 172 outputs the information regarding the target block and the information regarding the generated target intra prediction image to the target image difference generation unit 174.

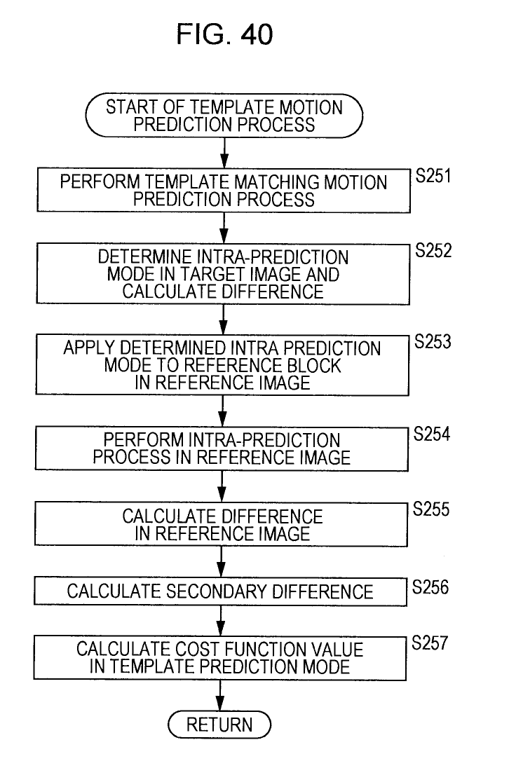

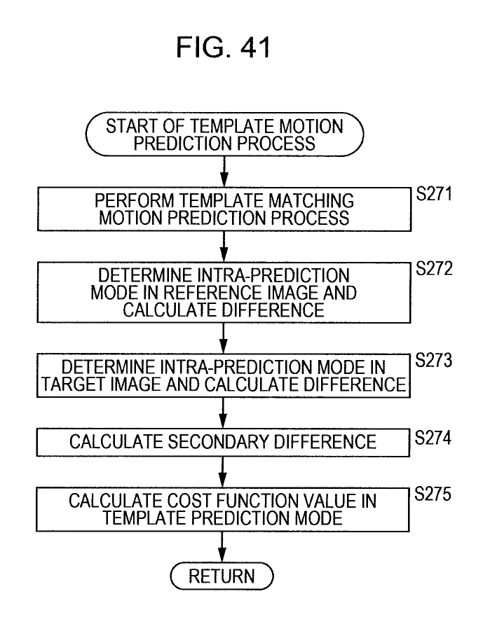

The target image intra-prediction unit 172 outputs the information regarding the intra-prediction mode to the corresponding intra-TP motion prediction/compensation unit 161 or the corresponding inter-TP motion prediction/compensation unit 162, if necessary. That is, information regarding the prediction mode is output in a case described below with reference to FIGS. 40 and 41. The information regarding the prediction mode is transmitted as information regarding the intra-prediction mode associated with the secondary difference information to the lossless encoding unit 66, when the prediction image of the intra-template prediction mode or the inter-template prediction mode is selected by the prediction image selection unit 76.

The reference image difference generation unit 173 generates difference information of the reference image, which is a difference between the pixel value of the reference block and the pixel value of the reference intra-prediction image and outputs the generated difference information to the calculation unit 175.

The target image difference generation unit 174 generates difference information of the target image, which is a difference between the pixel value of the target block and the pixel value of the target intra-prediction image and outputs the generated difference information of the target image to the calculation unit 175.

The calculation unit 175 performs division calculation on the difference information of the target image and the difference information of the reference image to calculate secondary difference information and outputs the calculated secondary difference information to the corresponding intra-TP motion prediction/compensation unit 161 or the corresponding inter-TP motion prediction/compensation unit 162.

### Examples of Operations of Inter-TP Motion Prediction/Compensation Unit and Adjacency Prediction Unit

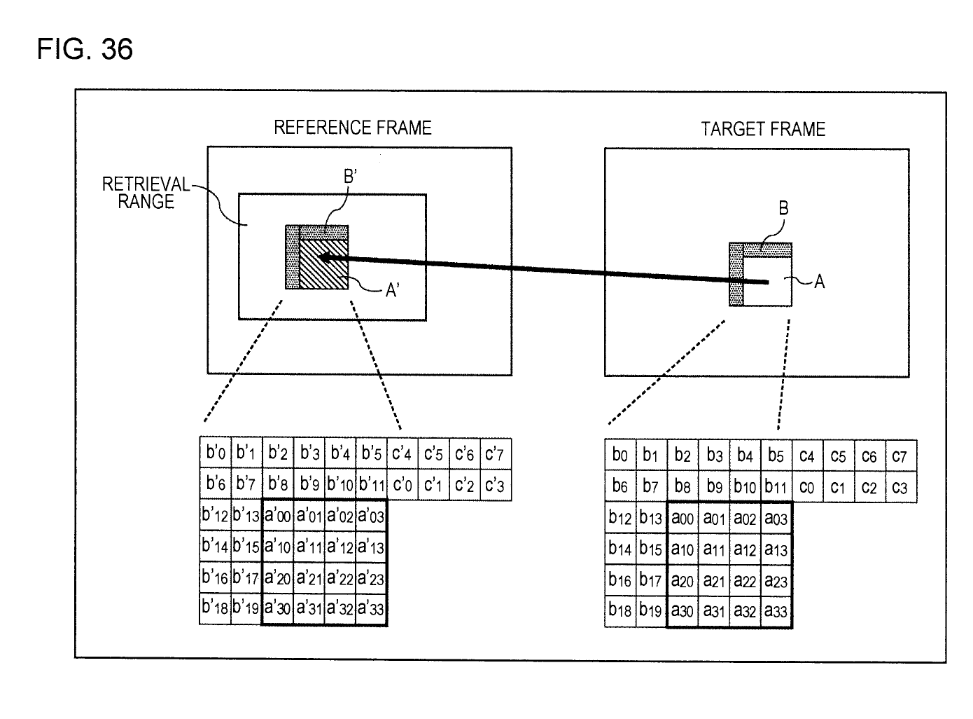

Next, the operations of the inter-TP motion prediction/compensation unit and the adjacency prediction unit of the image encoding apparatus 151 will be described with reference to FIG. 36. In the example of FIG. 36, the operations will be described in the case of the inter-processing. In this case, the processes in the intra-TP motion prediction/compensation unit 161 and the inter-TP motion prediction/compensation unit 162 are the same except that the reference block exists in the screen (target frame) or between the screens (reference frame). Accordingly, the case of the intra-processing will not be described.

In the example of FIG. 36, the target block A and the template region B adjacent to the target block A are shown in the target frame and the reference block A′ and the template region B′ adjacent to the reference block A′ are shown in the reference frame. Further, in the example of FIG. 36, a block size of 4×4 pixels is shown as an example.

The target block A includes pixel values a₀₀ to a₃₃ and the template region B includes pixel values b₀ to b₁₉. Further, the reference block A′ includes pixel values a′₀₀ to a′₃₃ and the template region B includes pixel values b′₀ to b′₁₉.

First, the inter-TP motion prediction/compensation unit 162 performs the motion prediction in accordance with the inter-template matching method. That is, when the template region B′ with the highest correlation with the template region B is searched within the search range of the reference frame, the reference block A′ and the template region B′ corresponding to the target block A and the template region B are determined. In the related art, a difference between the pixel value of the reference block A′ and the pixel value of the target block A as the prediction image of the target block A is encoded.

At this time, the template matching process of integer pixel precision is performed. In the template matching process, pixels values c₀ to c₇ and the pixel values c′₀ to c′₇ of the pixels adjacent to the template regions B and B′ on the right side may be used.

Next, the reference image intra-prediction unit 171 performs the intra-prediction between the pixel values b′₇, b′₈, b′₉, b′₁₀, b′₁₁, b′₁₃, b′₁₅, b′₁₇, and b′₁₉ of the pixels adjacent to the reference block in the template region B′ and pixel values a′₀₀ to a′₃₃ of the reference block in the reference frame. The pixel values c′₀ to c′₃ may be used even in the intra-prediction.

That is, the reference image intra-prediction unit 171 generates the prediction images in the nine types of 4×4 intra-prediction modes defined in the H.264/AVC scheme by the use of the pixel values b′₇, b′₈, b′₉, b′₁₀, b′₁₁, b′₁₃, b′₁₅, b′₁₇, and b′₁₉ and the pixel values c′₀ to a′₃. Then, the reference image intra-prediction unit 171 determines the prediction mode with the minimum prediction error, which is calculated by SAD (Sum of Absolute Difference) or the like, with the pixel values a′₀₀ to a′₃₃ of the reference block.

At this time, differences between the intra-prediction pixels generated through the intra-prediction and the pixel values a′₀₀ to a′₃₃ are denoted by a_d'₀₀ to a_d'₃₃. Further, it is assumed that only the “available” mode is used as the prediction mode in both the reference block and the target block.

The reference image difference generation unit 173 generates the difference information of the reference image which is a difference between the pixel value of the reference block and the pixel value of the reference intra-prediction image. That is, on the assumption that [Ref] is the pixel value of the reference block and [Ipred_Ref(best_mode)] is the intra-prediction pixel value f the optimum intra-prediction mode in the reference image, the difference information [DifRef] of the reference image is calculated by Expression (76) below.

[Dif_Ref]=[Ref]−[Ipred_Ref(best_mode)] (76)

Subsequently, the intra-prediction mode determined in the reference frame is applied in the target frame to the pixel values b₇, b₈, b₉, b₁₀, b₁₁, b₁₃, b₁₅, b₁₇, and b₁₉ (the pixel values c₀ to c₃, if necessary) in the target frame, the target intra-prediction image is generated.

At this time, the differences between the intra-prediction pixels generated in the intra-prediction and the pixel values a′₀₀ to a′₃₃ of are denoted by a_d₀₀ to a_d₃₃.

Further, the target image difference generation unit 174 generates the difference information of the target image, which is a difference between the pixel value of the target block and the pixel value of the prediction image. That is, on the assumption that [Curr] is the pixel value of the target block and [Ipred_Curr(best_mode)] is the intra-prediction pixel value of the target block of the optimum intra-prediction mode determined in the reference image, difference information [Dif_Curr] of the target image is calculated by Expression (77) below.

[Dif_Curr]=[Curr]−[Ipred_Curr(best_mode)] (77)

Next, the calculation unit 175 generates a 4×4 matrix of [a_d′ₖₗ−a_dₖₗ], k and l=0, . . . , 3. That is, the secondary difference information [Res] is calculated by Expression (78).

[Res]=[Dif_Curr]−[Dif_Ref] (78)

The secondary difference information [Res] generated in this way is encoded and transmitted to the decoding side. That is, the secondary difference information [Res] is output to the motion prediction/compensation unit 75 via the inter-TP motion prediction/compensation unit 162. The motion prediction/compensation unit 75 outputs the pixel value [Curr] of the target block A as the prediction image of the inter-template prediction mode and [Ipred_Curr(best_mode)]+[Dif_Ref] which is the difference between the pixel value [Curr] of the target block a and the secondary difference information [Res] to the prediction image selection unit 78.

When the prediction image selection unit 78 selects the difference between the image to be subjected to the inter-processing as the prediction image generated in the optimum inter-prediction mode and the secondary difference information, the difference [Ipred_Curr(best_mode)]+[Dif_Ref] is output to the calculation units 63 and 70.

The calculation unit 63 subtracts the difference [Ipred_Curr(best_mode)]+[Dif_Ref] from the original image [Curr], the secondary difference information [Res] as the result is output to the orthogonal transform unit 64. The secondary difference information [Res] is subjected to the orthogonal transform by the orthogonal transform unit 64, is quantized by the quantization unit 65, and is encoded by the lossless encoding unit 66.

On the other hand, the secondary difference information [Res] subjected to the orthogonal transform and the quantization is subjected to the inverse quantization and the inverse orthogonal transform and is input to the calculation unit 70. The difference between the image to be subjected to the inter-processing and the secondary difference information is input from the prediction image selection unit 78. Accordingly, the calculation unit 70 adds the secondary difference information [Res] to the difference [Ipred_Curr(best_mode)]+[Dif_Ref] to obtain [Curr]. Then, the [Curr] is output to the de-block filter 71 and the frame memory 72.

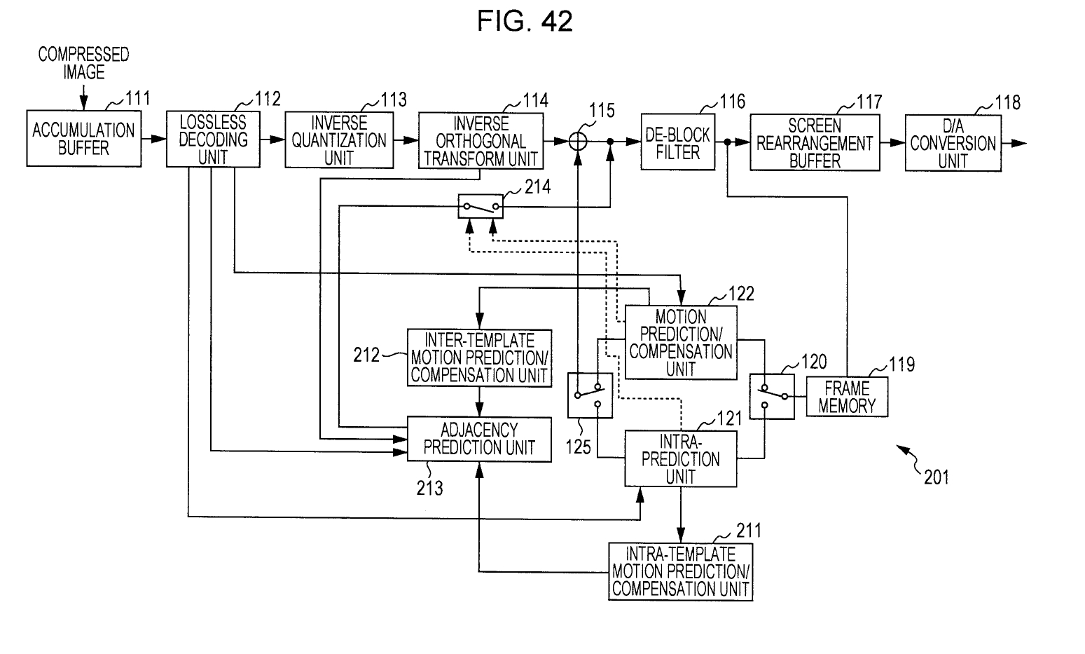

That is, the calculation unit 70 performs the same process as that of the adjacency prediction unit 213 of an image decoding apparatus 201 described below with reference to FIG. 42.

As described above, the prediction image (the reference block B) of the target block A is calculated. Moreover, according to the invention, the difference between the target block A and the in-screen prediction image is calculated and the difference between the reference block B and the in-screen prediction image is calculated. Further, the difference (secondary difference) is encoded. Thus, it is possible to improve the encoding efficiency.

When the determination of the intra-prediction mode is performed in the reference frame, as described above, the above-described process of the adjacency prediction unit 163 can be performed on the decoding side. That is, it is not necessary to transmit the optimum intra-prediction mode. Thus, it is possible to improve the encoding efficiency.

Further, since the prediction process is performed on the prediction image (reference block) and the secondary difference information as the difference value is encoded, the prediction efficiency can be improved in the intra-template matching process and the inter-template matching process.

As described above, the intra-template matching and the inter-template matching are used in correspondence with the target block and the reference block. However, the intra-motion prediction described with reference to FIG. 2 and the motion prediction of the H.264/AVC scheme may be used.

However, in the case of the above-described template-matching, the pixels used in the template matching process can be used in the intra-prediction. Therefore, it is not necessary to read other pixel values from the frame memory at the time of the intra-prediction. Accordingly, since the access to the memory does not increase, it is possible to improve the processing efficiency.

By using the intra-prediction mode defined in the H.264/AVC scheme, the reference image intra-prediction unit 171 and the target image intra-prediction unit 172 can share the circuit with the intra-prediction unit 74. Thus, it is possible to improve the prediction efficiency of the template matching prediction without an increase in the circuit.

The block size of 4×4 pixels has been used in the above description, but the above-described processes are also applicable to the blocks of 8×8 pixels and 16×16 pixels. Further, in the case of the block sizes of 4×4 pixels, 8×8 pixels, and 16×16 pixels, the candidate prediction modes may be restricted to, for example, the Vertical, Horizontal, or the DC prediction modes.

Further, the above-described processes may be performed independently for the Y signal component, the Cb signal component, and the Cr signal component.

### [Description of Another Example of Prediction Process]

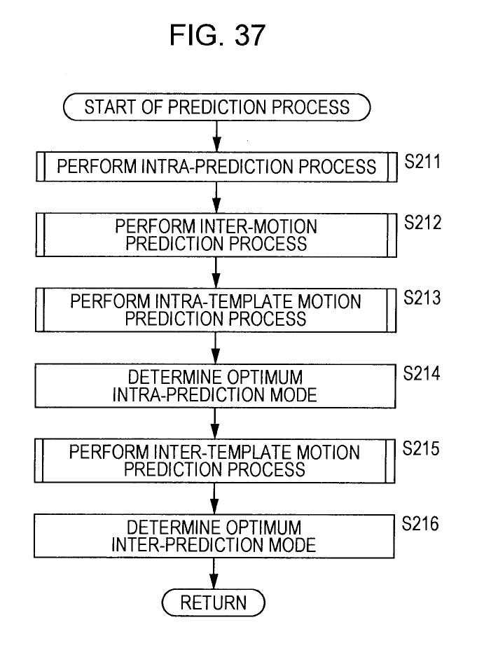

Next, the prediction process of the image encoding apparatus 151 will be described with reference to the flowchart of FIG. 37. The prediction process is another example of the prediction process in FIG. 13 described in the prediction process of step S21 of FIG. 12. That is, since the encoding process of the image encoding apparatus 151 is basically the same as the encoding process of the image encoding apparatus 51 described with reference to FIG. 12, the description thereof will not be repeated.

When the image, which is to be processed, supplied from the screen rearrangement buffer 62 is an image of the block to be subjected to the intra-processing, the decoded image to be referred is read from the frame memory 72 and is supplied to the intra-prediction unit 74 via the switch 73. In step S211, the intra-prediction unit 74 performs the intra-prediction on the pixels of the block to be processed in all the candidate intra-prediction modes based on this image.

The details of the intra-prediction process in step S211 are basically the same as those of the process described above with reference to FIG. 26. The intra-prediction is performed in all the candidate intra-prediction modes through this process to calculate the cost function values for all the candidate intra-prediction modes. Then, based on the calculated cost function values, one intra-prediction mode considered to be optimum is selected among all the intra-prediction modes.

In the case of step S211, unlike the example of FIG. 26, the prediction image generated in the optimum intra-prediction mode and the cost function value thereof are not supplied to the prediction image selection unit 78. The cost function value of the optimum intra-prediction mode is used in the process of step S214.

When the image, which is to be processed, supplied from the screen rearrangement buffer 62 is an image of the block to be subjected to the inter-processing, the decoded image to be referred is read from the frame memory 72 is supplied to the motion prediction/compensation unit 75 via the switch 73. In step S212, the motion prediction/compensation unit 75 performs the inter-motion prediction process based on this image. That is, the motion prediction/compensation unit 75 performs the motion prediction process in all the candidate inter-prediction mode with reference to the image supplied from the frame memory 72.

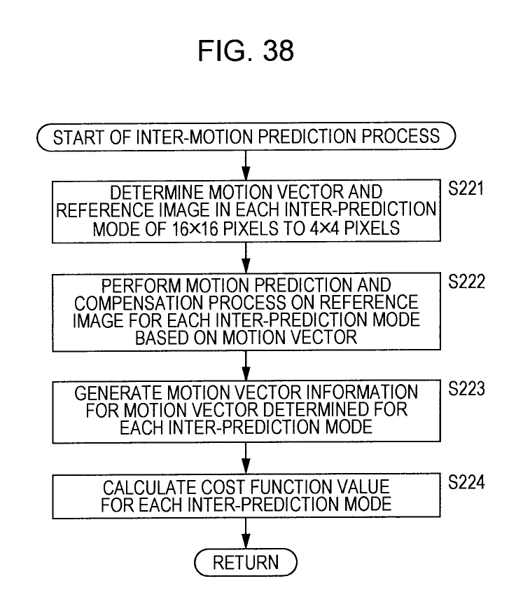

The details of the inter-motion prediction process in step S212 will be described below with reference to FIG. 38. The motion prediction process is performed in all the candidate inter-prediction modes through this process to calculate the cost function values for all the candidate inter-prediction modes.

When the image, which is to be processed, supplied from the screen rearrangement buffer 62 is an image of the block to be subjected to the intra-processing, the decoded image, which is to be referred, from the frame memory 72 is supplied also to the intra-TP motion prediction/compensation unit 161 via the intra-prediction unit 74. In step S213, the intra-TP motion prediction/compensation unit 161 performs the intra-template motion prediction process in the intra-template prediction mode.

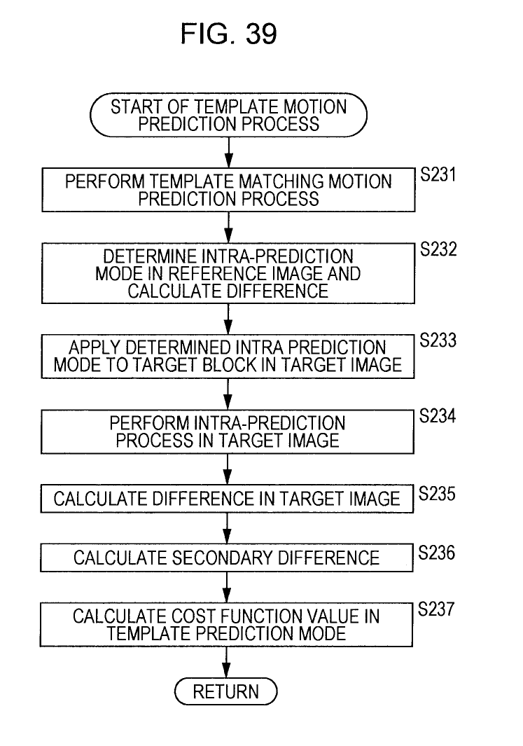

The details of the intra-template motion prediction process in step S213 will be described below with reference to FIG. 39 together with the details of the inter-template motion prediction process. The motion prediction process is performed in the intra-template prediction mode through this process to calculate the secondary different information. The cost function value is calculated for the intra-template prediction mode using the calculated secondary difference information. Then, the difference between the secondary difference information and the target block generated as the prediction image through the motion prediction process of the intra-template prediction mode is supplied together with the cost function value thereof to the intra-prediction unit 74.

In step S214, the intra-prediction unit 74 compares the cost function value for the intra-prediction mode selected in step S211 to the cost function value for the intra-template prediction mode calculated in step S213. The intra-prediction unit 74 determines the prediction mode with the minimum value as the optimum intra-prediction mode and supplies the prediction image generated in the optimum intra-prediction mode and the cost function value thereof to the prediction image selection unit 78.

When the image, which is to be processed, supplied from the screen rearrangement buffer 62 is an image of the block to be subjected to the inter-processing, the decoded image to be referred is read from the frame memory 72 is supplied to inter-TP motion prediction/compensation unit 162 via the motion prediction/compensation unit 75. In step S215, the inter-TP motion prediction/compensation unit 162 performs the inter-template motion prediction process in the inter-template prediction mode based on this image.

The details of the inter-template motion prediction process in step S215 will be described with reference to FIG. 39 together with the intra-template motion prediction process. The motion prediction process is performed in the inter-template prediction mode through this process to calculate the secondary different information. The cost function value is calculated for the inter-template prediction mode using the calculated secondary difference information. Then, the difference between the secondary difference information and the target block generated as the prediction image through the motion prediction process of the inter-template prediction mode is supplied together with the cost function value thereof to the motion prediction/compensation unit 75.

In step S216, the motion prediction/compensation unit 75 compares the cost function value for the optimum inter-prediction mode selected in step S212 to the cost function value for the inter-template prediction mode calculated in step S215. The motion prediction/compensation unit 75 determines the prediction mode with the minimum value as the optimum inter-prediction mode. The motion prediction/compensation unit 75 supplies the prediction image generated in the optimum intra-prediction mode and the cost function value thereof to the prediction image selection unit 78.

### [Description of Inter-Motion Prediction Process]

Next, the inter-motion prediction process of step S212 in FIG. 37 will be described with reference to the flowchart of FIG. 38.

In step S221, the motion prediction/compensation unit 75 determines the motion vector and the reference image for each of the eight types of inter-prediction modes of 16×16 pixels to 4×4 pixels described above with reference to FIG. 5. That is, the motion vector and the reference image are determined for the block to be process for each of the inter-prediction modes.

In step S222, the motion prediction/compensation unit 75 performs the motion prediction and the compensation process on the reference image based on the motion vector determined in step S221 for each of the eight types of inter-prediction modes of 16×16 pixels to 4×4 pixels. The prediction image is generated in each of the inter-prediction modes through the motion prediction and the compensation process.

In step S223, the motion prediction/compensation unit 75 generates the motion vector information added to a compressed image in the motion vector determined in each of the eight types of inter-prediction modes of 16×16 pixels to 4×4 pixels. At this time, the motion vector information is generated using the method of generating the motion vector described with reference to FIG. 8.

The generated motion vector information is also used when the cost function value is calculated in subsequent step S224. When the prediction image selection unit 78 finally selects the corresponding prediction image, the motion vector information is output together with the prediction mode information and the reference frame information to the lossless encoding unit 66.

In step S224, the motion prediction/compensation unit 75 calculates the cost function value expressed in Expression (74) or Expression (75) described above in each of the eight types of inter-prediction modes of 16×16 pixels to 4×4 pixels. Here, the calculated cost function value is used when the optimum inter-prediction mode is determined in step S126 described above with reference to FIG. 37.

### [Description of Template Motion Prediction Process]

Next, the template motion prediction process will be described with reference to the flowchart of FIG. 39. In the example of FIG. 39, the case of the inter-processing, that is, a case of the template motion prediction process of step S215 in FIG. 37 has been described. This process is the same except that the reference block exists in the screen or between the screens. Accordingly, the case of the intra-process, that is, the same process as the process in FIG. 39 is performed even in step S213 in FIG. 37.

In step S231, the inter-TP motion prediction/compensation unit 162 performs the inter-template matching motion prediction process. That is, the image which is to be subjected the inter-prediction, read from the screen rearrangement buffer 62 and the necessary reference image supplied from the frame memory 72 are input to the inter-TP motion prediction/compensation unit 162.

The inter-TP motion prediction/compensation unit 162 performs the motion prediction of the inter-template prediction mode using the image to be subjected to the inter-prediction and the reference image and using the pixel value of the template with the decoded pixels and the pixels adjacent to the target block, as described above with reference to FIG. 3. Further, the inter-TP motion prediction/compensation unit 162 calculates the reference block which can correspond to the target block of the image to be subjected to the inter-processing in the reference frame.

The inter-TP motion prediction/compensation unit 162 outputs the information (that is, the information regarding the adjacent pixels of the target block and the reference block) regarding the necessary reference image, the information regarding the target block, and the information regarding the reference block corresponding to the target block to the reference image intra-prediction unit 171.

In step S232, the reference image intra-prediction unit 171 and the reference image difference generation unit 173 determines the intra-prediction mode and calculates the difference in the reference image. That is, the reference image intra-prediction unit 171 generates the reference intra-prediction images in all the intra-prediction modes defined in the H.264/AVC scheme in the reference frame by the use of the pixel values of the pixels adjacent to the reference block.

The reference image intra-prediction unit 171 determines the prediction mode with the minimum prediction error (SAD) between the pixel value of the reference block and the pixel value of the reference intra-prediction image and outputs the pixel value of the reference block and the reference intra-prediction image of the determined prediction mode to the reference image difference generation unit 173. Further, the reference image intra-prediction unit 171 outputs the information (for example, information regarding the adjacent pixels of the target block) regarding the necessary reference image, the information regarding the target block, and the information regarding the determined intra-prediction mode to the target image intra-prediction unit 172.

The reference image difference generation unit 173 calculates the difference information of the reference image, which is the difference between the pixel value of the reference block and the pixel value of the reference intra-prediction image, and outputs the calculated difference information of the reference image to the calculation unit 175.

In step S233, the target image intra-prediction unit 172 applies the intra-prediction mode determined for the reference block to the target block for the target image. In step S234, the target image intra-prediction unit 172 performs the intra-prediction process on the target image using the applied intra-prediction mode. That is, the target image intra-prediction unit 172 generates the target intra-prediction image in the applied intra-prediction mode by the use of the pixel values of the pixels adjacent to the target block in the target frame. The information regarding the target intra-prediction image generated through the intra-prediction is output together with the information regarding the target block to the target image difference generation unit 174.

In step S235, the target image difference generation unit 174 generates the difference information of the target image, which is a difference between the pixel value of the target block and the pixel value of the target intra-prediction image, and outputs the generated difference information of the target image to the calculation unit 175.

In step S236, the calculation unit 175 performs division calculation on the difference information of the target image and the difference information of the reference image, calculates the secondary difference information, and outputs the calculated secondary difference information to the inter-TP motion prediction/compensation unit 162.

In step S237, the inter-TP motion prediction/compensation unit 162 calculates the cost function value expressed in Expression (74) or Expression (75) described above in the inter-template prediction mode by the use of the secondary difference information from the calculation unit 175. The inter-TP motion prediction/compensation unit 162 outputs the difference between the secondary difference information and the image to be subjected to the inter-processing as the prediction image and the cost function value thereof to the motion prediction/compensation unit 75.

That is, the calculated cost function value is used when the optimum inter-prediction mode is determined in step S216 of FIG. 37 described above.

Since the optimum intra-prediction mode is determined in the reference block and is applied even to the target block, as described above, it is not necessary to transmit the intra-prediction mode to the decoding side.

### [Description of Another Example of Template Motion Prediction Process]

Next, another example of the template motion prediction process will be described with reference to the flowchart of FIG. 40. For facilitating the description of the example of FIG. 40, the description will be made with reference to the function block of FIG. 35, but some of the data flow are different from that of FIG. 35.

In step S251, the inter-TP motion prediction/compensation unit 162 performs the inter-template matching motion prediction process. Thus, the reference block which can correspond to the target block of the image to be subjected to the inter-processing is calculated in the reference frame.

In the example of FIG. 40, the inter-TP motion prediction/compensation unit 162 outputs the information (that is, the information regarding the adjacent pixels of the target block and the reference block) regarding the reference image, the information regarding the target block, and the information regarding the reference block corresponding to the target block to the target image intra-prediction unit 172.

In step S252, the target image intra-prediction unit 172 and the target image difference generation unit 174 determines the intra-prediction mode and calculates the difference in the target image. That is, the target image intra-prediction unit 172 generates the target intra-prediction images in all the intra-prediction modes defined in the H.264/AVC scheme in the target frame by the use of the pixel values of the pixels adjacent to the target block.

The target image intra-prediction unit 172 determines the prediction mode with the minimum prediction error (SAD) between the pixel value of the target block and the pixel value of the target intra-prediction image and outputs the pixel value of the target block and the target intra-prediction image of the determined prediction mode to the target image difference generation unit 174.

The target image intra-prediction unit 172 outputs the information (for example, information regarding the adjacent pixels of the reference block) regarding the necessary reference image and the information regarding the reference block to the reference image intra-prediction unit 171. Further, the target image intra-prediction unit 172 outputs the information regarding the determined intra-prediction mode to the reference image intra-prediction unit 171 and outputs this information to the corresponding intra-TP motion prediction/compensation unit 161 or the corresponding inter-TP motion prediction/compensation unit 162.

That is, when the prediction image of the inter-template prediction mode is selected by the prediction image selection unit 78, the information regarding the intra-prediction mode determined in the target block is output together with the inter-template prediction mode to the lossless encoding unit 66 and is transmitted to the decoding side.

The target image difference generation unit 174 calculates the difference information of the target image, which is the difference between the pixel value of the target block and the pixel value of the target intra-prediction image, and outputs the calculated difference information of the target image to the calculation unit 175.

In step S253, the reference image intra-prediction unit 171 applies the intra-prediction mode determined for the target block to the reference block for the reference image. In step S254, the reference image intra-prediction unit 171 performs the intra-prediction process on the reference image using the applied intra-prediction mode. That is, the reference image intra-prediction unit 171 generates the reference intra-prediction image in the applied intra-prediction mode in the reference frame. The information regarding the reference intra-prediction image generated through the intra-prediction is output together with the information regarding the reference block to the reference image difference generation unit 173.

In step S254, the reference image difference generation unit 173 generates the difference information of the reference image, which is a difference between the pixel value of the reference block and the pixel value of the reference intra-prediction image, and outputs the generated difference information of the reference image to the calculation unit 175.

In step S256, the calculation unit 175 performs division calculation on the difference information of the target image and the difference information of the reference image, calculates the secondary difference information, and outputs the calculated secondary difference information to the inter-TP motion prediction/compensation unit 162.

In step S257, the inter-TP motion prediction/compensation unit 162 calculates the cost function value expressed in Expression (74) or Expression (75) described above in the inter-template prediction mode by the use of the secondary difference information from the calculation unit 175. The inter-TP motion prediction/compensation unit 162 outputs the difference between the secondary difference information and the image to be subjected to the inter-processing as the prediction image and the cost function value thereof to the motion prediction/compensation unit 75.

That is, the calculated cost function value is used when the optimum inter-prediction mode is determined in step S216 of FIG. 37 described above.

Since the optimum intra-prediction mode is determined in the target block and is applied even to the reference block, as described above, it is necessary to transmit the intra-prediction mode to the decoding side. However, the efficiency of the intra-prediction is improved compared to the example of FIG. 39.

### [Description of Still Another Example of Template Motion Prediction Process]

Next, another example of the template motion prediction process will be described with reference to the flowchart of FIG. 41. For facilitating the description of the example of FIG. 41, the description will be made with reference to the function block of FIG. 35, but some of the data flow are different from that of FIG. 35.

In step S271, the inter-TP motion prediction/compensation unit 162 performs the inter-template matching motion prediction process. Thus, the reference block which can correspond to the target block of the image to be subjected to the inter-processing is calculated in the reference frame.

In the example of FIG. 41, the inter-TP motion prediction/compensation unit 162 outputs the information (that is, the information regarding the adjacent pixels of the target block and the reference block) regarding the reference image, the information regarding the target block, and the information regarding the reference block corresponding to the target block to the reference image intra-prediction unit 171 and the target image intra-prediction unit 172.

In step S272, the target image intra-prediction unit 172 and the target image difference generation unit 174 determines the intra-prediction mode and calculates the difference in the target image. That is, the target image intra-prediction unit 172 generates the target intra-prediction images in all the intra-prediction modes defined in the H.264/AVC scheme in the target frame by the use of the pixel values of the pixels adjacent to the target block.

The target image intra-prediction unit 172 determines the prediction mode with the minimum prediction error (SAD) between the pixel value of the target block and the pixel value of the target intra-prediction image and outputs the pixel value of the target block and the target intra-prediction image of the determined prediction mode to the target image difference generation unit 174.

Further, the target image intra-prediction unit 172 outputs the information regarding the determined intra-prediction mode to the corresponding intra-TP motion prediction/compensation unit 161 or the corresponding inter-TP motion prediction/compensation unit 162. That is, when the prediction image of the inter-template prediction mode is selected by the prediction image selection unit 78, the information regarding the intra-prediction mode determined in the target block is output together with the inter-template prediction mode to the lossless encoding unit 66 and is transmitted to the decoding side.

The target image difference generation unit 174 calculates the difference information of the target image, which is the difference between the pixel value of the target block and the pixel value of the target intra-prediction image, and outputs the calculated difference information of the target image to the calculation unit 175.

In step S273, the reference image intra-prediction unit 171 and the reference image difference generation unit 173 determines the intra-prediction mode and calculates the difference in the reference image. That is, the reference image intra-prediction unit 171 generates the reference intra-prediction images in all the intra-prediction modes defined in the H.264/AVC scheme in the reference frame by the use of the pixel values of the pixels adjacent to the reference block.

The reference image intra-prediction unit 171 determines the prediction mode with the minimum prediction error (SAD) between the pixel value of the reference block and the pixel value of the reference intra-prediction image and outputs the pixel value of the reference block and the reference intra-prediction image of the determined prediction mode to the reference image difference generation unit 173.

The reference image difference generation unit 173 calculates the difference information of the reference image, which is a difference between the pixel value of the reference block and the pixel value of the reference intra-prediction image, and outputs the calculated difference information of the reference image to the calculation unit 175.

In step S274, the calculation unit 175 performs division calculation on the difference information of the target image and the difference information of the reference image, calculates the secondary difference information, and outputs the calculated secondary difference information to the inter-TP motion prediction/compensation unit 162.

In step S275, the inter-TP motion prediction/compensation unit 162 calculates the cost function value expressed in Expression (74) or Expression (75) described above in the inter-template prediction mode by the use of the secondary difference information from the calculation unit 175. The inter-TP motion prediction/compensation unit 162 outputs the difference between the secondary difference information and the image to be subjected to the inter-processing as the prediction image and the cost function value thereof to the motion prediction/compensation unit 75.

That is, the calculated cost function value is used when the optimum inter-prediction mode is determined in step S216 of FIG. 37 described above.

Since the optimum intra-prediction mode is determined in the target block and the reference block, as described above, it is necessary to transmit the intra-prediction mode to the decoding side, thereby increasing the process. However, the efficiency of the intra-prediction is improved compared to the example of FIG. 40.

### Another Example of Configuration of Image Decoding Apparatus

FIG. 42 is a diagram illustrating the configuration of the image decoding apparatus serving as an image processing apparatus according to another embodiment of the invention.

The image decoding apparatus 201 has the same configuration as that of the image decoding apparatus 101 in FIG. 29 in that the image decoding apparatus 201 includes the accumulation buffer 111, the lossless decoding unit 112, the inverse quantization unit 113, the inverse orthogonal transform unit 114, the calculation unit 115, the de-block filter 116, the screen rearrangement buffer 117, the D/A conversion unit 118, the frame memory 119, the switch 120, the intra-prediction unit 121, the motion prediction/compensation unit 122, and the switch 125.

The image decoding apparatus 201 is different from that the image decoding apparatus 101 in FIG. 29 in that the image decoding apparatus 201 includes no in-screen prediction unit 123 and no secondary difference compensation unit 124 and further includes an intra-template motion prediction/compensation 211, an inter-template motion prediction/compensation 212, an adjacency prediction unit 213, and a switch 214.

Hereinafter, the intra-template motion prediction/compensation 211 and the inter-template motion prediction/compensation 212 are referred to as an intra-TP motion prediction/compensation unit 211 and an inter-TP motion prediction compensation unit 212, respectively.

The information, which is obtainable by decoding the header information, regarding the intra-prediction mode is supplied from the lossless decoding unit 112 to the intra-prediction unit 121. When the information regarding the intra-prediction mode is supplied, the intra-prediction unit 121 generates the prediction image based on this information and outputs the generated prediction image to the switch 125.

When the information regarding the intra-template prediction mode is supplied, the intra-prediction unit 121 supplies the image used for the intra-prediction to the intra-TP motion prediction/compensation unit 211 and performs the motion prediction/compensation process in the intra-template prediction mode. In this case, the intra-prediction unit 121 turns on the switch 214 and supplies the image from the adjacency prediction unit 213 to the de-block filter 116.

The intra-TP motion prediction/compensation unit 211 performs the motion prediction of the same intra-template prediction mode as that of the intra-TP motion prediction/compensation unit 161 in FIG. 34 to calculate the reference block which can correspond to the target block of the image to be subjected to the intra-processing. The intra-TP motion prediction/compensation unit 211 outputs the information (that is, the information regarding the adjacent pixels of the target block and the reference block) regarding the reference image, the information regarding the target block, and the information regarding the reference block corresponding to the target block to the adjacency prediction unit 213.

The information (prediction mode, motion vector information, or reference frame information) which is obtainable by decoding the header information is supplied from the lossless decoding unit 112 to the motion prediction/compensation unit 122. When the information indicating the inter-prediction mode is supplied, the motion prediction/compensation unit 122 generates the prediction image by performing the motion prediction and the compensation process on the image based on the motion vector information and the reference frame information and outputs the generated prediction image to the switch 125.

When the information indicating the inter-template prediction mode is supplied, the motion prediction/compensation unit 122 supplies the inter-TP motion prediction compensation unit 212 with the image, which is to be subjected to the inter-processing, read from the frame memory 119 and the image to be referred. Then, the motion prediction/compensation unit 122 performs the motion prediction/compensation process in the inter-template prediction mode. In this case, the motion prediction/compensation unit 122 turns on the switch 214 and supplies the image from the adjacency prediction unit 213 to the de-block filter 116.

The inter-TP motion prediction compensation unit 212 performs the motion prediction of the same inter-template prediction mode as that of the inter-TP motion prediction/compensation unit 162 in FIG. 34 to calculate the reference block which can correspond to the target block of the image to be subjected to the inter-processing. The inter-TP motion prediction compensation unit 212 outputs the information (that is, the information regarding the adjacent pixels of the target block and the reference block) regarding the reference image, the information regarding the target block, and the information regarding the reference block corresponding to the target block to the adjacency prediction unit 213.

The secondary difference information subjected to the decoding process, the inverse quantization, and the inverse orthogonal transformed is supplied from the inverse orthogonal transform unit 114 to the adjacency prediction unit 213. Further, when there is the information regarding the intra-prediction mode associated with the secondary difference information, this information is supplied from the lossless decoding unit 112.

The adjacency prediction unit 213 performs the process corresponding to the processes of the in-screen prediction unit 123 and the secondary difference compensation unit 124 in FIG. 29. That is, the adjacency prediction unit 213 performs the intra-prediction on the target block as the in-screen prediction by the use of the information regarding the necessary reference image to generate the target intra-prediction image and performs the intra-prediction on the reference block to generate the reference intra-prediction image. At this time, the adjacency prediction unit 213 uses the information regarding the intra-prediction mode associated with the secondary difference information supplied from the lossless decoding unit 112, if necessary.

The adjacency prediction unit 213 calculates the reference difference information, which is the difference between the pixel value of the reference block and the pixel value of the reference intra-prediction image, and compensates the target image using the secondary difference information, the target intra-prediction image, and the reference difference information from the inverse orthogonal transform unit 114. The adjacency prediction unit 213 supplies the compensated target image to the de-block filter 116 via the switch 214.

The switch 214 is normally turned off. Therefore, terminals of both ends are connected and turned on under to the control of the intra-prediction unit 121 or the motion prediction/compensation unit 122 and the image from the adjacency prediction unit 213 is supplied to the de-block filter 116.

### Example of Configuration of Adjacency Unit

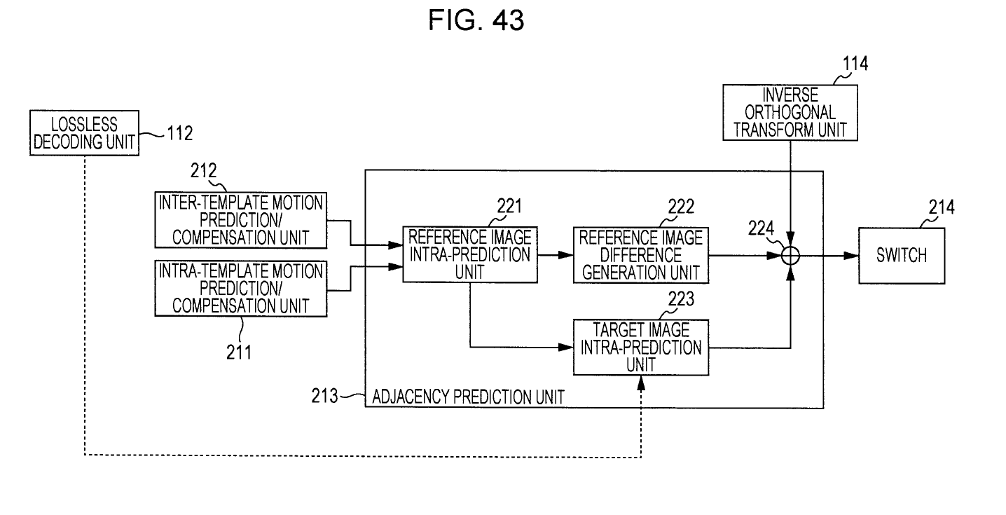

FIG. 43 is a block diagram illustrating an example of the detailed configuration of the adjacency prediction unit.

In the example of FIG. 43, the adjacency prediction unit 213 includes a reference image intra-prediction unit 221, a reference image difference generation unit 222, a target image intra-prediction unit 223, and a calculation unit 224.

The information (that is, information regarding the adjacent pixels of the target block and the reference block) regarding the necessary reference image, the information regarding the target block, and the information regarding the reference block corresponding to the target block are input from the intra-TP motion prediction/compensation unit 211 or the inter-TP motion prediction/compensation unit 212 to the reference image intra-prediction unit 221.

The reference image intra-prediction unit 221 performs the intra-prediction on the reference block in the corresponding reference frame or target frame to generate the reference intra-prediction image. For example, when the process in FIG. 39 is performed in the image encoding apparatus 151, the reference image intra-prediction unit 221 generates the reference intra-prediction images of all the intra-prediction modes and determines the intra-prediction mode with the minimum prediction error with the pixel value of the reference block.

The reference image intra-prediction unit 221 outputs the information (for example, information regarding the adjacent pixels of the target block) regarding the necessary reference image, the information regarding the target block, and the information regarding the determined intra-prediction mode to the target image intra-prediction unit 223. Further, the reference image intra-prediction unit 221 outputs the information regarding the reference block and the information regarding the reference intra-prediction image generated in the determined intra-prediction mode to the reference image difference generation unit 222.

The reference image difference generation unit 222 generates the difference information of the reference image, which is the difference between the pixel value of the reference block and the pixel value of the prediction image, and outputs the generated difference information of the reference image to the calculation unit 224.

The target image intra-prediction unit 223 generates the target intra-prediction image by performing the intra-prediction on the target block. For example, when the process in FIG. 39 is performed in the image encoding apparatus 151, the target image intra-prediction unit 223 generates the target intra-prediction image in the intra-prediction mode determined by the reference image intra-prediction unit 221. The target image intra-prediction unit 223 outputs the information regarding the generated target intra-prediction image to the calculation unit 224.

The secondary difference information is input from the inverse orthogonal transform unit 114 to the calculation unit 224. The calculation unit 224 compensates the target image using the secondary difference information, the target intra-prediction image, and the reference difference information from the inverse orthogonal transform unit 114. The adjacency prediction unit 213 supplies the compensated target image to the switch 214.

When the process in FIG. 40 or 41 is performed in the image encoding apparatus 151, the lossless decoding unit 112 decodes the information regarding the intra-prediction mode associated with the secondary difference information. In this case, the target image intra-prediction unit 223 performs the intra-prediction on the target block in the intra-prediction mode in which the lossless decoding unit 112 performs the decoding.

When the process in FIG. 40 is performed in the image encoding apparatus 151, the target image intra-prediction unit 223 supplies the reference image intra-prediction unit 221 with the intra-prediction mode in which the lossless decoding unit 112 performs the decoding. In this case, the reference image intra-prediction unit 221 also performs the intra-prediction on the target block in the intra-prediction mode in which the lossless decoding unit 112 performs the decoding.

### Examples of Operations of Inter-TP Motion Prediction/Compensation Unit and Adjacency Prediction Unit

Hereinafter, the operations of the inter-TP motion prediction/compensation unit and the adjacency prediction unit in the image decoding apparatus 201 will be described. Since the same is applied to the intra-TP motion prediction/compensation unit, the description thereof will not be repeated.

In the calculation unit 224, the secondary difference information [res]=[Dif_Curr]−[Dif_Ref] (which can be obtained by Expression (78) described above) from the image encoding apparatus 151 can be obtained.

The inter-TP motion prediction/compensation unit 212 performs the motion prediction and the compensation process of the same inter-template prediction mode as that of the inter-TP motion prediction/compensation unit 162 in FIG. 34 and determines the reference block which can correspond to the target block of the image to be subjected to the inter-processing.

The reference image intra-prediction unit 221 performs the intra-prediction on the reference block in the reference frame to generate the reference intra-prediction mage. For example, when the process in FIG. 39 is performed in the image encoding apparatus 151, the reference image intra-prediction unit 221 generates the reference intra-prediction images of all the intra-prediction modes and determines the intra-prediction mode with the minimum prediction error with the pixel value of the reference block.

The reference image difference generation unit 222 generates the difference information [Dif_ref] of the reference image which is the difference between the pixel value of the reference block and the pixel value of the reference intra-prediction image generated in the determined intra-prediction mode (best_mode).

The calculation unit 224 generates the difference information [Dif_Curr] of the target image by Expression (79) below using the secondary difference information [Dif_Curr]−[Dif_Ref] and the difference information [Dif_ref].

([Dif_Curr]−[Dif_Ref]+[Dif_ref]=[Dif_Curr] (79)

The target image intra-prediction unit 223 performs the intra-prediction on the target block in the target frame in the intra-prediction mode (best_mode) determined for the reference block to generate an target intra-prediction image [Ipred_Ref(best_mode)].

Accordingly, the calculation unit 224 generates the decoded image by Expression (80) below using the generated target intra-prediction image [Ipred_Ref(best_mode)] and the difference information [Dif_Curr] of the target image of Expression (79).

decoded image=[Dif_Curr]+[Ipred_Ref(best_mode)] (80)

In the above description, the processes of the calculation unit 224 are separately performed by Expression (79) and Expression (80) in order to facilitate the description, but may be simultaneously performed.

The optimum intra-prediction mode (best_mode) is determined in the target image by the image encoding apparatus 151 and the information is transmitted is some cases (case of FIG. 40 or 41). In this case, not the best_mode determined in the reference image but the transmitted best_mode is used even in the image decoding apparatus 201. Further, when the best_mode is used even in the reference image in the image encoding apparatus 151 (case of FIG. 40), the best_mode is used also in the reference image in the image decoding apparatus 201.

### [Description of Another Example of Prediction Process]

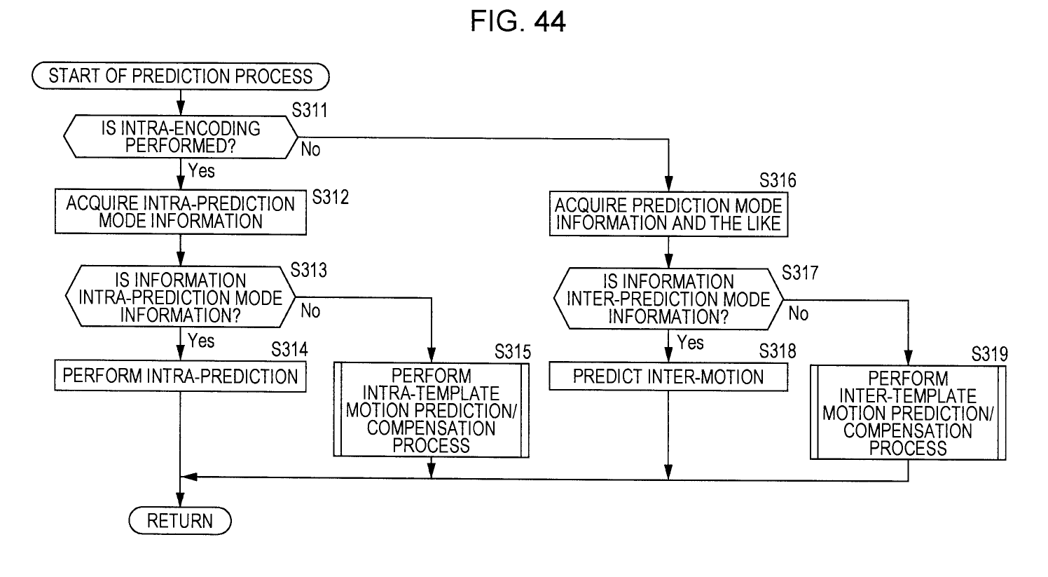

Next, the prediction process of the image decoding apparatus 201 will be described with reference to the flowchart of FIG. 44. The prediction process is another example of the prediction process in FIG. 32 described in the prediction process of step S138 of FIG. 31. That is, since the encoding process of the image decoding apparatus 201 is basically the same as the encoding process of the image decoding apparatus 101 described with reference to FIG. 31, the description thereof will not be repeated.

In step S311, the intra-prediction unit 121 determines whether the target block is subjected to the intra-processing. The intra-prediction mode information or the intra-template prediction mode information is supplied from the lossless decoding unit 112 to the intra-prediction unit 121. Thus, the intra-prediction unit 121 determines that the target block is subjected to the intra-processing in step S311, and then the process proceeds to step S312.

In step S312, the intra-prediction unit 121 acquires the intra-prediction mode information or the intra-template prediction mode information. In step S313, the intra-prediction unit 121 determines whether the prediction mode is the intra-prediction mode. When the intra-prediction unit 121 determines that the prediction mode is the intra-prediction mode in step S313, the intra-prediction unit 121 performs the intra-prediction in step S314.

That is, when the image to be processed is the image to be subjected to the intra-processing, a necessary image is read from the frame memory 119 and is supplied to the intra-prediction unit 121 via the switch 120. In step S314, the intra-prediction unit 121 performs the intra-prediction based on the intra-prediction mode information acquired in step S312 to generate the prediction image. The generated prediction image is output to the switch 125.

On the other hand, when the intra-template prediction mode information is acquired in step S312, the intra-prediction unit 121 determines that the intra-template prediction mode information is not the intra-prediction mode information in step S313. Then, the process proceeds to step S315.

When the image to be processed is the image to be subjected to the intra-template prediction process, a necessary image is read from the frame memory 119 and is supplied to the intra-TP motion prediction/compensation unit 211 via the switch 120 and the intra-prediction unit 121.

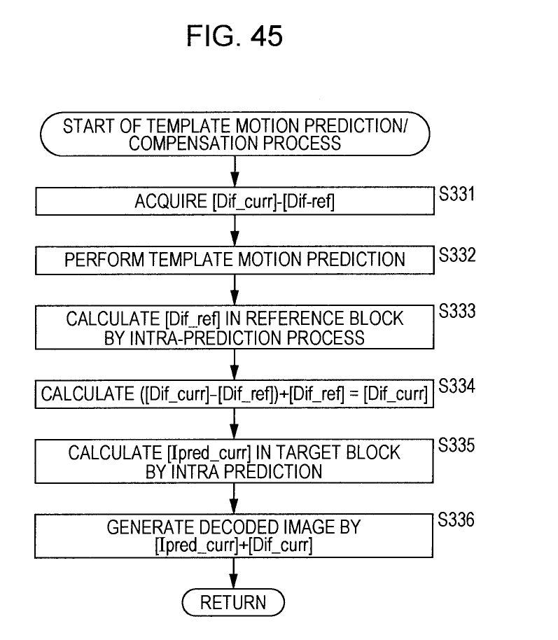

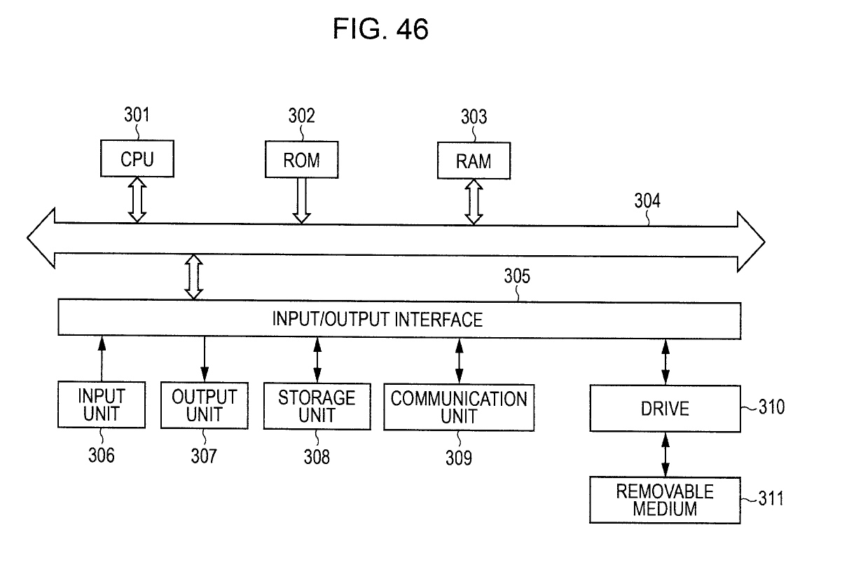

In step S315, the intra-TP motion prediction/compensation unit 211 performs the motion prediction/compensation process of the intra-template prediction mode. The details of the intra-template motion prediction/compensation process of step S315 will be described with reference to FIG. 45 together with the inter-template motion prediction/compensation process.

The intra-prediction is performed on the reference block in the target frame through this process to calculate the reference difference information between the reference block and the reference intra-prediction image. Further, the intra-prediction is performed on the target block in the target frame to generate the intra-prediction image. Then, the secondary difference information, the target intra-prediction image, and the reference difference information from the inverse orthogonal transform unit 114 are added, the image of the target block is generated, and the generated image is output to the filter 116 via the switch 214. That is, in this case, the image of the target block is directly output to the de-block filter 116 without transmission to the calculation unit 115.

On the other hand, when the intra-prediction unit 121 determines that the target block is not subjected to the intra-processing in step S311, the process proceeds to step S316. In step S316, the motion prediction/compensation unit 122 acquires the prediction mode information or the like from the lossless decoding unit 112. At this time, the target image intra-prediction unit 223 acquires the information regarding the intra-prediction mode associated with the secondary difference information.

When the image to be processed is the image to be subjected to the inter-processing, the inter-prediction mode information, the reference frame information, and the motion vector information are supplied from the lossless decoding unit 112 to the motion prediction/compensation unit 122. In this case, in step S316, the motion prediction/compensation unit 122 acquires the inter-prediction mode information, the reference frame information, and the motion vector information.

In step S317, the motion prediction/compensation unit 122 determines whether the prediction mode information from the loss decoding unit 112 is the inter-prediction mode information. When the motion prediction/compensation unit 122 determines that the prediction mode information from the loss decoding unit 112 is the inter-prediction mode information in step S317, the process proceeds to step S318.

In step S318, the motion prediction/compensation unit 122 performs the inter-motion prediction. That is, when the image to be processed is the image to be subjected to the inter-prediction process, a necessary image is read from the frame memory 119 and is supplied to the motion prediction/compensation unit 122 via the switch 120. In step S318, the motion prediction/compensation unit 122 performs the motion prediction of the inter-prediction mode based on the motion vector acquired in step S316 to generate the prediction image. The generated prediction image is output to the switch 125.

On the other hand, when the inter-template prediction mode information is acquired in step S316, the motion prediction/compensation unit 122 determines that the prediction mode information is not the inter-prediction mode information in step S317. Then, the process proceeds to step S319.

When the image to be processed is the image to be subjected to the inter-template prediction process, a necessary image is read from the frame memory 119 and is supplied to the inter-TP motion prediction/compensation unit 212 via the switch 120 and the motion prediction/compensation unit 122.

In step S319, the inter-TP motion prediction/compensation unit 212 performs the motion prediction of the inter-template prediction mode and the compensation process. The details of the inter-template motion prediction/compensation process of step S319 will be described below with reference to FIG. 45 together with the intra-template motion prediction/compensation process.

The intra-prediction is performed on the reference block in the reference frame through this process to calculate the reference difference information between the reference block and the reference intra-prediction image. Further, the intra-prediction is performed on the target block in the target frame to generate the target intra-prediction image. Then, the secondary difference information, the target intra-prediction image, and the reference difference information from the inverse orthogonal transform unit 114 are added, the image of the target block is generated, and the generated image is output to the filter 116 via the switch 214. That is, in this case, the image of the target block is directly output to the de-block filter 116 without transmission to the calculation unit 115.

### [Description of Template Motion Prediction Process]

Next, the template motion prediction/compensation process will be described with reference to the flowchart of FIG. 45. In the example of FIG. 45, the case of the inter-processing, that is, a case of the template motion prediction process of step S319 in FIG. 44 will be described. This process is the same except that the reference block exists in the screen or between the screens. Accordingly, the case of the intra-process, that is, the same process as the process in FIG. 45 is performed even in step S315 in FIG. 44.

The secondary difference information [Res] subjected to the decoding process, the inverse quantization, and the inverse orthogonal transform is supplied from the inverse orthogonal transform unit 114 to the calculation unit 224. In step S331, the calculation unit 224 acquires the secondary difference information [Res]=[Diff_curr]−[Dif_ref] from the inverse orthogonal transform unit 114.

In step S332, the inter-TP motion prediction/compensation unit 212 performs the motion prediction of the same inter-template prediction mode as the inter-TP motion prediction/compensation unit 162 in FIG. 34 and determines the reference block which can correspond to the target block of the image to be subjected to the inter-processing.

The inter-TP motion prediction/compensation unit 212 outputs the information (that is, the information regarding the adjacent pixels of the target block and the reference block) regarding the necessary reference image, the information regarding the target block, and the information regarding the reference block corresponding to the target block to the reference image intra-prediction unit 221.

In step S333, the reference image intra-prediction unit 221 and the reference image difference generation unit 222 perform the intra-prediction on the reference block to calculate the difference information [Diff-ref] of the reference image which is the difference between the pixel value of the reference block and the pixel value of the reference intra-prediction image.

That is, the reference image intra-prediction unit 221 generates the reference intra-prediction images of all the intra-prediction modes in the reference frame and determines the intra-prediction mode with the minimum prediction error with the pixel value of the reference block. The pixel value of the reference block and the reference intra-prediction image of the determined intra-prediction mode are output to the reference image difference generation unit 222. Further, the reference image intra-prediction unit 221 outputs the information (for example, information regarding the adjacent pixels of the target block) regarding the necessary reference image, the information regarding the target block, and the information regarding the determined intra-prediction mode to the target image intra-prediction unit 223.

The reference image difference generation unit 222 generates the difference information of the reference image, which is the difference between the pixel value of the reference block and the pixel value of the reference intra-prediction image, and outputs the calculated difference information of the reference image to the calculation unit 224.

In step S334, the calculation unit 224 adds the secondary difference information [Dif_curr]−[Dif_ref] acquired in step S331 and the difference information [Dif_ref] of the reference image and outputs the difference information [Dif_curr] of the target image.

On the other hand, in step S335, the target image intra-prediction unit 223 performs the intra-prediction on the target block in the intra-prediction mode determined by the reference image intra-prediction unit 221 to generate a target intra-prediction image [Ipred_curr]. The target image intra-prediction unit 223 outputs the information regarding the generated target intra-prediction image to the calculation unit 224.

In step S336, the calculation unit 224 adds the difference information [Dif_curr] of the target image calculated in step S334 and the target intra-prediction image [Ipred_curr] to generate the decoded image of the target block. The decoded image is directly input to the de-block filter 116 via the switch 214.

In the example of FIG. 45, the case of the process in FIG. 39 has been exemplified even in the image encoding apparatus 151. Since the process in FIG. 40 or 41 is different in the following fact and the other processes are basically the same, the description thereof will not be repeated. That is, when the process in FIG. 40 is performed, the optimum intra-prediction mode (best_mode) from the lossless decoding unit 112 is used for the intra-prediction of step S333 and step S335. Further, when the process in FIG. 41 is performed, the optimum intra-prediction mode (best_mode) from the lossless decoding unit 112 is used for the intra-prediction of step S335.

In this way, in the image encoding apparatus 151 and the image decoding apparatus 201, first difference information is generated in the target image and the reference image which can correspond to each other by the intra-template matching or the inter-template matching, and the secondary difference information is generated and encoded.

In particular, in the intra-template matching or the inter-template matching, not the pixel value of the target block but the pixel value of the template adjacent to the target block is used for the prediction. Therefore, the prediction efficiency may be lowered in some cases compared to the prediction in which the pixel value of the target block is used.

Accordingly, according to the image encoding apparatus 151 and the image decoding apparatus 201, it is possible to improve the prediction efficiency in the intra-template matching or the inter-template matching.

In this way, according to the invention, the reference block (prediction image) corresponding to the target block is calculated, the prediction is also performed on the target block and the reference block to calculate the difference (residual error), and the secondary difference is generated from the difference and is encoded. Thus, it is possible to further improve the encoding efficiency.

When the prediction mode is used based on the above-described secondary difference, it is necessary to transmit the prediction mode information to the decoding side. For example, in the example of FIG. 31, as described above, when the inter-prediction mode is acquired, the inter-prediction mode is performed based on the secondary difference. However, one of two method described below can be used to use the prediction mode based on the secondary difference.

For example, there is a method of performing an encoding process by substituting the prediction mode information based on the secondary difference by another prediction mode information used in the H.264/AVC scheme. When this method is used, the decoding process is performed in the mode based on the secondary difference at the time of acquiring the substituted prediction mode on the decoding side.

For example, there is a method of performing an encoding process by adding new prediction mode information based on the secondary difference to another prediction mode information used in the H.264/AVC scheme. When this method is used, the decoding process is performed in the mode based on the secondary difference at the time of acquiring the added prediction mode on the decoding side.

In the above description, the H.264/AVC scheme has been used as the encoding method, but other encoding schemes/decoding schemes may be used.

The invention is applicable to an image encoding apparatus and an image decoding apparatus used when image information (bit stream) compressed by orthogonal transform such as discrete cosine transform, for example, MPEG or H.26x, and motion compensation is received via a network medium such as satellite broadcast, a cable television, the Internet, or a portable telephone. Further, the invention is applicable to an image encoding apparatus and an image decoding apparatus used when processing is performed on a magneto-optical disk, a flash memory, and the like. Furthermore, the invention is applicable to a motion prediction/compensation apparatus including the image encoding apparatuses and the image decoding apparatus.

The above-described series of processes may be executed by hardware or software. When the series of processes are executed by software, a program for the software is installed in a computer. Here, examples of the computer include a computer embedded with dedicated hardware and a general personal computer which can execute various functions by installing various programs.

FIG. 46 is a block diagram illustrating an example of the hardware configuration of the computer executing the above-described series of processes by the program.

In the computer, a CPU (Central Processing Unit) 301, a ROM (Read Only Memory) 302, and a RAM (Random Access Memory) 303 are connected to each other by a bus 304.

Further, an input/output interface 305 is connected to the bus 304. An input unit 306, an output unit 307, a storage unit 308, a communication unit 309, and a drive 310 are connected to the input/output interface 305.

The Input unit 306 is realized by a keyboard, a mouse, a microphone, or the like. The output unit 307 is realized by a display, a speaker, or the like. The storage unit 308 is realized by a hard disk, a non-volatile memory, or the like. The communication unit 309 is realized by a network interface or the like. The drive 310 drives a removable medium 311 such as a magnetic disk, an optical disk, a magneto-optical disk, or a semiconductor memory.

In the computer with the above-described configuration, the CPU 301 execute the above-described series of processes by loading and executing the program stored in the storage unit 308 on the RAM 303 via the input/output interface 305 and the bus 304.

The program executed by the computer (the CPU 301) can be recorded in the removable medium 311 serving as, for example, a package medium for supply. The program can be supplied via a wired or wireless transmission medium such as a local area network, the Internet, digital broadcast, or the like.

In the computer, the program can be installed to the storage unit 308 via the input/output interface 305 by mounting the removable medium 311 on the drive 310. Further, the program can be received by the communication unit 309 via a wired or wireless transmission medium and can be installed to the storage unit 308. Furthermore, the program can be installed in advance in the ROM 302 or the storage unit 308.

The program executed by the computer may be a program executed chronologically in the order described in the specification or may be a program executed in parallel or at a necessary time when called.

The invention is not limited to the above-described embodiments, but may be modified in various forms within the scope of the invention without departing from the gist of the invention.

### REFERENCE SIGNS LIST

51: image encoding apparatus
66: lossless encoding unit
74: intra-prediction unit
75: motion prediction/compensation unit
76: in-screen prediction unit
77: secondary difference generation unit
81: target frame in-screen prediction unit
82: target frame in-screen difference generation unit
83: reference frame in-screen prediction unit
84: reference frame in-screen difference generation unit
91: target frame difference reception unit
92: reference frame difference reception unit
93: secondary difference calculation unit
101: image decoding apparatus
112: lossless decoding unit
121: intra-prediction unit
122: motion prediction/compensation unit
123: in-screen prediction unit
124: secondary difference generation unit
131: target frame in-screen prediction unit
132: reference frame in-screen prediction unit
133: reference frame in-screen difference generation unit
141: prediction image reception unit
142: reference frame difference reception unit
143: image calculation unit
151: image encoding apparatus
161: intra-template motion prediction/compensation unit
162: inter-template motion prediction/compensation unit
163: adjacency prediction unit
171: reference image intra-prediction unit
172: target image intra-prediction unit
173: reference image difference generation unit
174: target image difference generation unit
175: calculation unit
201: image decoding apparatus
211: intra-template motion prediction/compensation unit
212: inter-template motion prediction/compensation unit
213; adjacency prediction unit
221: reference image intra-prediction unit
222: reference image difference generation unit
223: target image intra-prediction unit
224: calculation unit

1. An image processing apparatus comprising:
a reception unit receiving target frame difference information, which is a difference between an image of a target frame and a target prediction image generated through in-screen prediction in the target frame, and reference frame difference information, which is a difference between an image of a reference frame corresponding to the target frame and a reference prediction image generated through the in-screen prediction in the reference frame;
a secondary difference generation unit generating secondary difference information which is a difference between the target frame difference information and the reference frame difference information received in the receiving; and
an encoding unit encoding the secondary difference information generated by the secondary difference generation unit as the image of the target frame.

2. The image processing apparatus according to claim 1, further comprising:
an inter-template motion prediction unit allowing the target block to correspond to the reference block by predicting motion of the target block using a first template, which is adjacent to the target block and is generated from a decoded image, in the reference frame.

3. The image processing apparatus according to claim 2, further comprising:
a target intra-prediction unit generating the target prediction image through the in-screen prediction by the use of pixels of the first template in the target frame; and
a reference intra-prediction unit generating the reference prediction image through the in-screen prediction by the use of pixels of a second template, which is adjacent to the reference block and is generated from the decoded image, in the reference frame.

4. The image processing apparatus according to claim 3,
wherein the reference intra-prediction unit determines a prediction mode by generating the reference prediction image through the in-screen prediction using the pixels of the second template in the reference frame, and
wherein the target intra-prediction unit generates the target prediction image through the in-screen prediction in the prediction mode determined by the reference intra-prediction unit by the use of the pixels of the first template in the target frame.

5. The image processing apparatus according to claim 3,
wherein the target intra-prediction unit determines a prediction mode by generating the target prediction image through the in-screen prediction by the use of the pixels of the first template in the target frame,
wherein the reference intra-prediction unit generates the reference prediction image through the in-screen prediction in the prediction mode determined by the target intra-prediction unit by the use of the pixels of the second template in the reference frame, and
wherein the encoding unit encodes the image of the target frame and information indicating the prediction mode determined by the target intra-prediction unit.

6. The image processing apparatus according to claim 3,
wherein the target intra-prediction unit determines a first prediction mode by generating the target prediction image through the in-screen prediction by the use of the pixels of the first template in the target frame,
wherein the reference intra-prediction unit determines a second prediction mode by generating the reference prediction image through the in-screen prediction by the use of the pixels of the second template in the reference frame; and
wherein the encoding unit encodes the image of the target frame and information indicating the first prediction mode determined by the target intra-prediction unit.

7. The image processing apparatus according to claim 1, further comprising:
a motion prediction unit allowing the target block to correspond to a reference block included in the reference frame by predicting motion of the target block using a target block included in the target frame in the reference frame.

8. The image processing apparatus according to claim 7, further comprising:
a target intra-template prediction unit generating the target prediction image through the in-screen prediction using a first block corresponding to the target block calculated by predicting motion of the target block using a first template, which is adjacent to the target block and is generated from a decoded image, in the target frame; and
a reference intra-template prediction unit generating the reference prediction image through the in-screen prediction using a second block corresponding to the reference block calculated by predicting motion of the reference block using a second template, which is adjacent to the reference block and is generated from the decoded image, in the reference frame.

9. The image processing apparatus according to claim 7, further comprising:
a target intra-motion prediction unit generating the target prediction image through the in-screen prediction using a first block corresponding to the target block calculated by predicting motion of the target block using the target block in the target frame; and
a reference intra-motion prediction unit generating the reference prediction image through the in-screen prediction using a second block corresponding to the reference block calculated by predicting motion of the reference block using the reference block in the reference frame.

10. An image processing method comprising: by an image processing apparatus,
receiving target frame difference information, which is a difference between an image of a target frame and a target prediction image generated through in-screen prediction in the target frame, and reference frame difference information, which is a difference between an image of a reference frame corresponding to the target frame and a reference prediction image generated through the in-screen prediction in the reference frame;
generating secondary difference information which is a difference between the received target frame difference information and the reference frame difference information; and
encoding the generated secondary difference information as the image of the target frame.

11. An image processing apparatus comprising:
a decoding unit decoding secondary difference information of a decoded target frame;
a reception unit receiving a target prediction image generated through in-screen prediction in the target frame and reference frame difference information, which is a difference between an image of a reference frame corresponding to the target frame and a reference prediction image generated through the in-screen prediction in the reference frame; and
a secondary difference compensation unit calculating an image of the target frame by adding the secondary difference information decoded by the decoding unit, the target prediction image received by the reception unit, and the reference frame difference information received by the reception unit.

12. The image processing apparatus according to claim 11, further comprising:
an inter-template motion prediction unit allowing the target block to correspond to the reference block by predicting motion of the target block using a first template, which is adjacent to the target block and is generated from a decoded image, in the reference frame.

13. The image processing apparatus according to claim 12, further comprising:
a target intra-prediction unit generating the target prediction image through the in-screen prediction by the use of pixels of the first template in the target frame; and
a reference intra-prediction unit generating the reference prediction image through the in-screen prediction by the use of pixels of a second template, which is adjacent to the reference block and is generated from the decoded image, in the reference frame.

14. The image processing apparatus according to claim 13,
wherein the reference intra-prediction unit determines a prediction mode by generating the reference prediction image through the in-screen prediction using the pixels of the second template in the reference frame, and
wherein the target intra-prediction unit generates the target prediction image through the in-screen prediction in the prediction mode determined by the reference intra-prediction unit by the use of the pixels of the first template in the target frame.

15. The image processing apparatus according to claim 13,
wherein the decoding unit decodes both the secondary difference information and information indicating a prediction mode in the target intra-prediction unit,
wherein the target intra-prediction unit generates the target prediction image through the in-screen prediction in the prediction mode indicated by the information decoded by the decoding unit by the use of the pixels of the first template in the target frame, and
wherein the reference intra-prediction unit generates the reference prediction image through the in-screen prediction in the prediction mode indicated by the information decoded by the decoding unit by the use of the pixels of the second template in the reference frame.

16. The image processing apparatus according to claim 13,
wherein the decoding unit decodes both the secondary difference information and information indicating a first prediction mode in the target intra-prediction unit,
wherein the target intra-prediction unit generates the target prediction image through the in-screen prediction in the first prediction mode indicated by the information decoded by the decoding unit by the use of the pixels of the first template in the target frame, and
wherein the reference intra-prediction unit determines a second prediction mode by generating the reference prediction image through the in-screen prediction by the use of the pixels of the second template in the reference frame.

17. The image processing apparatus according to claim 11, further comprising:
a motion prediction unit allowing the target block to correspond to a reference block included in the reference frame by predicting motion of the target block using a target block included in the target frame in the reference frame.

18. The image processing apparatus according to claim 17, further comprising:
a target intra-template prediction unit generating the target prediction image through the in-screen prediction using a first block corresponding to the target block calculated by predicting motion of the target block using a first template, which is adjacent to the target block and is generated from a decoded image, in the target frame; and
a reference intra-template prediction unit generating the reference prediction image through the in-screen prediction using a second block corresponding to the reference block calculated by predicting motion of the reference block using a second template, which is adjacent to the reference block and is generated from the decoded image, in the reference frame.

19. The image processing apparatus according to claim 17, further comprising:
a target intra-motion prediction unit generating the target prediction image through the in-screen prediction in the target frame using a first block corresponding to the target block calculated using motion vector information of the target block decoded together with the secondary difference of the target frame by the decoding unit; and
a reference intra-motion prediction unit generating the reference prediction image through the in-screen prediction in the reference frame using a second block corresponding to the reference block calculated using motion vector information of the reference block decoded together with the secondary difference of the target frame by the decoding unit.

20. An image processing method comprising: by an image processing apparatus,
decoding secondary difference information of a decoded target frame;
receiving a target prediction image generated through in-screen prediction in the target frame and reference frame difference information, which is a difference between an image of a reference frame corresponding to the target frame and a reference prediction image generated through the in-screen prediction in the reference frame; and
calculating an image of the target frame by adding the decoded secondary difference information, the received target prediction image, and the received reference frame difference information.
